(19) United States
(12) Patent Application Publication
(10) Pub. No.: US 2016/0078494 A1
(43) Pub. Date: Mar. 17, 2016

(54) ELECTRONIC BOOK SELECTION AND DELIVERY SYSTEM WITH TARGETED ADVERTISING

(71) Applicant: ADREA, LLC, Sunnyvale, CA (US)

(72) Inventors: John S. HENDRICKS, Potomac, MD (US); Michael L. Asmussen, Herndon, VA (US)

(21) Appl. No.: 14/949,560

(22) Filed: Nov. 23, 2015

Related U.S. Application Data
(63) Continuation of application No. 09/328,672, filed on Jun. 9, 1999, now abandoned.
Application No. 09/328,672 is a continuation-in-part of application No. 09/289,956, filed on Apr. 13, 1999, now abandoned.
Application No. 09/289,956 is a continuation-in-part of application No. 09/289,957, filed on Apr. 13, 1999, now Pat. No. 7,835,989.
Application No. 09/289,957 is a continuation-in-part of application No. 09/237,828, filed on Jan. 27, 1999, now Pat. No. 7,401,286.
Application No. 09/237,828 is a continuation-in-part of application No. 09/054,419, filed on Apr. 3, 1998, now Pat. No. 6,463,585.
Application No. 09/054,419 is a continuation-in-part of application No. 08/906,469, filed on Aug. 5, 1997, now Pat. No. 6,408,437.
Application No. 08/906,469 is a continuation-in-part of application No. 08/735,552, filed on Oct. 23, 1996, now Pat. No. 6,160,989.
Application No. 08/735,552 is a continuation-in-part of application No. 08/355,549, filed on Dec. 14, 1994, now Pat. No. 5,679,678.
Application No. 08/355,549 is a continuation-in-part of application No. 08/336,247, filed on Nov. 7, 1994, now Pat. No. 5,986,690.
Application No. 08/336,247 is a continuation-in-part of application No. 07/991,074, filed on Dec. 9, 1992, now abandoned.
Application No. 07/991,074 is a continuation-in-part of application No. 08/160,194, filed on Dec. 2, 1993, now Pat. No. 5,990,927.

(51) Int. Cl. G06Q 30/02

(52) U.S. Cl. CPC G06Q 30/0269

(57) ABSTRACT

The invention, an electronic book selection and delivery system, supports the inclusion of advertisements targeted based on subscriber likes and dislikes text. The system includes a targeted advertising management system that compiles information about electronic book subscribers, electronic books, and advertisements and optimally selects advertisements to be placed in electronic books customized for an individual subscriber. The system contains an operations center, a distribution system, a home system, and a billing and collection system. The operations center, in conjunction with the targeted advertising management system performs the functions of manipulation of text data, security and coding of text, cataloging of electronic books, message center, advertising selection, insertion and delivery functions. The home system connects to a distribution system, generates menus and stores text, and transacts through communicating mechanisms. A portable electronic book-shaped viewing device is used for viewing the text and advertisements. Advertisements may be targeted to individual home systems based on common characteristics of subscribers, including area of dominant influence, age, reading habits and income.

### RELATED APPLICATIONS

This application is a continuation-in-part of U.S. application Ser. No. 08/336,247 entitled ELECTRONIC BOOK SELECTION AND DELIVERY SYSTEM, filed Nov. 7, 1994; U.S. application Ser. No. 08/160,194 entitled ADVANCED SET-TOP TERMINAL FOR CABLE TELEVISION DELIVERY SYSTEMS, filed Dec. 2, 1993; U.S. application Ser. No. 08/906,469 entitled REPROGRAMMABLE TERMINAL FOR SUGGESTING PROGRAMS OFFERED ON A TELEVISION PROGRAM DELIVERY SYSTEM, filed Aug. 5, 1997; U.S. application Ser. No. 08/735,552, entitled NETWORK CONTROLLER FOR CABLE TELEVISION DELIVERY SYSTEMS, filed Oct. 23, 1996; U.S. application Ser. No. 08/355,549 entitled NETWORK CONTROLLER FOR CABLE TELEVISION DELIVERY SYSTEMS, filed Oct. 23, 1996; U.S. application Ser. No. 09/054,419 entitled TARGETED ADVERTISEMENT USING TELEVISION DELIVERY SYSTEM, filed Apr. 3, 1998; U.S. application Ser. No. 09/237,828 entitled ELECTRONIC BOOK ELECTRONIC LINKS, filed Jan. 27, 1999; U.S. application Ser. No. 09/289,957 entitled ELECTRONIC BOOK ALTERNATIVE DELIVERY SYSTEMS, filed Apr. 13, 1999; and U.S. application Ser. No. 09/289,956 entitled ELECTRONIC BOOK ALTERNATIVE DELIVERY METHODS, filed Apr. 13, 1999. These applications are incorporated by reference herein.

### BACKGROUND ART

Sparked by the concept of an information superhighway, a revolution will take place in the distribution of books. Not since the introduction of Gutenberg's movable typeset printing has the world stood on the brink of such a revolution in the distribution of text material. The definition of the word “book” will change drastically in the near future. Due to reasons such as security, convenience, cost, and other technical problems, book and magazine publishers are currently only able to distribute their products in paper form. Advertising, which is critical in supporting the costs of developing and distributing content, can currently be addressed to the mass marketplace. Advertisers want to optimize their advertising expenditures by ensuring that specific advertisements are directed to the appropriate reading audiences. Specifically, advertisers want specific advertisements to be presented in written material that is being viewed by those individuals most likely to be influenced to buy the advertised product, or otherwise respond in a desired fashion to the advertisement. This invention solves the problems encountered by publishers and advertisers.

### TECHNICAL FIELD AND BRIEF SUMMARY OF INVENTION

This invention is directed to an electronic book. More specifically, the invention is an electronic book system that supports advertisements that can be targeted to a subscriber based on the subscriber's characteristics.

The electronic book selection and delivery system is a new way to distribute books to bookstores, public libraries, schools and subscribers. The technological breakthroughs of this invention provide a secure electronic system for both delivering selected books and associated advertising. The system has an unusual combination of features that provide the subscriber with a daily use household appliance that has a high tech aura while being very practical, portable, and easy to use.

The clear advantage of the system is that it eliminates the distribution of any physical object such as a paper book or computer memory device from any book or text distribution system. The purchase of an electronic book becomes a PAY-PER-READ™ event avoiding the overhead, “middle-men,” printing costs, and time delay associated with the current book distribution system. Published material and text such as the President's speech, a new law, a court decision on abortion, or O. J. Simpson's testimony can be made immediately available to the subscriber at a nominal fee. Additionally, advertisements can be associated with electronic books that are targeted directly to the subscriber's likes and can be updated to be kept fresh and current. Alternately, electronic books may be distributed as data files on a memory card, such as a PCMCIA card, for example.

The system is a novel combination of new technology involving the television, cable, telephone, and computer industries. It utilizes high bandwidth data transmissions, strong security measures, sophisticated digital switching, high-resolution visual displays, novel controls, and user friendly interface software.

The primary components of the text delivery system are the subsystem for delivery and the subsystem for receiving and selecting text that was delivered. An embodiment of the system includes additional components and optional features that enhance the system. The system may be configured for use by bookstores, public libraries, schools and subscribers. The system for subscriber use is made up of four subsystems, namely: (1) an operations center, (2) a distribution system, (3) a home system including reception, selection, viewing, transacting and transmission capabilities, and (4) a billing and collection system. Alternative configurations of the system are defined to allow for a variety of traditional and non-traditional delivery methods.

The operations center performs several primary functions: manipulating text data (including receiving, formatting and storing of text data), security encoding of text, cataloging of electronic books, providing a messaging center capability, and performing uplink functions. In one embodiment, the system delivers the text from the operations center to subscriber homes by inserting text data within analog video signals. The insertion of text is generally performed with an encoder at an uplink site that is within or near the operations center. The system can use several lines of the Vertical Blanking Interval (VBI), all the lines of the analog video signal, a digital video signal or unused portions of bandwidth to transmit text data. Using the VBI delivery method, the top ten or twenty book titles may be transmitted with video during normal programming utilizing existing cable or broadcast transmission capability without disruption to the subscriber's video reception. Using the entire video signal, thousands of electronic books may be transmitted within just one hour of airtime. Nearly any analog or digital video or data distribution system may be used to deliver the text data. The text data may also be transmitted over other low and high speed signal paths including a telephone network (e.g., a public switched telephone network) having a high speed connection such as an asynchronous digital subscriber line (ADSL) connection. The operations center also provides the processing necessary to create, assign, and deliver advertisements along with and in addition to electronic books, and allows for the collection and interpretation data collected from subscribers to measure and optimize advertisement placement.

The home system performs four primary functions: connecting to the distribution system, selecting text, storing text, and transacting through a phone, a cable or other communicating mechanism. The components of the home system may be configured in a variety of hardware configurations. Each function may be performed by a separate component, the components may be integrated, or the capability of existing cable set top terminal boxes, televisions and personal computers may be utilized. A connector, a library and a viewer may be used. In one embodiment, the connector portion of the home system receives the analog video signal and strips or extracts the text from the video. The library stores the text signal, provides a user friendly software interface to the system and processes the transactions at the subscriber's home. The viewer provides a screen for viewing text or menus and novel user friendly controls. Alternative embodiments allow for the delivery of text using a variety of communication methods.

The viewing device may be a portable book-shaped viewer that stores one or more electronic books for viewing and provides a screen for interacting with the library. A high resolution LCD display is used to both read the electronic books and to interact with the home library software. An optional phone connector or return-path cable connection initiates the telephone calls and, with the aid of the library, transmits the necessary data to complete the ordering and billing portion of the subscriber transaction or collection of subscriber data, electronic books read data, and advertisement viewing data. The user-friendly controls include a bookmark, current electronic book and page turn button. The billing and collection system performs transaction management, authorizations, collections and publisher payments automatically, utilizing the telephone system or alternative communication methods.

A system similar to the system for subscriber use may be used in bookstores, schools and public libraries.

### BRIEF DESCRIPTION OF DRAWINGS

FIG. 1 is a block diagram of the primary components of the electronic book selection and delivery system.

FIG. 2 is a schematic showing an overview of the electronic book selection and delivery system.

FIG. 3a is a schematic of the delivery plan for the electronic book selection and delivery system.

FIG. 3b is a schematic of an alternate delivery plan.

FIG. 4 is a block diagram of the operations center.

FIG. 5a is a flow diagram of the processing at the operations center and uplink.

FIG. 5b is a block diagram of the hardware configuration for an uplink site.

FIG. 6a is a block diagram of the hardware configuration for a four component home system.

FIG. 6b is a schematic of a two unit home system.

FIG. 7 is a flow diagram of the processes performed by the video connector.

FIG. 8 is a block diagram for an example of a library unit.

FIG. 9 is a flow diagram of some of the processes performed by the library on the received data stream.

FIG. 10 is a flow diagram of the processes performed by the library unit on information requests from the viewer.

FIG. 11 is a block diagram showing the components for an example of a viewer.

FIG. 12 is a flow diagram of some of the processes performed by the viewer on an information request from a subscriber.

FIG. 13 is a chart depicting the menu structure and sequencing of menus in the menu system.

FIG. 14a is a schematic of an introductory menu.

FIG. 14b is a schematic showing an example of a main menu.

FIGS. 14c, 14d, 14e, 14f, 14g, 14h, 14i and 14j are schematics showing examples of submenus.

FIG. 15 is a schematic diagram of an electronic book system for a bookstore or public library.

FIG. 16a and FIG. 16b are schematics of hardware modifications or upgrades to a set top terminal.

FIG. 17 is a schematic showing a set top terminal that includes a data receiver and data transmitter.

FIG. 18a is a schematic of an electronic book-on-demand system.

FIG. 18b is a schematic of an operations center supporting an electronic book-on-demand system.

FIG. 19a is a depiction of a full page ad.

FIG. 19b is a depiction of a banner-type ad.

FIG. 19c shows advertisement links in an electronic book.

FIG. 20 is a schematic showing the on-demand targeted advertising delivery system.

FIG. 21 is a schematic showing the broadcast targeted advertising delivery system.

FIG. 22 is a diagram of a configuration set-up system.

FIG. 23 is a diagram of the ad selection system.

FIG. 24 is the software flow chart for the Alternate Advertisement Targeting routine.

FIG. 25 is the subroutine flow chart for processing electronic books read matrices through correlation algorithms.

FIG. 26 is the subroutine flow chart for determining final groupings of home systems.

FIG. 27 is a diagram showing a sample assignment of advertising to home system groups.

FIG. 28 is a diagram assigning available bandwidth for multiple advertisement.

FIG. 29 is a software flowchart for an alternative advertisement targeting routine.

### DETAILED DESCRIPTION OF INVENTION

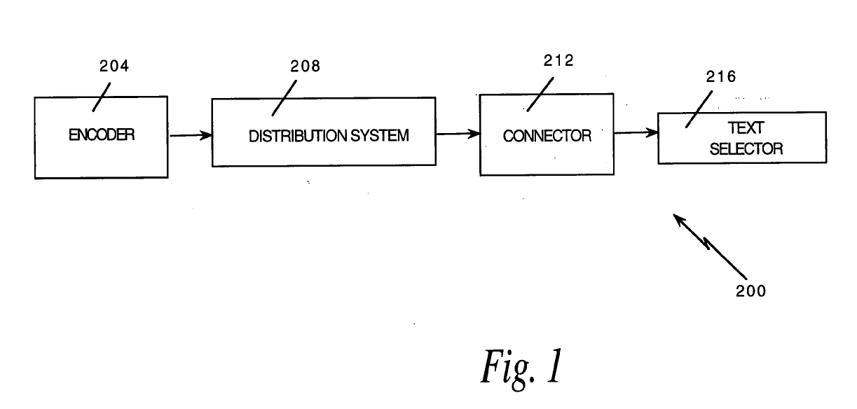

In an embodiment, the primary components of the electronic book selection and delivery system 200 are an encoder 204, a distribution system 208, a connector 212, and a text selector 216 as shown in FIG. 1. In an embodiment, the encoder 204 places textual data on a video signal to form a composite video signal. Although the composite signal may contain only textual data, it also may carry both video and textual data. A variety of equipment and methods may be used to encode text data onto a video signal. The distribution system 208 distributes the composite video signal from the single point of the encoder 204 to multiple locations that have connectors 212. The connector 212 receives the digital or analog video signal from the distribution system 208 and separates, strips or extracts the text data from the composite video signal. If necessary, the extracted text data is converted into a digital bit stream. Text selector 216 works in connection with the connector 212 to select text.

Using a connector 212 and text selector 216 combination, various methods of selecting and retrieving desired text from a composite or video signal are possible. Text may be pre-selected, selected as received or selected after being received and stored. One method is for the connector 212 to strip or extract all the text from the video signal and have the text selector 216 screen all the text as received from the connector 212. The text selector 216 only stores text in long term or permanent memory if the text passes a screening process described below.

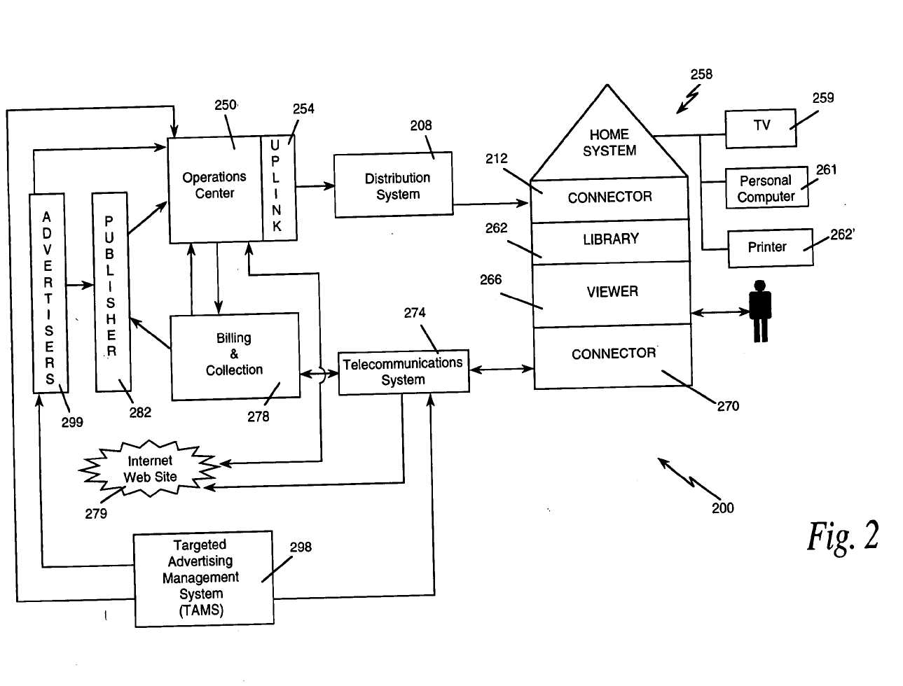

An overview of this embodiment is shown in FIG. 2. The system 200 includes: an operations center 250 including an uplink site 254, the distribution system 208, a home system 258 including a video connector 212, a library 262, a viewer 266, and a phone connector 270, telephone system 274, an Internet web site 279 and a billing and collection subsystem 278. Also shown in FIG. 2, the home system 258 may include connections to a television 259, a personal computer 261 and a printer 263. The television 259 and the personal computer 261 may be used to display menu screens, electronic books, electronic files, or any other information associated with the delivery system 200. In addition, the television 259 and the personal computer 261 may provide control function that replicate and supplement those of the viewer 266.

The operations center 250 receives textual material from outside sources 282 such as publishers, newspapers, and on-line services. Additionally, the operations center 250 can receive advertisements directly from advertisers or advertisements already embedded in content received from publishers. The operations center 250 receives this textual material in various digital formats and converts the textual material to a standard compressed format for storage. In so doing, the operations center 250 creates a pool of textual material that is available to be delivered to the home system 258. The text materials may be grouped by books or titles for easy access.

As used herein, “book” means textual or graphical information such as contained in any books, novels, encyclopedias, articles, magazines, manuals, catalogs, menus, pamphlets or other documents. The term “electronic book” refers to an electronic version of a “book.” The term “title” may represent the actual title assigned by an author to a book, or any other designation indicating a particular group, portion, or category of textual information. The title may refer to a series of related textual information, a grouping of textual information, or a portion of textual data. For example, “Latest Harlequin Romance”, “Four Child Reading Books (Ages 10-12),” “Encyclopedia ‘BRITANNICA’,™” “President's Speech,” “Instruction Manual,” “Schedule of 4th of July Events,” “Pet Handbooks,” “Roe v. Wade,” and “The Joy of Cooking” are suitable titles. Also, the title may be a graphical symbol or icon. Thus, a picture of a wrench may be a title for a repair book, a picture of a computer a title for a computer book, a graphical symbol of a telephone a title for a telephone book, a drawing of a dagger a title for a mystery book, a picture of a bat and ball a title for a sports book and a picture of tickertape a title for a business book.

The operations center 250 includes an uplink site 254 for placing the text onto a video signal and sending the composite video signal into the distribution system 208. The uplink site 254 would generally include an encoder 204 (not shown in FIG. 2) to encode the text onto a video signal.

In an embodiment, to transmit textual data, the delivery system 208 may use high bandwidth transmission techniques such as those defined by the North American Broadcast Teletext Standard (NABTS) and the World System Teletext (WST) standard. Using the WST format (where each line of the Vertical Blanking Interval contains 266 data bits), a four hundred page book, for example, may be transmitted during programming using four lines of the Vertical Blanking Interval at a rate of approximately one book every 1.6 minutes (63,840 bits per second). Alternatively, electronic books may be transmitted over a dedicated channel, which interrupts programming so that 246 lines of video can be used to transmit approximately 2,250 books every hour (3.9 Mbits per second). A teletext type format is the simplest but possibly the slowest text format to use with the system 200. In either event, the encoder 204 is utilized at the uplink site 254 to insert textual data into the analog video signal. In many other respects, the delivery of the textual information is completed using existing cable television plant and equipment or alternate transmission formats and delivery systems.

Many analog and digital video distribution systems can be used with the system 200, such as cable television distribution systems, broadcast television distribution systems, video distributed over telephone systems, distribution from the Internet, direct satellite broadcast distribution systems, and other wire and wireless distribution systems. Nearly any distribution system that can deliver a telecommunication signal, including a video signal will work with the text delivery system 200. The text may also be distributed without using a telecommunications signal as described in co-pending U.S. application Ser. No. 09/289,957 entitled ELECTRONIC BOOK ALTERNATIVE DELIVERY SYSTEMS, filed Apr. 13, 1999 and U.S. application Ser. No. 09/289,956 entitled ELECTRONIC BOOK ALTERNATIVE DELIVERY METHODS, filed Apr. 13, 1999.

The home system 258 performs five primary functions, (1) connecting with a distribution system, (2) selecting data, (3) storing data, (4) displaying data, and (5) handling transactions. An important optional function of the home system 258 is communicating using, in one embodiment, a telephone communication system 274. The home system 258 is made up of primarily four parts: a connector 212 or similar type of connector for connecting with the distribution system 208, a library 262 for storing and processing, a viewer 266 for viewing menus and text and a telephone connector 270 for connecting with a telephone communications system 274.

The billing and collection subsystem 278 may be co-located with the operations center 250 or located remote from the operations center 250. In an embodiment, the billing and collection subsystem 278 may be in communication with the home system 258 using telephone-type communication systems (for example 274). Any of a number of telephone type communication systems, such as, a cellular system, may operate with the billing and collection system 278. The billing and collection system 278 records the electronic books or portions of text that are selected or ordered by the subscriber. The collection system will charge a subscriber's credit account or bill the subscriber. In addition, the billing and collection system 278 will monitor that amount due to publishers or other outside sources 282 who have provided textual data or other services such as air time to enable the system 200 to operate.

When electronic books are provided using the Internet web site 279, the billing and collecting functions may be incorporated into the Internet web site 279. For example, a subscriber may pay for an electronic book selection by entering a credit card number into a data field of a page on the Internet web site 279. In this configuration, a separate billing and collection system may not be required.

A targeted advertising management system (TAMS) 298 may be co-located with the operations center 250 or located remote from the operations center 250. The TAMS 298 communicates with the home system 258 using telephone type communication systems, or alternatively using two-way cable communications or cellular phone or any other communication method as presented in co-pending U.S. application Ser. No. 09/289,957 entitled ELECTRONIC BOOK ALTERNATIVE DELIVERY SYSTEMS, filed Apr. 13, 1999 and U.S. application Ser. No. 09/289,956 entitled ELECTRONIC BOOK ALTERNATIVE DELIVERY METHODS, filed Apr. 13, 1999. The TAMS 298 collects subscriber data from the home system 258 and uses the data to place advertisements in electronic books and on menus. The TAMS 298 provides advertisers 299 with suggestions for how to place advertisements within available content, or alternatively, manages the placement of these advertisements directly using the operations center 250.

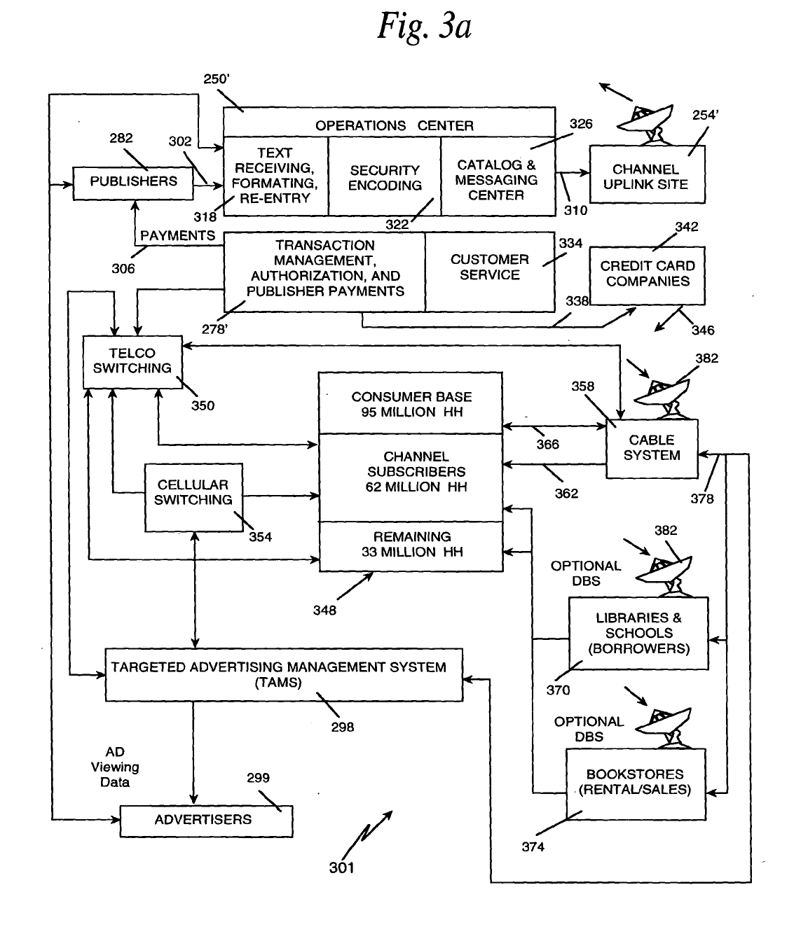

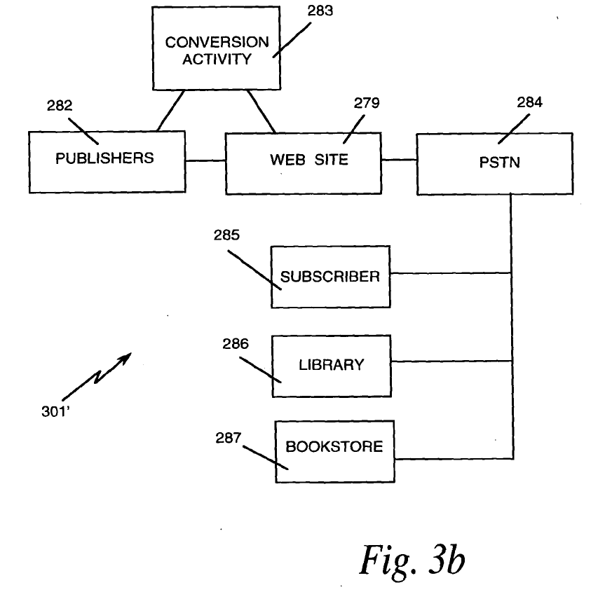

FIG. 3a is an expanded overview of an embodiment of a delivery plan 301 for the electronic book selection and delivery system 200. The delivery plan 301 supports various types of subscribers, various billing systems, and various TAMS. FIG. 3a shows that publishers 282 will provide text transfer 302 to the operations center 250′ and receive payments 306 from the billing and collection system 278′. A separate channel uplink site 254′ is shown in this configuration receiving data 310 from the operations center 250′. The operations center 250′ has three separate sections (318, 322, 326) one for text receiving, formatting and re-entry 318, a second for security encoding 322 and a third section for catalog and messaging center functions 326.

The collection and billing system 278′ shown has two sections (330, 334) one for transaction management, authorizations and publisher payments 330, and the other for customer service 334. The customer service section 334 provides for data entry and access to customer account information. Transaction accounting information 338 is supplied to credit card companies 342 by the transaction management section 330 of the billing and collection system 278′. The credit card companies 342 provide billing 346 to customers either electronically or by mail.

The TAMS 298 collects subscriber data and requests, collects advertisements that are optimized for placement in electronic books or menus, manages the storage, retrieval, and insertion of the advertisements, and analyzes the performance and success of the placement of these advertisements.

Three methods for communicating among the subscriber base 348 and both the billing and collection system 278′ and the TAMS 298 are shown in FIG. 3a: telephone switching 350 alone, cellular switching 354 and telephone switching 350 combined, and by use of the cable system 358 and the telephone switching 350. The system shown supports both one-way 362 and two-way cable communication 366 with subscribers. Public libraries and schools 370 as well as bookstores 374 may use the delivery plan 301.

Public libraries and schools 370 may have a modified system to allow the viewer 266 to be checked-out or borrowed while bookstores 374 may rent or sell the viewer 266 and sell electronic books. The bookstores 374 as well as the public libraries and schools 370 may be serviced by the cable system 358. Optional direct broadcast systems (DBS) 382 can also be used with the delivery plan 301.

FIG. 3b is an alternate delivery plan 301′ that provides for electronic book selection and delivery using the Internet. In FIG. 3b, the publishers 282 provide the electronic books to be posted at the Internet web site 279. The publishers may convert the text and graphical data to digital format, compress the digital data, and upload the compressed digital data to the Internet web site 279. Alternately, the publishers 282 may arrange for an outside conversion activity 283 to convert the text and graphical data to digital format. The conversion activity 283 may then provide the digital data to the Internet web site 279. For example, a large on-line bookstore could gather publications in electronic form from a variety of publishers, or could convert hard-copy books to electronic form, and post the electronic books on the Internet such as at the Internet web site 279.

The electronic books may then be transferred using a public switched telephone network (PSTN), for example, direct to a subscriber 285, a library 286 and a bookstore 287. The library 286 and the bookstore 287 may also provide electronic books to the subscriber 285.

### I. The Operations Center

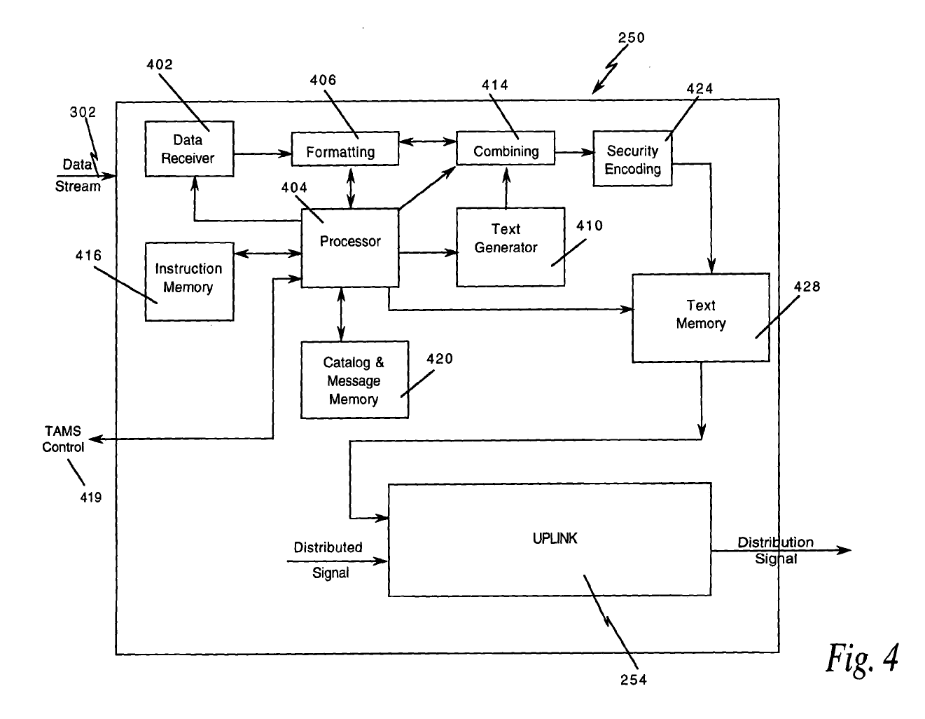

FIG. 4 is a schematic of the operations center 250 which includes the uplink 254. The operations center 250 gathers text or electronic books and advertisements by receiving, formatting, storing, and encoding. A data stream 302 containing text and advertisements is received at the operations center 250 by a data receiver 402. The data receiver 402 is under the control of a processor 404. After reception, the data stream 302 is formatted using digital logic for formatting 406, which is also under the control of the processor 404. If any additional text is being generated at the operations center 250 locally for insertion into a distribution signal, the text generation is handled through text generator hardware 410, which may include a data receiver and a keyboard (not shown). Following processing by the text generator 410, the additional text can be added to the text received by the combining hardware 414, which includes digital logic circuitry (not shown). The text generator 410 is an embodiment to allow for the real-time insertion of advertisements in text and menus.

The processing at the operations center 250 is controlled by a processor 404, which uses an instruction memory 416. The processor 404 and the instruction memory 416 may be supplied by a personal computer or mini-computer. To perform cataloging and messaging functions, the operations center 250 uses a catalog and message memory 420 and the text generator 410, if necessary.

The processor 404 also receives inputs from and provides instructions 419 to the TAMS 298 (not shown in FIG. 4).

The data stream of text and advertisements, catalog and messages may be encoded by security module encoding 424 prior to being sent to the uplink module 254. Various encoding techniques may be used by the security encoding module 424, such as the commercial derivative of NSA's encryption algorithm (Data Encryption System (DES)) and General Instrument's DigiCipher II™, for example. Following encoding, the encoded text may be stored in text memory 428 prior to being sent to the uplink 254. In an embodiment, a first-in-first-out text memory arrangement is used under the control of the processor 404. Various types of memory may be used for the text memory 428 including RAM. The operations center 250 may use file server technology for the text memory 428 to catalog and spool electronic books for transmission as is described below. The operations center may also store the electronic book files as compressed data files.

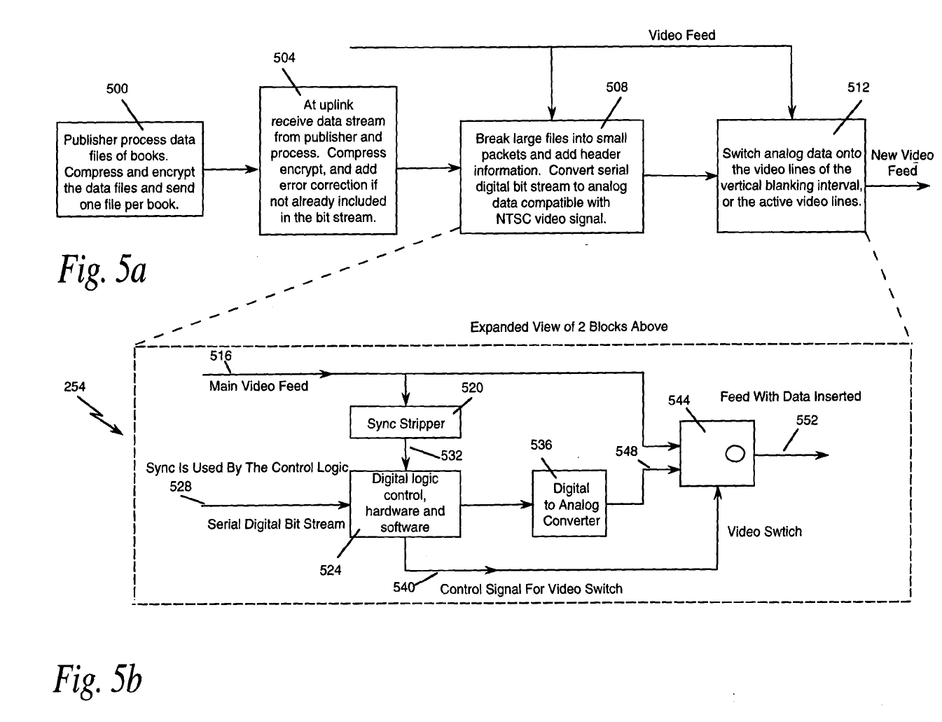

FIG. 5a is a flowchart of the steps involved in processing text from the publisher or provider 282 that may occur at the operations center 250. In FIG. 5a, the electronic books are distributed using an analog video signal. However, other telecommunications systems may be used to distribute the electronic book. As shown in block 500, the publisher 282 processes data files of text for electronic books along with any embedded advertisements, and then compresses, encrypts and sends the data files to the operations center 250 or uplink 254. Text files for electronic books may be sent one electronic book at a time. As shown in block 504, the uplink 254 or operations center 250 receives and processes the data stream from the publisher 282. Generally, part of this processing includes encryption and error correction.

As shown in block 508, files are broken into smaller packets of information. Header information is added to the packets. The bit stream is converted from a serial digital bit stream to an analog bit stream that is compatible with an NTSC video signal. Block 512 shows the switching of analog data into the video lines of a video signal. The analog data is generally placed either in the VBI or the active video lines. In some instances, unused portions of bandwidth (such as 5-40 MHZ, 70-75 MHZ, 100-109 MHZ or other guard bands) may be used instead of the video lines.

FIG. 5b is an example of a hardware configuration to perform some of the functions for blocks 508 and 512. A video feed 516 is received and processed through a sync stripper 520. The stripped sync signal 532 is used by the digital logic control 524. The digital logic control 524 receives the sync signal 532 and a serial digital bit stream 528 for processing. The digital logic control 524 passes the serial digital bit stream to the Digital to Analog converter 536 and outputs a control signal 540 for the video switch 544. The video switch 544 integrates the video feed 516 and analog data stream 548 into a video feed with analog data signal inserted 552.

As an alternative to cable, broadcast or other television delivery methods, the public telephone system may be used to transmit electronic books to the subscribers. An average electronic book would take about 7 minutes to transmit over the public telephone system. Using the telephone system, it is not necessary to combine video and text into a composite signal. In most other respects, the operations center would remain similar whether text delivery was by telephone or cable. In one embodiment, file server technology (such as that described in U.S. Pat. No. 5,262,875, entitled AUDIO/VIDEO FILE SERVER INCLUDING DECOMPRESSION/PLAYBACK MEANS, issued to Mincer, et al., and, U.S. Pat. No. 5,218,695, entitled FILE SERVER SYSTEM HAVING HIGH-SPEED WRITE EXECUTION, issued to Noveck, et al., incorporated herein by reference) may be used at the operations center with a telephone system text delivery method.

As another alternative to cable, television, and telephone system delivery, the public telephone system may be used to provide access to the Internet, where the Internet web site 279 may be accessed. Electronic books may be ordered, paid for, and delivered directly from the Internet web site 279 over the telephone system.

In any delivery system using the telephone system, individual subscribers may increase the electronic book deliver rate by incorporating high speed modems or other communication devices such as an Integrated Services Digital Network (ISDN) connector, or by use of an Asymmetric Digital Subscriber Line (ADSL) or other delivery methods.

### II. The Home System

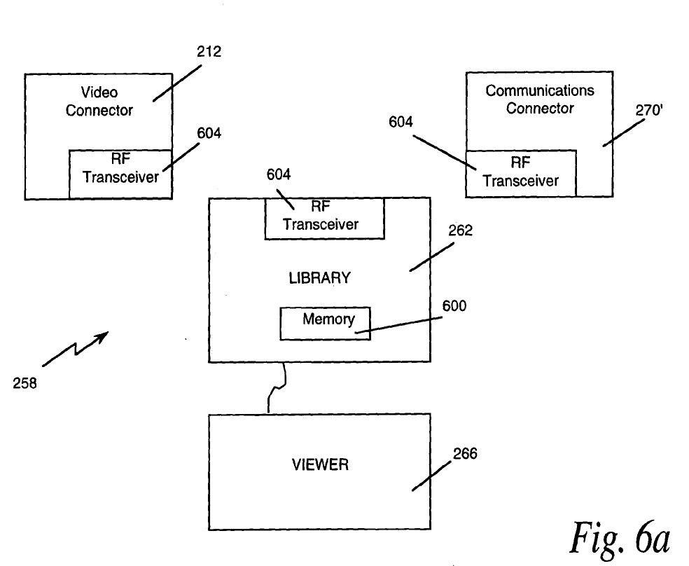

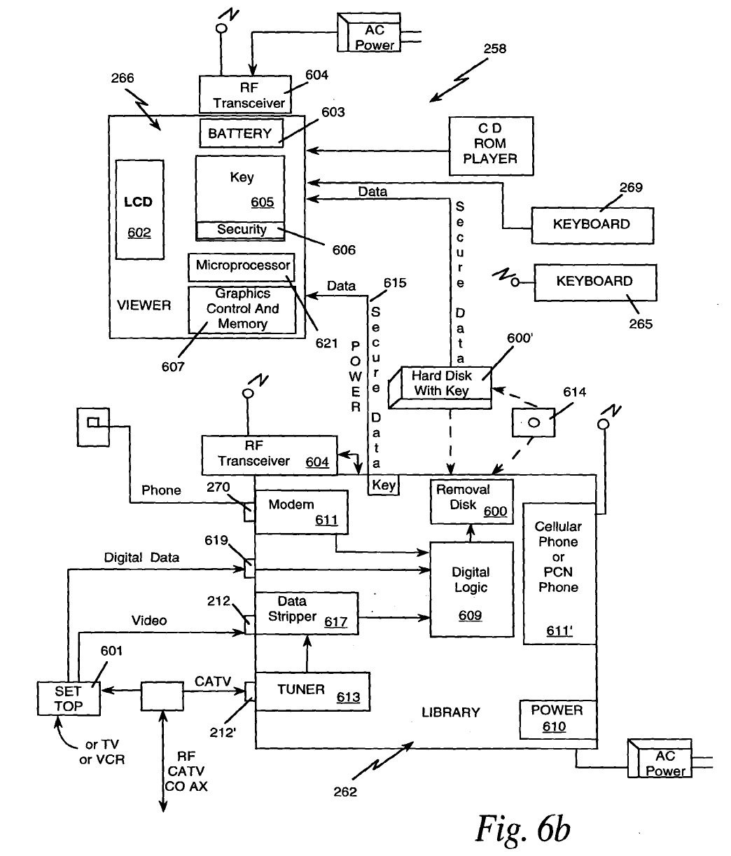

The hardware configuration for a four component home system 258 is shown in FIG. 6a. FIG. 6b shows a hardware configuration for a two component home system. The home system 258 performs several functions, such as receiving data and video transmissions, stripping (or extracting) the data from the video signal, screening and storing the data, providing user friendly interface controls and software, displaying menus and text, processing transactions, initiating telephone calls and transmitting billing data. Various hardware configurations may be utilized to achieve the desired functions of the home system 258. For example, as shown in FIG. 6b, the home system 258 can be configured to utilize the reception and channel tuning capability of the current installed subscriber base of cable converter boxes and televisions 601. The home system 258 can also be designed as an advanced set top terminal terminal box with menu generation capability, electronic memory and a telephone modem as described in section V below.

The electronic components that make up the home system 258 can be arranged in a variety of ways. In the four unit subsystem of FIG. 6a the viewer 266 and library 262 are wired together while the remaining components communicate through RF transceivers 604. In a simple version of the home system 258 there are only two units, a library 262 and a viewer 266. FIG. 6b shows a two unit home system 258 with certain optional features.

The viewer 266 is generally equipped with a high resolution viewing area 602, digital logic (including a key 605, security 606, and a microprocessor 621), video graphics control and memory 607, power supply circuitry 602 (not shown), an optional battery 603 and an optional RF transceiver 604. In a two unit arrangement, the library 262 contains the connector function to the distribution system 208, connector function to a public telephone communications system, and memory 600 (which may be removable and portable 600′). More specifically, the library 262 would include data stripping functions 617, digital logic 609, memory storage 600, power circuitry 610, optional telephone connections 611 (including cellular or PCN 611′), optional battery (not shown), optional tuner module 613 and an optional RF transceiver 604. The video connector 212 and the public telephone system connection 270, as well as the removable portable memory unit 600 of the library may be broken out into separate components. (FIG. 6b shows a removable portable hard disk memory 600′ with removable cartridges 614.) Finally, the home system 258 may include an attached keyboard 267 or a wireless keyboard 268. Both the attached keyboard 267 and the wireless keyboard 268 may be used to communicate with the viewer 266 or the library 262.

The wireless keyboard 268 may communicate using radio frequency (RF) signaling for example. Therefore, the home system 258 may have as many as six separate components which communicate with each other. The two, three, four, five, or six separate components which make up the home system can communicate with each other in a variety of ways, including hardwired connection 615, RF transceiver 604 and other wireless methods.

In an alternate arrangement, all functions of the home system 258 may be incorporated into a single unit. The functions of the library 262, for example, may be carried out by a card or chipset in the viewer 266. All communications devices needed to couple the home system 258 to various telecommunications networks may also be incorporated into the viewer 266. All interfaces between the home system 258 and the subscriber may be included in the viewer 266. In this embodiment, the viewer 266 may include a communication device for receiving inputs from a separate keyboard.

RF communications may be used in the home because it allows separate components to be located throughout the home without restriction. The data communicated between the units may be secure data. In addition, the library 262 may provide power to the viewer 266 through the hard wire communication link 615.

To receive and strip the data from the video signal at the subscriber's home, either a cable interface device or cable connector 212 is used. The cable connector device includes a tuner 613, while the cable interface device makes use of existing tuning equipment in the home. In either configuration, data is stripped from the video signal and stored at the subscriber's location in the library 262. The phone connector 270 and modem 611 initiate telephone calls and transmit ordering and billing information to the operations center 250 or billing and collection system 278 or TAMS 298. A digital connector 619 is provided to communicate digital information with the set top 601. The library 262 is the intelligent component of the home system 258, incorporating the hardware and software necessary to store the text data, generate menus and effect the purchase transactions. In addition to an RF transceiver 604, the home library 262 also includes the necessary jacks and connections to allow the system to be connected to the viewer 266. As shown in FIG. 6b, the library 262 communicates the text data to the viewer in a secure format that requires a key 605 for decryption. The text may be decrypted page by page.

a. The Video Connector

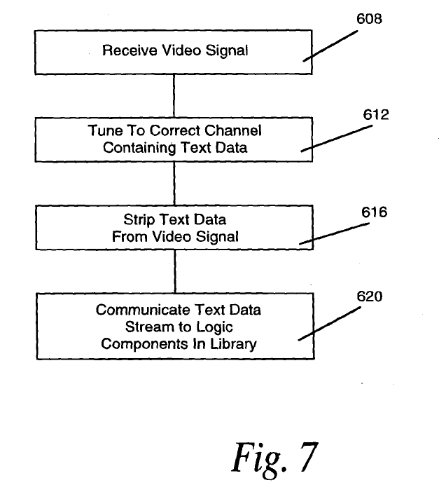

FIG. 7 shows the flow of the processes performed by the video connector 212. The video connector receives the video signal 608, tunes to the channel containing the text data 612, strips the text data from the video signal 616, and communicates the text data stream to logic components in the library 620.

The connection to the video distribution system may be a cable connector to a cable television delivery system, as shown in FIG. 6b. The cable connector includes a data stripper circuit 617, which accepts video input from either a set top terminal, TV or VCR 601, or an optional tuner block 613 that receives the CATV signal through the cable connector 212′. The data stripper circuit 617 strips data out of the video, and outputs a digital bit stream to the digital logic portion 609 of the library unit 262. The data is embedded in the video signal either in the vertical blanking interval or the active video portion in an encrypted and compressed format. The data stripper circuit 617 can be placed inside the set top terminal 601, TV, or in the library unit. The data stripper circuit 617 outputs the digital bit stream to be used by the library digital logic 609.

The video connector 212 may also contain a channel tuner module 613 that can tune to the video channel and provide access to the video that contains the data to be stripped. Using the optional tuner module 613, a set top terminal, VCR, or TV tuner is not needed in the home system. The optional tuner module 613 would instead receive the CATV signal directly through the cable connector 212.

b. Library

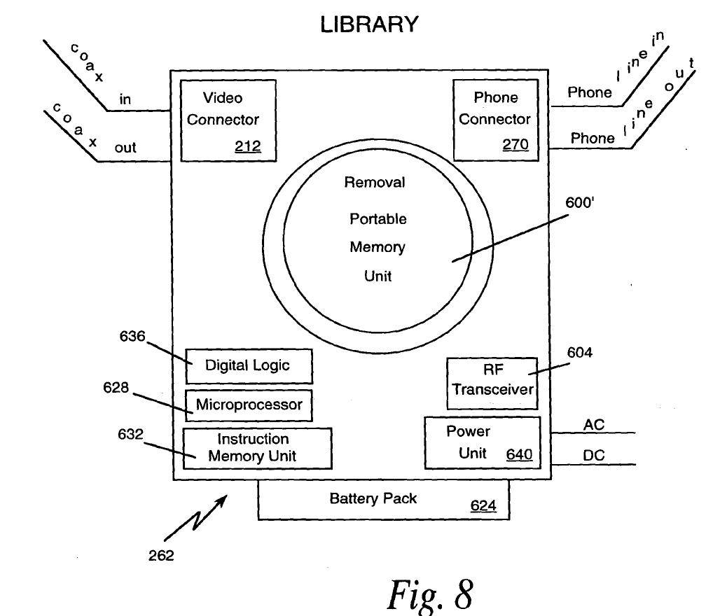

An embodiment of the library 262 for a two unit home system is shown in both FIG. 6b and FIG. 8. The embodiment shown includes the following optional parts: the video connector 212, phone connector 270, RF transceiver 604, and battery pack 624 in addition to a removal portable memory 600′, microprocessor 628, instruction memory unit 632, digital logic 636, and power unit 640.

The library 262 contains a digital logic section 609 (not shown in FIG. 8) which includes the microprocessor 628, the digital logic 636 and the instruction memory unit 632. The microprocessor 628 may be a secure microprocessor such as the Mot SC21 device sold by Motorola. The digital logic section 609 will receive the serial digital bit stream from the data stripper circuit 617 and process the data. Error correction will also be performed by the digital logic section 609 and the data will be checked for proper address. If the address of the data is correct and the library 262 is authorized to receive the data, the data will be transferred to the memory storage unit 600, 600′. Authorization to receive the data is provided by the cable headend or another distribution point. An authorization code may be sent in the serial digital bit stream. The digital logic section 609 will send appropriate text and graphical data to the memory storage unit 600, 600′. It transfers this data in a compressed and encrypted format and the data remains stored in a compressed and encrypted format.

i. Memory Storage Unit

The memory storage unit of the library may be a removable portable memory unit 600′ (as shown in FIGS. 6a, 6b and 8). A variety of options are available for memory storage: a hard disk drive, such as an 80 megabyte, a 200 megabyte, a hard disk with removable platters, a CD ROM or a Memory Stick™. Referring to FIG. 6b, a hard disk drive unit 600′ which contains removable platters may also be used. This would provide virtually unlimited library storage capacity. Data will be stored in the memory storage unit in a compressed and encrypted format. As is also shown in FIG. 6b, the data will also contain a key or unique ID number that matches the ID or key of the viewer 266. This matching of a unique key or ID number prevents unauthorized transfer of text data from the memory storage unit to an unauthorized viewer. Small memory devices such as smart cards, electronic memory cards or PCMCIA cards (personal computer memory card industry association) or Memory Stick™ may also be used to store the data.

ii. Power Circuitry

As shown in FIGS. 6b and 8, the library 262 will accept power from AC wall power 610, DC power 640, or optional battery power 624. Power circuitry 610, 640 may provide all the voltage necessary from either the battery 624 or an AC unit for the various circuitries in the library. The power circuitry 610, 640 may also provide power to the viewer through a single data cable when connected to the viewer. The power circuitry 610, 640 will recharge the battery using AC power when in operation. With the optional battery unit 624 installed, the library 262 becomes a portable unit and can still provide power to the viewer 266. In order to extend battery life, power conservation measures may be utilized, such as shutting down the memory system when not in use. When the viewer 266 is being utilized and the library circuitry is not being utilized, virtually all power may be shut down to the library 262.

iii. Connection to the Public Telephone System

In one embodiment, the connection to the telephone system may be provided by a modem 611. Various available modems may be used to perform this function. As shown in FIG. 6b, cellular phone or PCN phone connections 611′ may also be provided. When the home system 258 is first initialized, the modem will be used to transfer the name and credit card information of the subscriber to the billing and collection subsystem 278. The telephone connection 270 may be utilized each time an electronic book is purchased by a subscriber to complete and record the transaction. The telephone connection 270 may also be used as a means for receiving the text data from the operations center 250, by-passing the distribution system 208 or to allow forwarding of collected subscriber information, including electronic books read data and advertisements viewed data, to the TAMS. The phone connection 270 may be a separate unit as shown in FIG. 6b.

iv. Library Processing

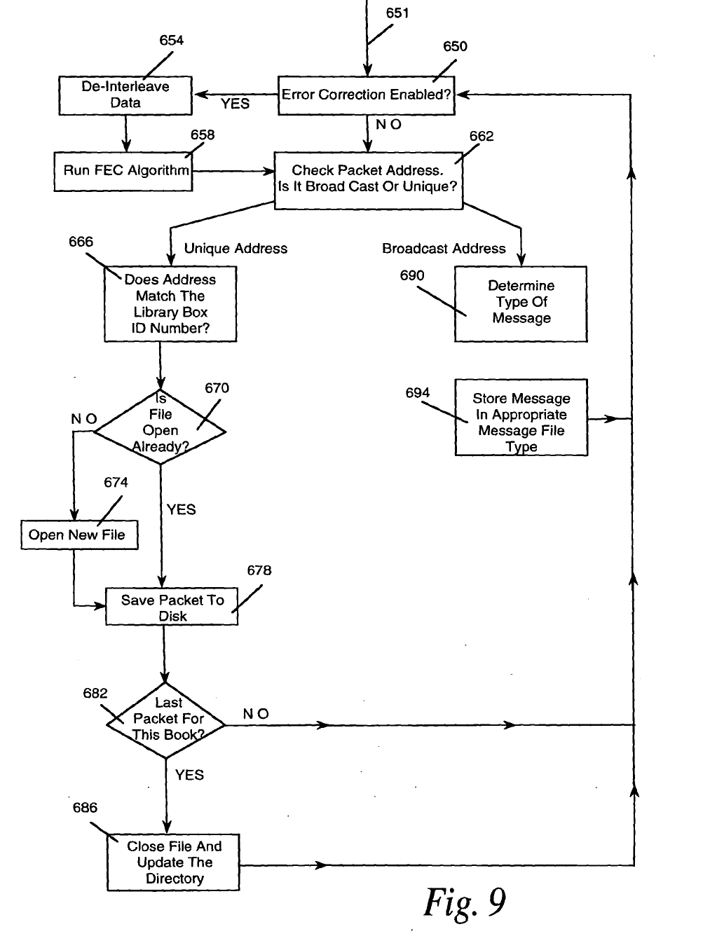

FIG. 9 shows an example of some basic processing performed by the library 262 on the data stream 651 received from the video connector 212 or stripper circuit 617. First the data stream 651 is checked for error correction (block 650). If an error is detected, (block 654) the microprocessor 628 de-interleaves the data and then runs a FEC (Forward Error Correcting) algorithm (block 658). The microprocessor 620 then performs the error correction needed on the data stream (blocks 650, 654 and 658). If no error correction is necessary the data packets are individually checked for packet address (block 662).

If the address is a unique address, the microprocessor 628 checks whether the address of the packet matches the library box ID number (block 666). This packet could be a command to provide the library 262 with a unique group assignment or advertisements that are specifically targeted to that library 262. The library ID number is a unique number associated with that library 262, which is used to ensure security of the data. Next, the microprocessor 628 determines whether an electronic file has already been opened into which the data packet can be saved. If no data file has been opened then the microprocessor 628 opens a new data file for that packet (block 674). If an electronic file has been opened, then the data packet is saved in that electronic file on disk (block 678). Next, the microprocessor 628 checks to see if this is the last data packet for a particular electronic book for a particular textual data block being received (block 682). If the data packet is the last packet of information, then the electronic file is closed and the directory of available electronic files is updated (block 686). Then the microprocessor 628 returns to receive another data packet from the data stream received from the data stripper (block 650).

If the packet address is checked and the address is determined to be a broadcast address, the process determines the type of message that is being sent (block 690). The message may be an index of electronic book titles, menu (and menu graphics) information, announcements, special offerings, discounts, promotions, previews, etc. or, a set of advertisements with the corresponding groups assigned for targeting. The message is then stored in appropriate electronic message file (block 694) and the microprocessor 628 returns to receive another data packet and perform another error check (block 650).

Using the process of FIG. 9, the library 262 is able to receive, store and update directories related to the textual data and graphical data (that can be used to depict pictures in a given electronic book or to generate menus). Variations of the processes are possible depending on the format of the data and operating system of the library 262.

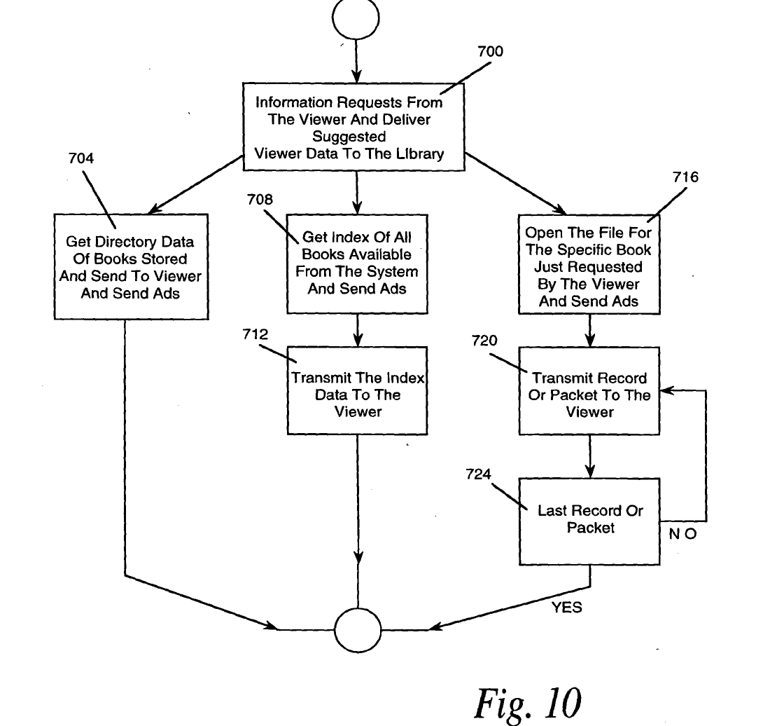

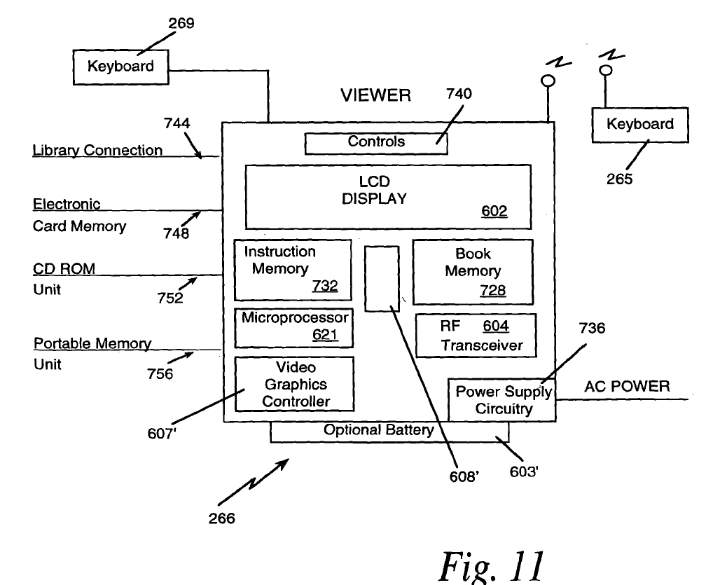

FIG. 10 shows an example of the processing of information requests from the viewer 266 at the library 262. Information requests from the viewer 266 are received either through the cable connecting the viewer 266 to the library 262 or through wireless transmissions such as RF. In an embodiment, the subscribers' requests may come from a set top terminal 602 (see Section V).

Information requests received from the viewer 266 may fall into three or more categories: (1) directory data of electronic books stored in the library 262, (2) index of all available electronic books on the system 200, and (3) requests for a specific electronic book (block 700). Regardless of the type of request, whenever communications takes place, the viewer 266 also provides the library 262 with any collected viewer data to date that will be used on the advertisement targeting process. As shown in block 704, the microprocessor 628 answers a request from the viewer 266 for a directory of data showing the electronic books stored at the viewer 266. The directory of data is sent to the viewer 266 so that the data may be displayed to the subscriber. In block 708, the microprocessor 628 is shown handling requests from the viewer 266 for an index of all available electronic books on the system 200. The library 262 will obtain an index of all the available electronic books on the system and transmit that index, (block 712), with menu information to the viewer 266. The microprocessor also replies to a request from the viewer 266 for a specific electronic book (block 716). The library 262 opens an electronic file for the specific electronic book requested by the viewer 266 and transmits the record or transmits the information on a packet-by-packet basis to the viewer (block 720). This process of transmitting the specific electronic book, record, or packets to the viewer continues until the last record or packet has been sent (block 724). Additionally, the library 262 may download any advertisements to the viewer 262 that may be pending.

In addition to the processes shown in FIG. 10 for handling a request for a specific electronic book, the library 262 also orders and receives specific electronic books from the operations center 250 using the process as described in block 716. Following a request for a specific electronic book that is not stored at the library 262, the library 262 will proceed to determine the next available time the electronic book will be on the distribution system 208 and ensure reception and storage of that electronic book (process not shown). In performing this process, the library 262 will transmit to the viewer 266 information on when the library 262 will obtain the text data for the electronic book so that the subscriber may view the electronic book. In addition to timing information, price and other ordering information may also be passed by the library 262 to the subscriber.

c. The Viewer

FIG. 11 is a block diagram of a viewer 266 showing its internal components. The viewer 266 of FIG. 11 is similar to the viewer 266 depicted in FIG. 6b. The viewer 266 is designed to physically resemble a bound book. The viewer 266 may be made up of five primary components and seven optional components: (1) LCD display 602, (2) digital circuitry (not shown), (3) video graphics controller 607′, (4) controls 740, (5) book memory 728, (6) optional power supply circuitry 736, (7) optional battery 603′, (8) optional RF transceiver 604, and (9) optional cellular or mobile communicator (such as 611′) (10) optional keyboards 267 and 268, and (11) an optional speaker/microphone 608′, (12) optional alternative communication interface devices.

(1) A high resolution LCD screen 602 may be used by the viewer 266 to display text and graphic images. In one embodiment, the screen 602 may be the size of one page of a book. A two page screen or two screens may also be used with the viewer 266.

(2) Digital circuitry includes a secure microprocessor 621, instruction memory 732, and digital logic. Data may be transferred to the viewer 266 in compressed and encrypted format. The secure microprocessor 621 compares the ID number of the viewer 266 with the incoming data stream and only stores the text data if the ID number of the viewer 266 matches that of the incoming data stream. In an embodiment, the viewer 266 not output text data or other data and that the data is decompressed and decrypted only at the moment of viewing and only for the current page being viewed. These measures may be used because they provide additional security against unauthorized access to data.

(3) A video graphics controller 607′ that is capable of assisting and displaying VGA quality text and graphic images is included in the viewer 266. The graphics controller 607′ is controlled by the digital circuitry described above. Text may be displayed in multiple font sizes.

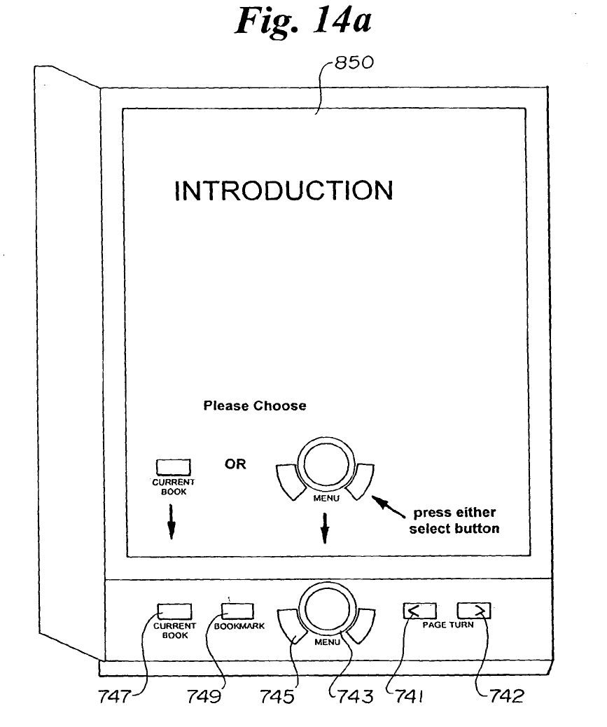

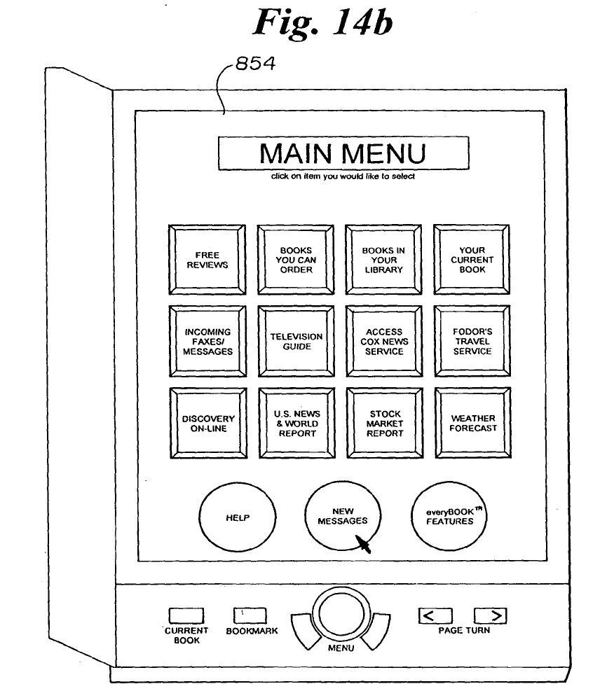

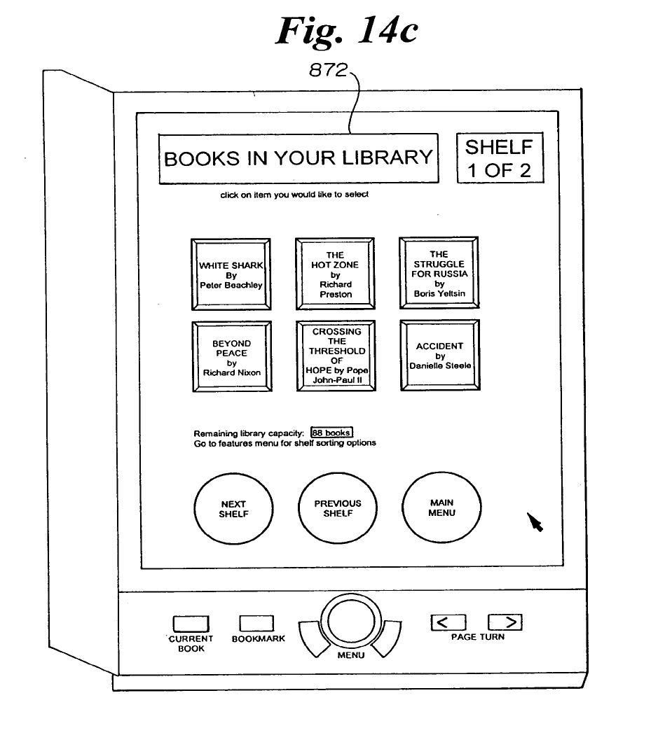

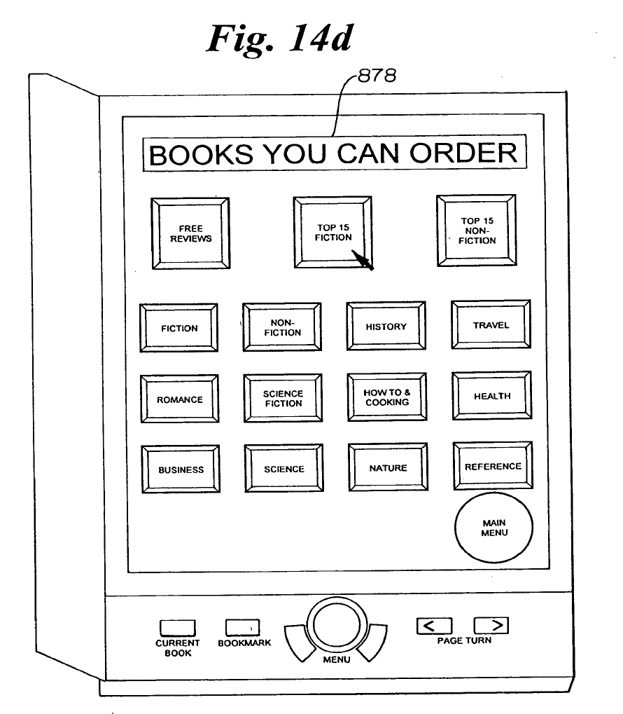

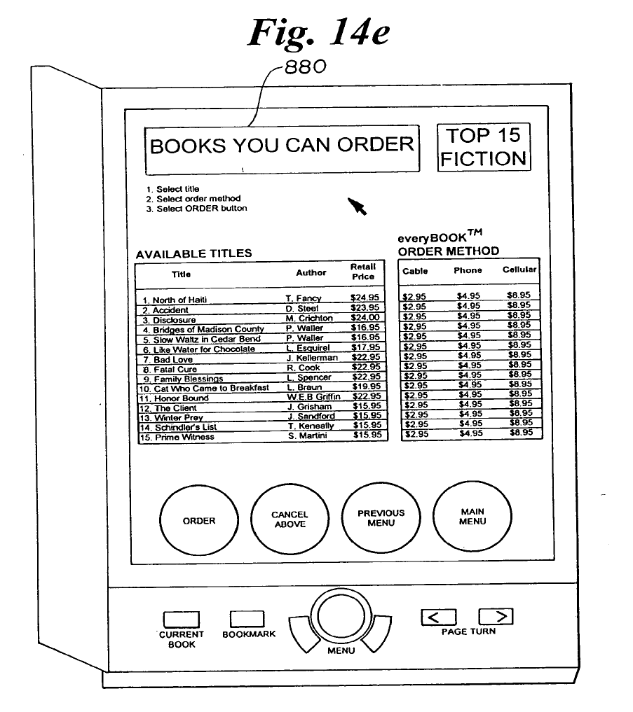

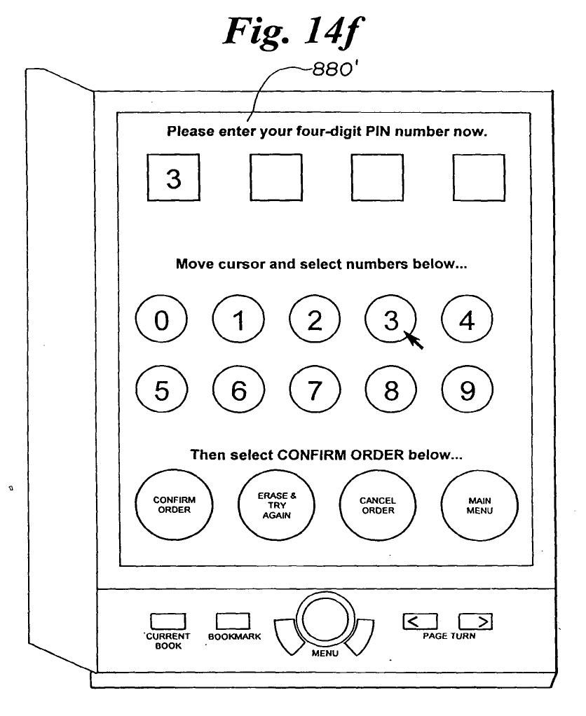

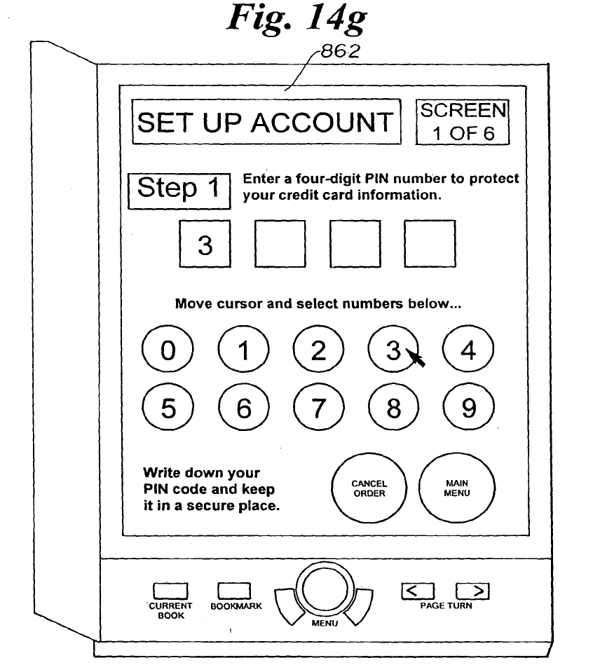

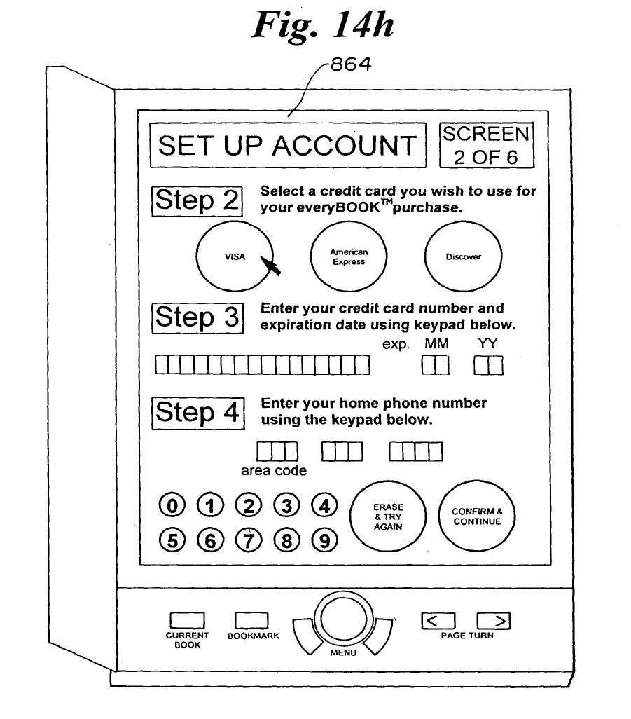

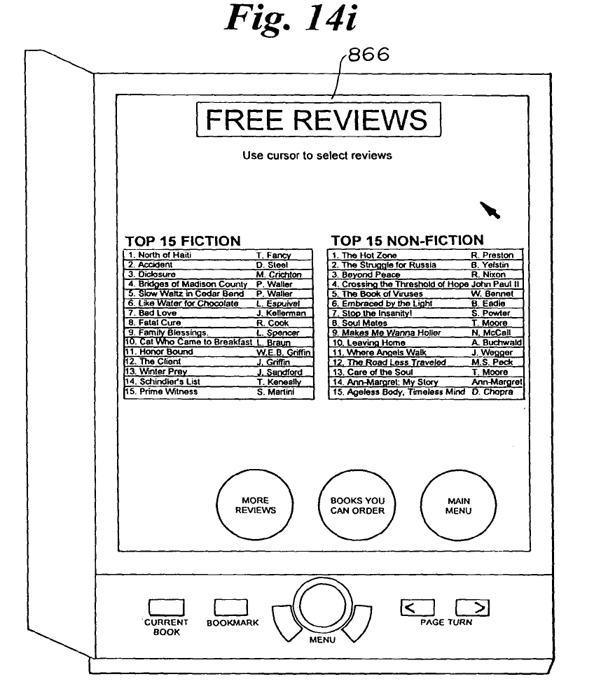

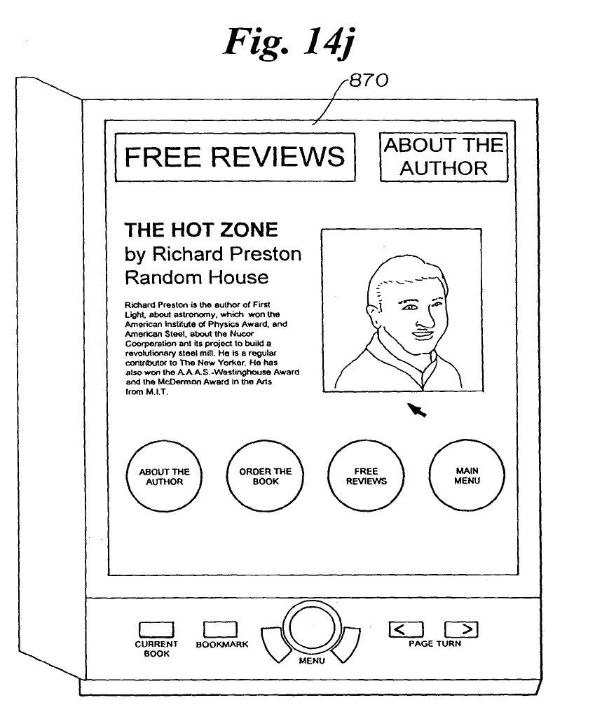

(4) The viewer 266 of FIG. 11 has touch panel controls 740. These unique and novel controls 740 allow the subscriber to select stored electronic books and electronic books from catalogues, move a cursor, and turn pages in an electronic book. The controls 740 may include forward and reverse page buttons 742, 741, a ball 743 for cursor movement, one or more selection buttons 745, a current electronic book button 747 and a bookmark button 749 (see FIG. 14a).

The controls 740 should be easy to use and conveniently located. Referring to FIG. 14a, the controls for the viewer 266 may be located below the screen 602 at the bottom portion of the viewer 266. The next page turn button 742 is the most used button 740 and may be located towards the right edge of the page. The subscriber is likely to use right hand thumb movements to work the controls particularly the page turn buttons 741, 742. Therefore, the buttons may be arranged in such a manner that the buttons are easily controlled by a subscriber's right thumb. Generally, this can be accommodated either on the lower portion of the viewer 266 (as shown) or along the right hand margin of the viewer 266 (not shown). The current electronic book button 747 and bookmark button 749 are usually the least used of the controls 740. Therefore, in the example shown those buttons 747, 749 are located on the inside portion towards the binder of the viewer 266. Locating the ball 743 or other cursor movement device (such as four pointer arrows not shown) in the bottom center of the viewer 266 is both easier for the subscriber to use and easier in manufacturing the viewer 266. The selection buttons for the cursor 745 may be located below the middle diameter of the cursor ball 743 on the right and left sides of the ball as shown. If pointer arrows are used for cursor movement, a selection button 745 may be located in the center of the four arrow buttons (not shown). Again, the most used controls 740 should be located where a subscriber's right hand thumb would normally rest.

(5) Book memory 728 for at least one electronic book or more of text is included in the viewer 266. The memory 728 stores text and any graphics that represent pictures in the electronic book. The memory 728 can also store menu graphics data. Two different memory 728 devices may be used in the viewer 266, one for the instructions for the microprocessor 621 in the digital circuitry and a second type of memory may be used for the book memory 728 (and graphics). Various memory devices available on the market may be used such as, ROM, RAM or a small hard disk. Since an electronic book requires approximately 0.6 megabytes of storage, a small hard disk providing approximately 600 MBytes of storage provides memory to store approximately 1000 electronic books.

Text for electronic books may be displayed in various font sizes. To accommodate various fonts for display, a variety of fonts are stored in instruction 732 or book memory 728. Thus larger or smaller fonts may be recalled from memory 621, 728 to create displays desired by the subscriber.

(6) Power supply circuitry 736 in the viewer 266 will accept power from either an AC power source or from an optional battery 603′, or the library 262. The power supply circuitry 736 provides the necessary voltages to accommodate the various systems within the viewer 266.

(7) An optional battery 603′ is provided in one embodiment. The battery 603′ is automatically recharged when AC power is available.

(8) An optional RF transceiver 604 that provides two-way data link between the viewer 266 and other components of the home system 258 can also be included in the viewer 266.

(9) The viewer 266 may include a cellular transceiver 608 (not shown in FIG. 11) for mobile communications.

(10) The optional wired (attached) keyboard 267 and wireless (e.g., RF) keyboard 268 may be used with the viewer 266 to provide communications between the subscriber and the viewer 266.

(11) The optional speaker and microphone 608′ allow the viewer 266 to provide audio signals to the subscriber, and allow the subscriber to provide an audio input. The speaker and microphone 608′ may be used in conjunction with the cellular transceiver 608 or other telecommunications equipment to provide for reception and transmission of telephony and data.

(12) The optional alternative communication interface devices allow the viewer 266 to make use of a variety of communication paths.

The viewer 266 of FIG. 11 has parts available for providing connections to: a library 744, electronic card memory 748, CD ROM units 752, and a portable memory unit 756 (such as that shown in FIG. 6b 600′). Various electronic memory cards such as a PCMCIA can be used with the viewer 266.

Security, low power consumption and excellent display technology are desired features of the viewer 266 design. The viewer 266 may be lightweight and portable. The viewer 266 contains a software operating system that allows electronic books to be stored, read and erased and includes the capability to order electronic books and retain them in memory 728 for a predefined period of time determined by the system operator. For example, the software can be configured to allow the electronic book to be read during a period of time (i.e., two weeks) and then automatically erased, read once and erased, or held in memory permanently. Each viewer 266 has a unique key 605. All of the data storage is encrypted with the key 605 for an individual viewer 266 to prevent more than one viewer device 266 accessing the text file or book file.

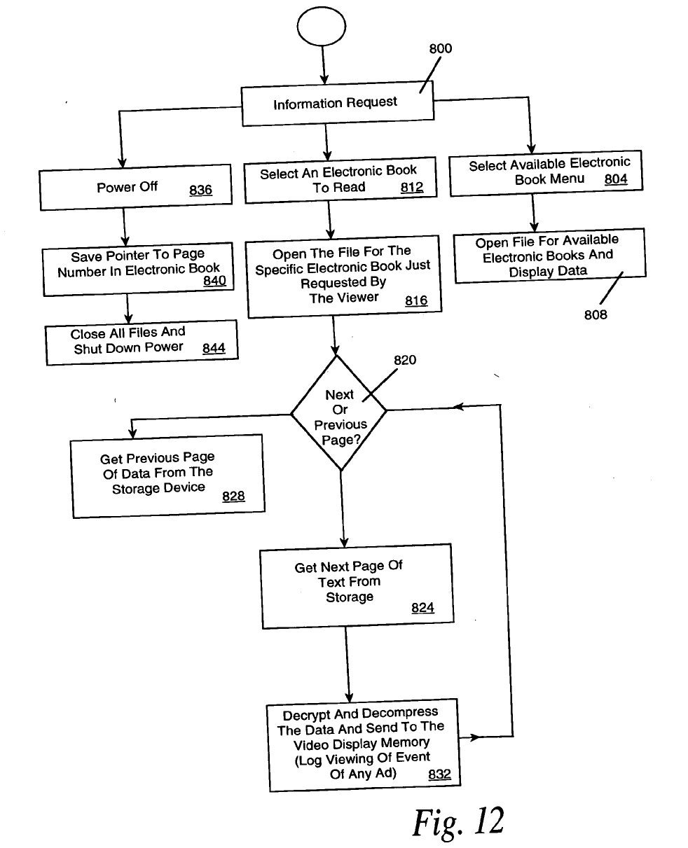

FIG. 12 is a flow diagram of some of the processes executed by the viewer 266. Generally, the viewer 266 receives inputs from the subscriber through touch panel controls 740. The subscriber's information requests are then processed by the viewer 266 (block 800).

If the subscriber requests a menu of available books, the microprocessor 621 will select a book menu (block 804). The microprocessor 621 will open the electronic files that list the electronic books that are available (related to the category of topic of the menu) and display the menu with the names of the available electronic books.

If the subscriber selects a particular electronic book to read, the microprocessor 621 will process the selection and determine the electronic file that contains the specific electronic book (block 812). Then, the microprocessor 621 will open the file for that specific electronic book and normally access the first page (block 816). (If a pointer has already been set in the electronic book, the microprocessor 621 may default to that page.) The microprocessor 620 will then determine which page needs to be displayed (block 820). The microprocessor 621 will determine whether a next page, previous page or a bookmarked page needs to be displayed (block 820). If the pointer for the electronic file is not in the correct location, then the microprocessor 621 will move the pointer and obtain the previous page of data from the stored file (block 828). Otherwise, the microprocessor 621 will normally obtain the next page of text from the stored electronic file (block 824). The microprocessor 621 will decrypt and decompress the text data and send the data to the video display 602 (block 832). The video display 602 will generally have a video display memory associated with it and the microprocessor 621 will send the data directly to that video display memory (block 832). The circuitry for the video display 602 then completes the process of displaying the page of text. The viewer 260 also logs the viewing of advertisements and book contents that will be provided back to the TAMS 298 using the library 262.

If the subscriber, through the controls 740, requests that the power be turned off, then the process of turning the power off will be initiated (block 836). The microprocessor 621 saves the pointer in memory to the page number in the electronic book that the viewer 266 is currently reading (block 840). The microprocessor 621 closes all the electronic files and signals the power circuitry to shut down the power to the various circuits in the viewer 266. With these examples of basic processes the viewer 266 is able to display electronic book selections and display text from those electronic books.

d. Menu System

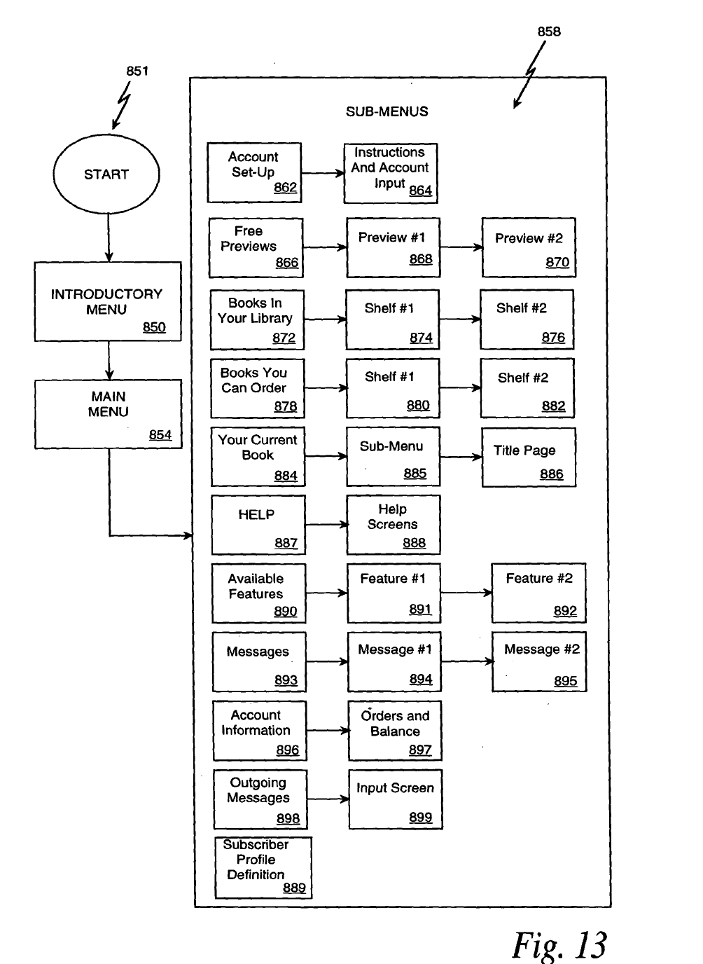

Referring generally to FIG. 13, the electronic book system 200 may have a menu system 851 for selecting features and books from the electronic book system 200. The operating software and memory required for the menu system 851 may be located at the viewer 266 (e.g., the instruction memory 732 and/or book memory 728). However, it can also be located at the library 262 (e.g., the instruction memory 632) or the library 262 and the viewer 266 can share the software and memory needed to operate the menu system 851. Since the menus are usually displayed on the viewer 266 and the viewer 266 may be capable of operating in the absence of the library 262, the basic software and memory to create the menus is more conveniently located at the viewer 266.

In one embodiment, the menu system 851 may be a system that allows sequencing between menus and provides menu graphics for graphical displays such as on the LCD display 602 of the viewer 266. In a system that uses a set top terminal or a portable computer, these menus may also be displayed on a television screen or the computer screen. In the simplest embodiment, the menus provide basic text information from which the subscriber makes choices. In more sophisticated embodiments, the menus provide visual displays with graphics and icons to assist the subscriber.

FIG. 13 depicts the menu system 851 with sequencing. The primary menus in the system are an introductory menu 850, a main menu 854 and various submenus 858. The embodiment shown, has three levels of submenus 858. In certain instances, one or two submenus 858 is sufficient to easily direct the subscriber to the selection or information requested. However, there are features in which three or more submenus 858 make the user interface more friendly for the subscriber. Each level of submenus 858 may consist of multiple possible menus for display. The particular menu displayed depends on the selection by the subscriber on the previous shown menu. An example of this tree sequence of one to many menus are the help submenus 887, 888. Depending upon the specific help requested, a different level two help menu is displayed to the subscriber.

An example of an introductory menu 850 is shown on FIG. 14a. Generally the introductory menu 850 introduces the viewer 266 to the system and provides initial guidance, announcements and instruction. The introductory menu 850 is followed by a main menu 854, an example of which is shown in FIG. 14b. The main menu 854 provides the viewer 266 with the basic selection or features available in the system. FIG. 14b is an example of a main menu 854 offering many additional features and submenus 858 to the subscriber. For example, FIG. 14b shows that the viewer 266 is able to choose by a point and click method, many options including: (1) free previews, (2) books you can order, (3) books in your library, (4) your current book, (5) help, (6) on-line services and (6) other system features. Following a selection on the main menu 854, a corresponding submenu 858 is shown.

FIG. 13 shows eleven available primary or first level submenus. They are (1) account set up 862, (2) free previews 866, (3) book suggestion entries 855, (4) books in your library 872, (5) books you can order 878, (6) your current book 884, (7) help 887, (8) available features 890, (9) messages 893, (10) account information 896 (11) outgoing message submenu 898. FIG. 14c is an example of a first level submenu for books in your library 872. The “Book In Your Library” example submenu 872 shows six available books by title and author and provides the subscriber with the ability to check a different shelf of books 874 or return to the main menu 854. FIGS. 14d and 14e show example submenus 858 for books that may be ordered using the “Books You Can Order” submenu 878.

FIG. 14f is an example of a confirmation 880′ menu that confirms a subscribers order. In this particular example, the subscriber is required to enter a PIN number to complete the subscriber's order. Any alphanumeric or similar password may be used to ensure the subscriber is an authorized subscriber. In an embodiment, the subscriber confirms an order with a PIN or password and then receives a final confirmation screen. The final confirmation screen is primarily text and may state:
Your book order is now being processed using CABLE.
Your book will be delivered overnight and your VISA account will be charged $2.95.
Your book will be available for reading at 6:00 AM EST tomorrow. Make sure that:
1. your Library Unit and Cable Connection Unit are plugged in with aerials up tonight; and
2. you tune your cable converter to THE BOOK Channel. The TV set does not have to remain on.
   or similar language.

Examples of the “Account Set Up Menu” 862 and further submenus 858 related to account set up (which provide instructions and account input 864) are shown in FIGS. 14g and 14h. These submenus 858 allow initialization of an account at the operations center 250 and orders to be charged to credit cards. The submenus 858 include the ability to enter data related to your desired PIN number or password, credit cards, phone numbers, etc. The account set up may be performed using the telephone system. A confirmation menu verifies that the account has been properly set up with the desired PIN or password and credit card.

Free previews for books 866 are also provided by submenus (868, 870). Examples of the free preview menus are shown in FIG. 14i and FIG. 14j. FIG. 14i shows a menu depicting various electronic books for which previews are available for viewing. Following a book selection, a screen submenu showing an excerpt of the selected electronic book cover's description is provided along with an excerpt from a critic's review of the selected electronic book. In one embodiment, this preview screen for a particular electronic book also allows the subscriber to select a submenu that provides information about the author. The electronic book preview submenu may also include a still video picture or graphics portraying a book cover or a scene from the electronic book. An example of such a still video picture or graphics is shown in FIG. 14j that depicts a preview screen 870 about the author. The author's preview screen 870 shows a picture of the author, provides a short biography, and may allow the subscriber to order the author's books. The price for ordering the authors various electronic books may also be shown on the menu.

In addition to free previews, in more sophisticated embodiments, the system provides the subscriber with a book suggestion feature (see 855). This is accomplished using the menu system 851 and the processor with associated memory located at the viewer 266, library 262 or at the distribution point (1020 or 250). When necessary, information for the program suggestion feature is sent in the text data of the composite or video signal to the home system 258. With this feature, books or authors are suggested to a subscriber based upon historical data of the subscriber's previous orders, demographics or mood of the subscriber, other indicators, and/or by text word searches.

In one book suggestion embodiment, text word searches of preview information (such as book cover descriptions, critics reviews and biographies about the author) and/or text of electronic books or other titles are performed by the library 262 using databases stored in the library memory 600. Personalized electronic book or author suggestions are made to the subscriber by obtaining information from the subscriber indicative of general subscriber interests. Subscriber entries may be solicited from the subscriber using the electronic book suggestion entries submenu 855. The system uses these subscriber entries either directly or indirectly to search for electronic books or authors to suggest to the subscriber. The system also uses this subscriber information for targeting advertisements.

Generally, the electronic book suggestion methods may be categorized into two categories, either responsive methods (which respond to a series of subscriber menu entries), or intelligent methods (which analyze data to suggest a book). Using a responsive or intelligent method, the system 200 determines a list of suggested titles or authors and creates a second or third level submenu 856, 857 to suggest the titles for subscriber selection.

Responsive methods of suggesting titles include, for example, the use of mood questions, searching for authors, and keyword searching. Using the instruction memory 732 and menu generation hardware (e.g., 607) of the viewer 266, a series of mood questions can be presented on menus to determine a subscribers interest at a particular time. For this methodology, the operations center's 250 processor 404 and instruction memory 416 assign each title mood indicators (and sub-indicators) from a group such as light, serious, violent, short, long, dull, exciting, complex, easy-read, young theme, old theme, adventure, romance, drama, fiction, science-fiction, etc. These indicators are sent to the home system 258 with the text data and are stored in library memory 600. Based upon the subscriber entries, the processor associates a set of indicators with the subscriber's request and a set of electronic books with matching indicators are located for suggesting to the subscriber. These indicators may also be used for categorizing subscribers for the purposes of targeting advertisements.

Responsive searches for authors or keywords (a search word provided by the subscriber) are generally performed by the library processor 628 and instruction memory 632 on data stored in the library's memory storage 600. For example, a keyword given by the subscriber may be searched for a match in library memory 600 storing the electronic book reviews, critics and previews databases. Thus, if a subscriber provided an entry of the word “submarine” on an appropriate submenu, the title “Hunt For Red October” may be located by the library microprocessor 678 using instruction from a routine in instruction memory 632.

Intelligent methods of suggesting programs include analyzing personal profile data on the subscriber and/or historical data about the subscriber such as past electronic books ordered by the subscriber (or buy data). This method may be used in an electronic book on demand system and may be performed at the distribution point or operations center 250 by the on-site processor 404 using subscriber databases stored in memory 428. The home system 258 receives the text data including program suggestion information from the distribution point or operations center 250 and generates the program suggestion submenus 855, 856, 857 using the same text data receiving 212 and viewer menu generation hardware (e.g., 607, 621) described above. Software routines and algorithms stored in instruction memories (e.g. 632, 732) are used to analyze historical data and electronic book ordered data to determine a line of electronic books to suggest to the subscriber.

The algorithms for this powerful feature of suggesting electronic books or authors to subscribers is disclosed in great detail in a co-pending application by the same inventor, U.S. application Ser. No. 08/160,281 and PCT/US93/11708 entitled REPROGRAMMABLE TERMINAL FOR SUGGESTING PROGRAMS OFFERED ON A TELEVISION PROGRAM DELIVERY SYSTEM, filed Dec. 2, 1993, and is incorporated herein by reference.

Referring to FIG. 13, submenus 858 are shown on the “Books In Your Library” submenu 872 and may be broken into shelf numbers with submenus for each shelf 874, 876. The submenus 858 for the “Books You Can Order” submenu 878 is similarly broken out into submenus by shelves 880, 882. These shelves may each be a category or genre of electronic books. Electronic books may be grouped into categories such as best sellers, novels, fiction, romance, etc. See FIG. 14d.

Referring to FIG. 13, the submenu 858 for “Your Current Book” 884 allows a subscriber to select a current electronic book 884 and then determine what page to view. This selection is confirmed with a level two submenu 885. The help submenu 887 provides the subscriber with additional help screens 888. The submenus 858 for available features 890 may be broken out into a sequence of separate submenus for each feature 891, 892.

Referring to FIG. 13, messages can also be sent with the electronic book selection and delivery system 200. A level one message screen provides the subscriber with the ability to select from various messages the subscriber has pending 893. Each message is then shown on a separate submenu screen 894, 895. The message may contain text and graphics.

Referring to FIG. 13, account information is shown on a level one submenu 896 and then follow-on submenus 858 show the recent orders and account balance 897. There is also a level one submenu for outgoing messages 898 which has a follow-on submenu used as an input screen 899. Menu 889 allows the subscriber to enter a subscriber profile, which may be used for future targeting of advertisements based on how that subscriber profile corresponds to an advertisers' desired targeted audience.

In addition to the specific features and submenus described in FIG. 13 and FIG. 14a through FIG. 14j, many other variations and features are possible. When an electronic book is finally selected for viewing, the title page 886 will appear on the screen followed by a page of text.

### III. The Billing and Collection System

In one embodiment, the billing and collection system 278 (shown in FIGS. 2 and 3) utilizes the latest technology in electronic transaction and telephone switching to track orders, authorize deliveries, bill subscribers, and credit publishers automatically. The telephone calls initiated by the phone connector 270 are received by the billing and collection system 278 that responds immediately without human intervention by placing the order and charging the subscribers credit card account. Data is compiled periodically and publishers 282 are credited for sales of their books or other text. The billing and collection system 278 may also connect with subscribers through two-way cable connections, cellular or other communication means.

In another embodiment, the billing and collection system 278 communicates with the operations center to track changes in available books and to provide statistical data to the operations center 250, including books read and advertisements watched data.

### IV. Public Library, School, and Bookstore System

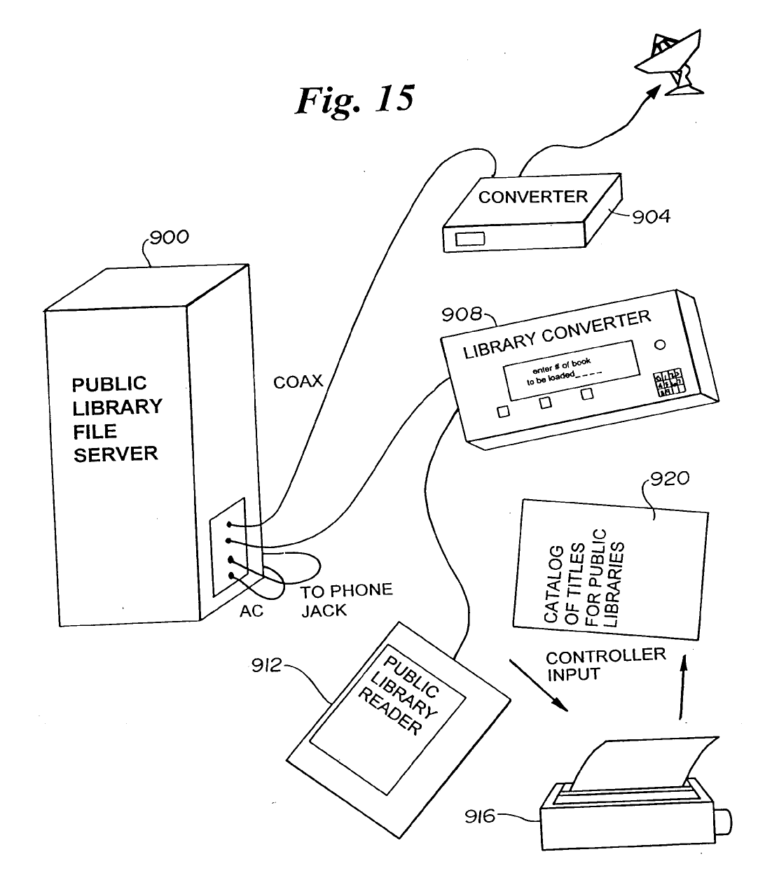

The electronic book system 200 can be modified to be used at public libraries, schools and bookstores. FIG. 15 shows one possible arrangement of components for a public library, school or bookstore location. The main unit at a public library, school or bookstore is the file server 900. The file server 900 is a large electronic memory unit that can store thousands of electronic books. Various electronic storage means may be used in the file servers, such as hard disks, read-write CD ROMs and read-only CD ROMs.

The system includes five components; the file server 900, a converter or video connector 904, a controller 908, a viewer 912, and a catalog printer 916. The software for controlling the system is primarily located in the controller 908. The converter or video connector 904 is similar to those described above. In this configuration the controller unit 908 monitors the data being transferred to the file server 900 by the converter 904. The controller 908 may be provided with a viewing screen and several control buttons. When it is necessary to have a larger screen to perform more sophisticated controlling of the system the viewer 266 may be connected to the controller 908 and the viewer screen and controls 740 may be used.

The controller 908 is only able to download electronic books to public viewers 912 that are authorized to receive electronic books from the particular file server 900. For security reasons, it is not desirable that the public viewer 912 have access to more than one file server 900. In this way, security can be maintained over the text data for electronic books. The public viewer 912 may be limited to receiving one or two electronic books at a time from the controller 908. When the user of the public viewer 912 needs a new or additional electronic book, the subscriber returns the viewer 912 to the school or public library where the subscriber receives a new electronic book from the controller 908.

In order to track the electronic books that are available on the file server 900, the titles of the available electronic books may be printed on a catalog printer 916. The catalog printer 916 is connected to the library controller 908 and the titles of the electronic books are downloaded to the catalog printer 916. Preferably, none of the coded text for any of the electronic books can be printed using the controller 908 and catalog printer 916 of this system. In order to maintain security over the data, none of the electronic book data is allowed to be downloaded to the printer 916. Once a complete printout of available electronic book titles, magazines, or other textual material is complete, a hard copy of the catalog 920 can be maintained at the file server 900.

The system shown may also be used at electronic bookstores. The electronic bookstores can rent the public viewer 912 to customers with the text for one or two electronic books loaded onto the public viewer 912. The public viewer 912 may be provided with an automatic timeout sequence. The timeout sequence would erase the textual data for the electronic books after a certain period of time, for example, two weeks. It is expected that after a period of time (perhaps within two weeks) the renter would return the public viewer 912 to the electronic bookstore and receive additional books for viewing. Using this arrangement, it is also possible for the electronic bookstore to sell a viewer 912 to a regular customer. The customer then returns to the electronic bookstore from time to time to receive textual data for an electronic book that the customer can then store permanently on the customer's own viewer 266. Various other configurations are possible for bookstores, schools and public libraries using the file server 900 and public viewer 912 described.

### V. Use of Set Top Terminal

Existing set top terminals such as those made by Scientific Atlanta or General Instruments are presently unequipped to handle the electronic book selection and delivery system 200. Although set top terminals may be built that include the library functions, hardware modifications are necessary in order to use the electronic book selection system 200 with existing set top terminal technology.

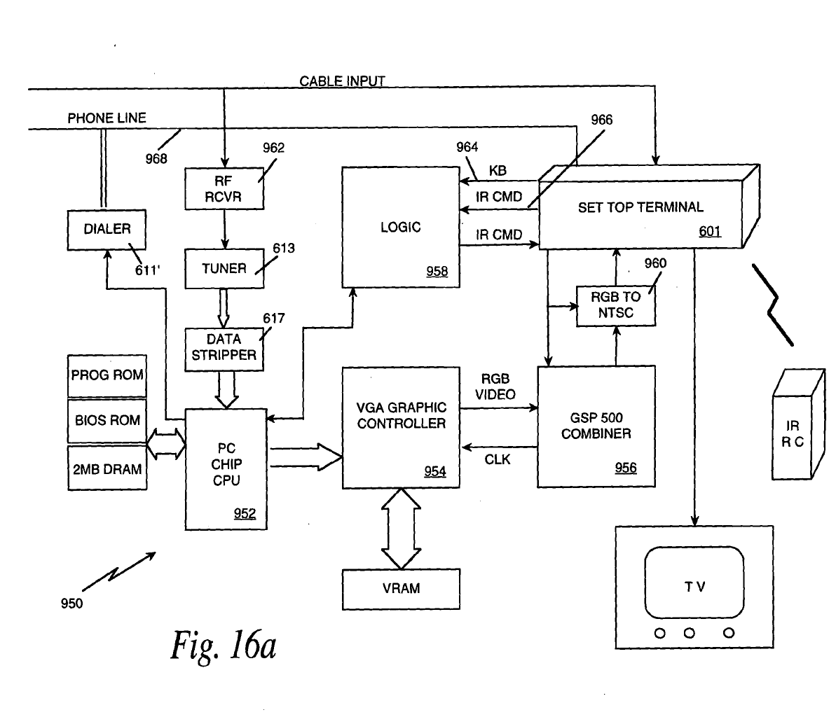

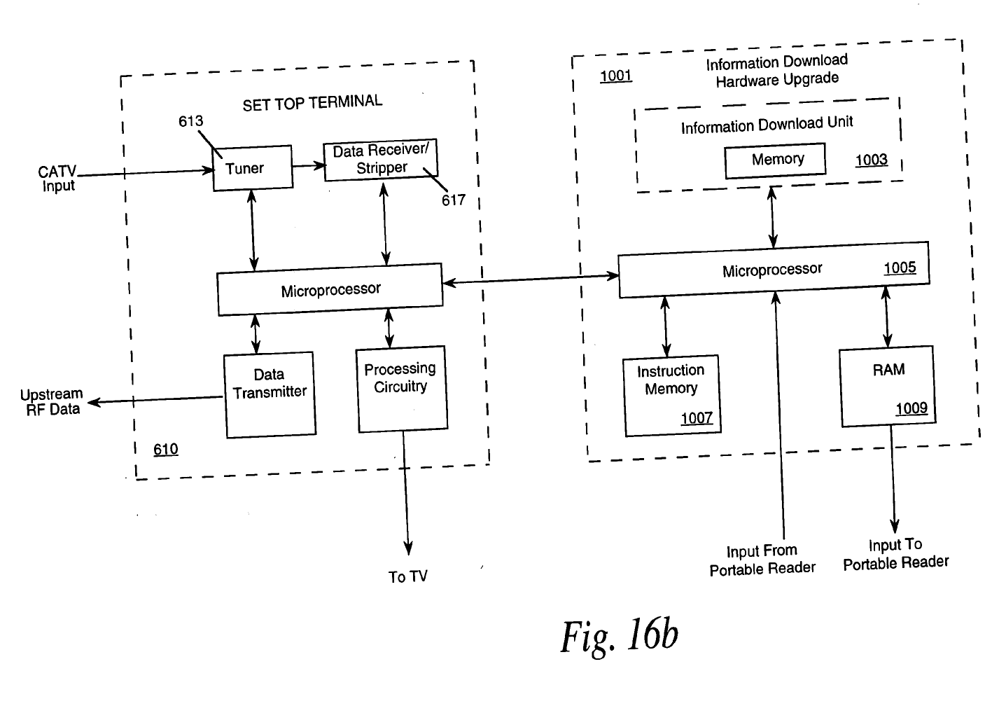

FIGS. 16a and 16b are examples of hardware modifications or upgrades. A port is used to attach hardware upgrades described below to a set top terminal. Two upgrades are possible to set top terminals 601 to assist in receiving and selecting electronic books. A menu generation card upgrade (FIG. 16a) and an information download unit (FIG. 16b). Each of these upgrades may be connected to the set top terminal unit through an upgrade port. A four wire a cable, ribbon cable or the like may be used to connect the upgrade to the set top terminal 601.

A card addition 950 to a set top terminal 601 is depicted in FIG. 16a. The card 950 shown provides the additional functionality needed to utilize the electronic book selection and delivery system 200 with existing set top terminal 601 technology. The card 950 may be configured to slip inside the frame of the set top terminal 601. The primary functions the card 950 adds to the set top terminal 601 are the interpreting data signals, generating menus, sequencing menus, and allowing a subscriber to select an electronic book using either the television or the viewer 266. The card 950 also provides a method for a remote location, such as the cable headend, to receive information on electronic books ordered. The electronic books ordered information and control commands may be passed from a cable headend (not shown) to the card 950 using telephone lines or alternative ordering methods as present in the co-pending U.S. application Ser. No. 09/289,957 entitled ELECTRONIC BOOK ALTERNATIVE DELIVERY SYSTEMS, filed Apr. 13, 1999, and U.S. application Ser. No. 09/289,956 entitled ELECTRONIC BOOK ALTERNATIVE DELIVERY METHODS, filed Apr. 13, 1999.

The primary components of the card 950 are a PC chip CPU 952, a VGA graphic controller 954, a video combiner 956, logic circuitry 958, NTSC encoder 960, a receiver 962, demodulator (not shown), and a dialer 611′. The card 950 operates by receiving the data text signal from the cable headend through the coaxial cable. The logic circuitry 958 of the card 950 receives data 964, infrared commands 966, and synchronization signals (not shown) from the set top terminal 601. Menu selections made by the viewer 266 on the remote control are received by the set top terminal's 601 IR equipment and passed through to the card 950. The card 950 interprets the IR signal and determines the electronic book (or menu) the subscriber has selected. The card 950 modifies the IR command to send the information to the set top terminal 601. The modified IR command contains the channel information needed by the set top terminal 601. Using the phone line 968 and dialer 611′, the card 950 is able to transmit books ordered information to the cable headend. It is also possible to receive the electronic books over the telephone lines and by-pass the distribution system 208. Furthermore, the electronic book may be distributed using an Internet web site such as the Internet web site 279 shown in FIG. 2.

These commands are passed through the interface linking the set top terminal's microprocessor with the microprocessor of the hardware upgrades. In this way, subscriber inputs, entered through the set top terminal keypad or remote control, can be transferred to any of the hardware upgrades for processing and responses generated therein can then be sent back to the set top terminal for display. In one embodiment the IR commands 966 are transferred from the set top terminal 601 to the hardware upgrade.

Hardware upgrades may include a microprocessor, interactive software, processing circuitry, bubble memory, and a long-term memory device. In addition to these basic components, the hardware upgrade may make use of an additional telephone modem or CD-ROM device.

The information download hardware upgrade 1001 (shown in FIG. 16b) allows the subscriber to download large volumes of information from the operations center or cable headend using the set top terminal 601. The hardware upgrade 1001 will enable subscribers to download data, such as books and magazines, to local storage. Primarily, the hardware upgrade 1001 is an additional local storage unit 1003 (e.g., hard disk, floppy, optical disk or magnetic cartridge and may include a microprocessor 1005, instruction memory 1007, and a random access memory 1009, as shown in FIG. 16b). A small portable viewer 266 may also be provided with the upgrade 1001 to enable downloaded text to be read without the use of a TV.

The downloadable information may be text, advertisements, or graphics supplied by the operations center 250 or cable headend. With this upgrade, electronic books may be downloaded and read anywhere with the portable viewer 266. Using this upgrade, electronic books may be downloaded and stored in compressed form for later decompression. The electronic books would be decompressed only at the time of viewing. Important text that the public desires immediate access may made available through this system. Text such as the President's speech, a new law, or a recent abortion decision rendered by the Supreme Court may be made immediately available.

In an embodiment, electronic book ordering information and electronic books read and advertisements viewed information is stored at each set top terminal 601 until it is polled by the cable headend using a polling request message format. An example of a polling request message format consists of six fields, namely: (1) a leading flag at the beginning of the message, (2) an address field, (3) a subscriber region designation, (4) a set top terminal identifier that includes a polling command/response (or P/F) bit, (5) an information field, and (6) a trailing flag at the end of the message. A similar response frame format for information communicated by the set top terminal to the cable headend in response to the polling request may be used.

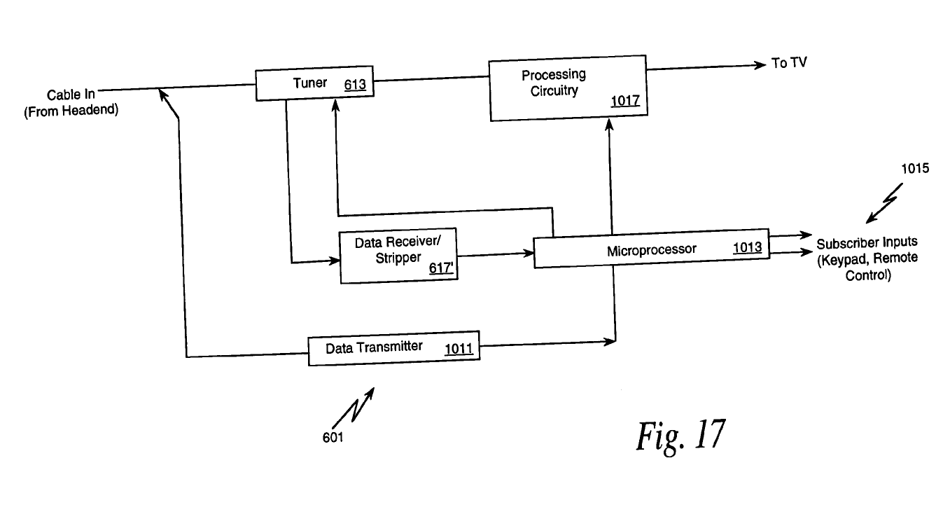

FIG. 17 shows a set top terminal 601 that includes a data receiver 617′ and a data transmitter 1011. The data transmitter provides upstream data communications capability between the set top terminal 601 and the cable headend. Upstream data transmissions are accomplished using the polling system described and, using a data transmitter 1011. Both receiver 617′ and transmitter 1011 may be built into the set top terminal 601 itself or added through an upgrade module. Regardless of the specific hardware configuration, the set top terminal's data transmission capabilities may be accomplished using the hardware shown in FIG. 17.

FIG. 17 shows RF signals, depicted as being received by a data receiver 617′ and tuner 613 working in unison. Both of these devices are interfaced with the microprocessor 1013, which receives inputs 1015, from the subscriber, either through a set top terminal's keypad, a remote control unit or the viewer 266. All cable signals intended for reception on the subscriber's TV are accessed by the tuner 613 and subsequently processed by the processing circuitry 1017. This processing circuitry 1017 typically includes additional components (not shown) for descrambling, demodulation, volume control and remodulation on a Channel 3 or 4 TV carrier.

In an embodiment, data targeted to individual set top terminals is received by the data receiver 617′ according to each set top terminal's specific address or ID. In this way, each addressable set top terminal only receives its own data. The data receiver 617′ may receive set top terminal 601 specific data in the information field of the signal frame described or on a separate data carrier located at a convenient frequency in the incoming spectrum.

The received data includes information regarding electronic books and menus available for selection. The subscriber may enter a series of commands 1015 using a keypad or remote control in order to choose a book or menu. Upon receipt of such commands, the set top terminal's microprocessor 1013 instructs the tuner to tune to the proper frequency of the channel carrying data and subsequently instructs the processing circuitry 1017 to begin descrambling of this data.

Upon selection of an electronic book, the microprocessor 1013 stores any selection information in local memory (not shown) for later data transmission back to the cable headend. Additionally, electronic books read and advertisements viewed data (and any updated subscriber profile information), can be stored to be sent to the operations center 250 using the headend at the next available polling cycle. The set top terminal's microprocessor 1013 coordinates all CATV signal reception and also interacts with various upstream data transmission components. Typically, the data transmitter 1011 operates in the return frequency band between 5 and 30 MHZ. In an alternative embodiment, the frequency band of 10 to 15 MHZ may be used. Regardless, however, of the frequency band used, the data transmitter 1011 sends information to the cable headend in the information field of the response frame described. Those skilled in the art will recognize that a number of variations and combinations of the above-described set top terminal hardware components may be used to accomplish upstream data transmissions.

### VI. Books-on-Demand System

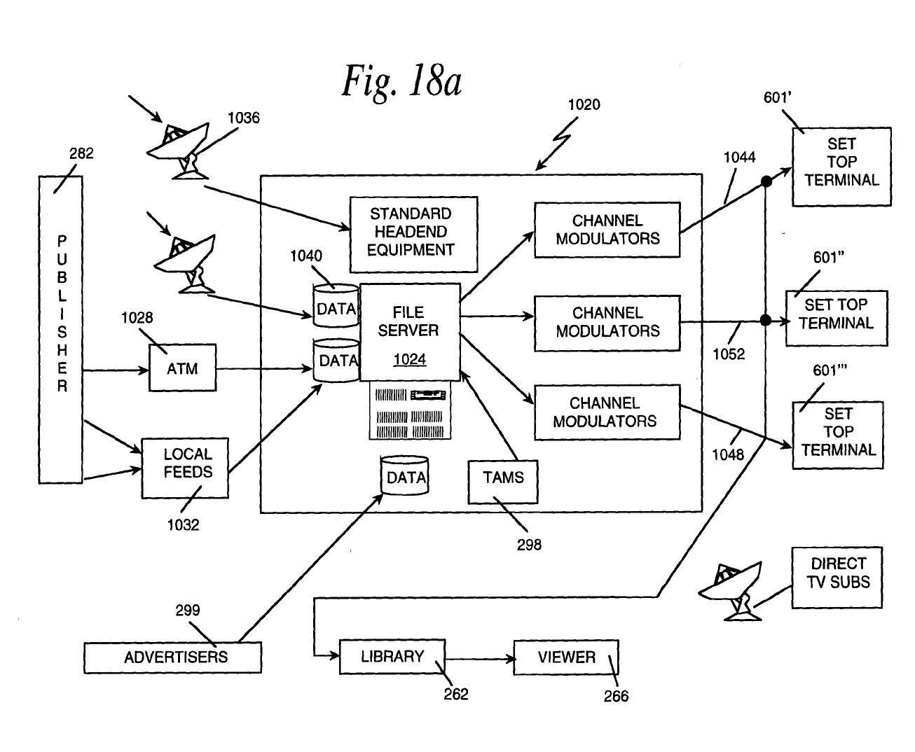

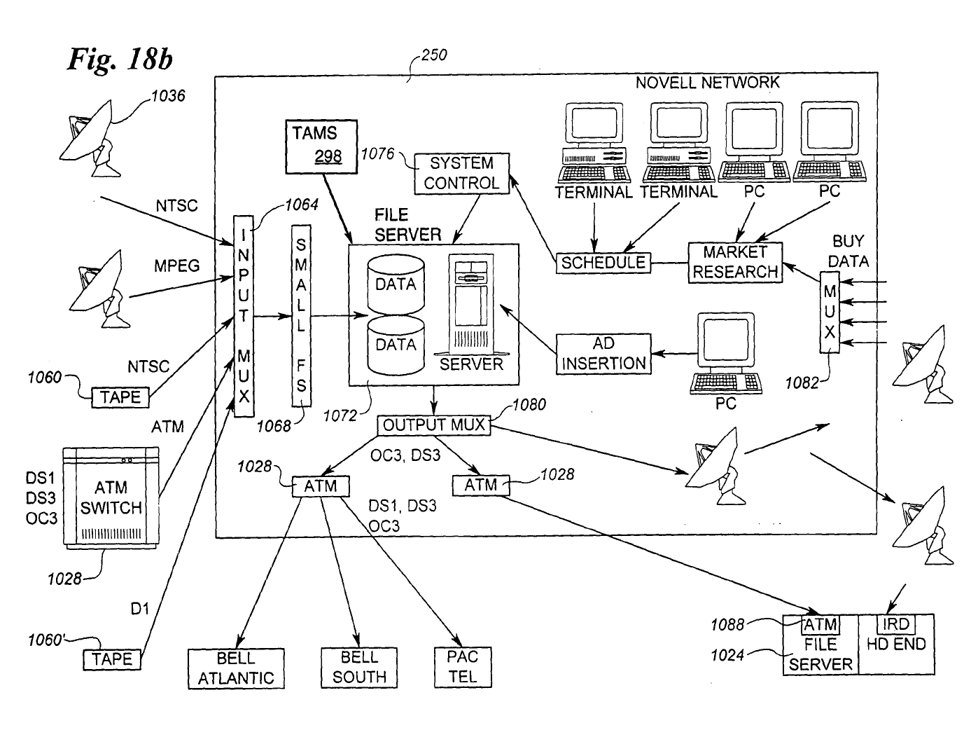

The electronic book system 200 may also be configured in a book-on-demand style. FIG. 18a shows one example of a configuration for a book-on-demand system. A book-on-demand system requires more powerful two-way communications between the subscriber's home, bookstore, school or public library and either the operations center 250 or a distribution site 1020 such as the cable headend. This type of two-way communication can be provided by the hardware shown in FIG. 17 and described above.

Referring to FIG. 18a, in a book-on-demand system, the subscriber selects the electronic book to be download from an available menu of electronic books (see for example FIGS. 14d and 14e). The data for menus of available electronic books is usually sent to the subscriber location by the distribution point 1020. After the subscriber's menu selection, information about the subscriber selection (or request) and stored subscriber information for use with targeting of advertisements are then communicated to either the distribution point 1020 (such as a cable headend) or the operations center 250. Upon receipt of this request, the needed textual and graphical information for the electronic book, along with advertisements targeted directly to that subscriber, are spooled and sent to the subscriber. In this manner, electronic books are only sent when requested by the subscriber and are sent immediately upon demand for the electronic book (or text).

In order to support such a book-on-demand system, the text delivery and distribution may be conducted on a strong nodal distribution architecture, such as a video-on-demand cable or telephone television system, or through use of individual telephone calls on the public telephone system or the Internet.

The book-on-demand system allows for a greater selection of electronic books to the subscriber and limits the amount of communicated book data that is unnecessary or unneeded. It also provides the electronic book to the subscriber in a much timelier fashion.

In addition to a stronger distribution system, a book-on-demand system requires the distribution point 1020 to have more sophisticated equipment to access and “spool out” the textual information. This can be accomplished using file server technology 1024 for storing the books and ATM 1028 or telephone-type switching (not shown) to distribute the textual information. One embodiment of file server 1024 and distribution technology that can be used in configuring such a book-on-demand system is described in U.S. Pat. No. 5,262,875 and U.S. Pat. No. 5,218,695, cited above.

FIG. 18a shows an embodiment for a book-on-demand system that utilizes file server technology. In addition to electronic books, the embodiment of FIG. 18a will support distribution of nearly any digital data. Books or textual files are received from publishers 282 and other sources through local feeds 1032, ATM 1028, or by satellite dish 1036. Advertisements are received from advertisers. The management of the proper advertisements to embed and deliver is controlled by the TAMS 298. The data is then stored in memory 1040 at the file server 1024. The distribution point 1020 may be a cable headend that receives requests from subscribers and delivers text to subscribers over a two-way communication system (such as a video-on-demand two-way cable system (VOD) 1044).

The library 262 can connect to either a basic premium-type service cable system 1048, a near video-on-demand type cable system (or pay-per-view (PPV) 1052) or the two-way cable system 1044. In connecting with either of these three systems the library 262 may access the cable directly or may access the system through the set top terminal 601′, 601″, or 601′″.

Using the two-way video-on-demand system 1044, a subscriber is able to request a specific book title and receive that text immediately following the request. To accomplish this, the distribution point 1020 transmits a list of available electronic books through the cable delivery system to the library 262. The library 262 displays the list of available books on a menu or similar format. As described earlier, the library 262 may use menus which list categories of available books to form its request from the distribution point 1020. After selecting a book the library 262 then sends a request signal on the two-way cable system 1044 back to the distribution point 1020. This request signal can be handled in two ways. The library 262 either initiates the request or the distribution point 1020 polls the various libraries on the two-way system 1044. Upon receiving the request for the book title, the text associated with that book title and the respective targeted advertisements are transmitted to the library 262 using the two-way cable system 1044.

FIG. 18b is an expanded view of an operations center 250 that supports a regional or national book-on-demand system. In fact, the operations center 250 shown supports distribution of nearly any digital data. The operations center 250 supports multiple feeds to receive digital information by tape 1060, 1060′, ATM 1028, or satellite 1036. The information is processed through an input MUX 1064 and a small file server 1068 before reaching the master file server 1072. Digital data such as electronic books received from publishers 282 and advertisements from advertisers 299 is then stored on the master file server 1072. The digital data may be stored compressed in a standard format such as MPEG2.

A system controller 1076 provides control over the regional or national book-on-demand system. Electronic books may be packaged into groups to provide feeds to various cable headends. In addition, scheduling and marketing research are conducted at the operations center 250. In order to handle the scheduling and market research, electronic book buy data is received at the operations center 250 through a multiplexer 1082. Electronic book buy information can be provided by the operations center 250 to the billing and collection system 278 and the TAMS 298.

The operations center 250 is also equipped to insert messages or advertisements into the file server using the TAMS 298. These messages and advertisements will eventually be received by the subscribers.

The master file server 1072 uses an output multiplexer 1080 and ATM 1028 as well as satellite connections to distribute digital data. In an embodiment, cable headends receive text data on electronic books from the master file server 1080 through the output multiplexer 1028 and an ATM system 1028. After receiving the digital electronic book data, the cable headends store the electronic books in a local file server 1024. FIG. 18a's distribution point 1020 is an example of a cable headend that may receive data from the operations center 250 of FIG. 18b through an ATM hookup 1088 or satellite hookup.

### VII. Electronic Book Targeted Advertising Management System

The electronic book targeted advertising management system (TAMS) 298 allows for advertisements to be directed to subscribers based on, for example, the use of subscriber data, electronic books read data, past advertisement viewing data, and/or mood indicators entered by the subscriber and used in an electronic book suggestion algorithm. Alternatively, input from subscribers collected through form-based questionnaires may be used to further define a subscriber's potential likes, wants, and needs. Advertisers wanting to optimize their advertising expenditures by ensuring that specific advertisements are viewed by the desired audience can do so by directing advertisements to the appropriate reading audiences. Specifically, advertisers can display specific advertisements in electronic books, electronic magazines and periodicals, and electronic newspapers that are being viewed by those subscribers most likely to be influenced to buy the advertised product, or otherwise respond in a desired fashion to the advertisement.

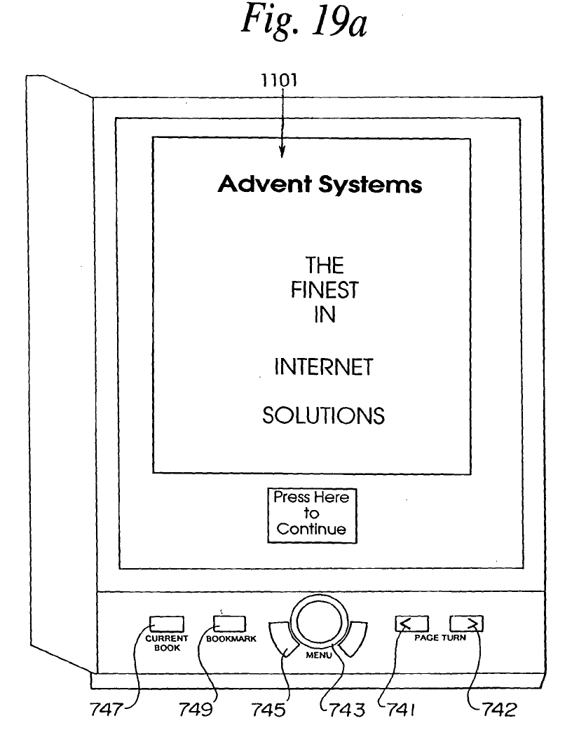

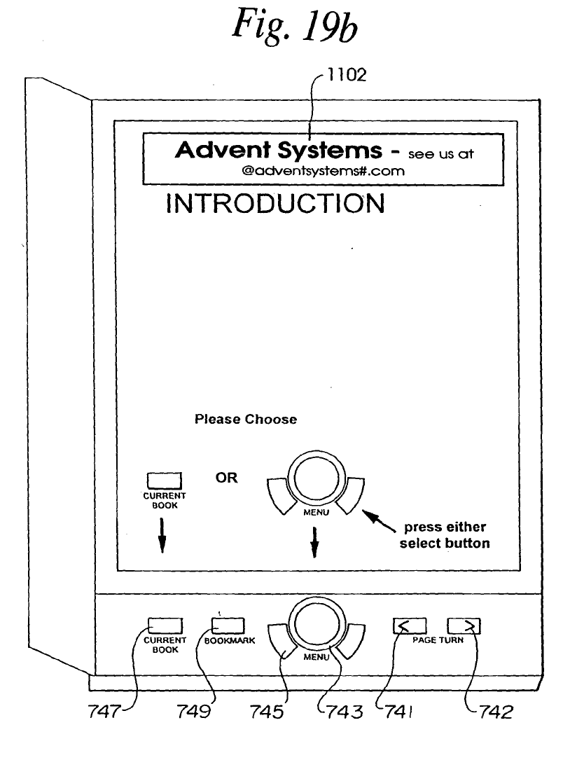

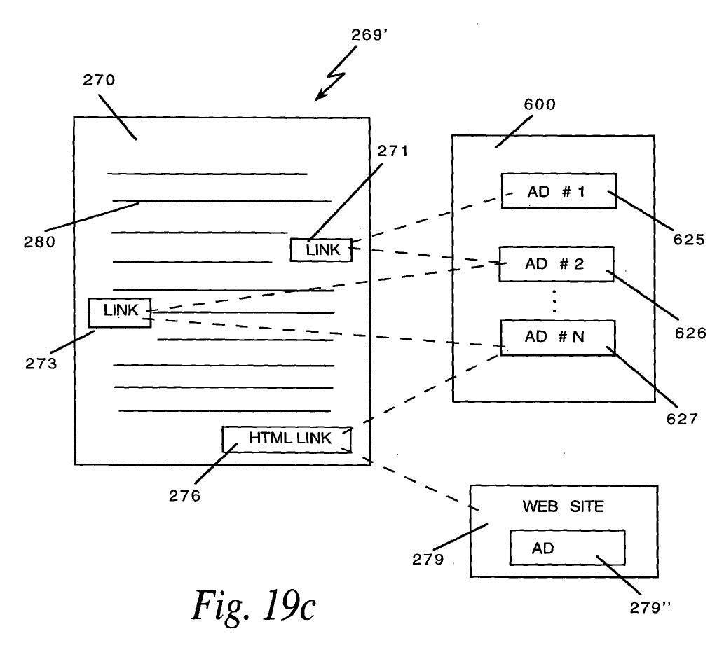

Advertisements can be presented to the subscriber in a variety of formats. First, advertisements may be displayed on the menu system residing on the library 262 or the viewer 266. These advertisements (1101) are in the form of a full screen textual, textual with background audio, graphical, graphical with background audio, video image, or a combination of video, text and graphics as depicted in FIG. 19a, or alternatively, advertisements (1102) can appear in the borders of the menu as banners, as depicted in FIG. 19b. Second, advertisements may be displayed within the actual electronic book text. These advertisements can be presented as the initial front page, as entire pages within an electronic book, or embedded with electronic book text within a page. Alternatively, these advertisements can be presented within the frame or banner displayed along with an electronic book. Advertisements within electronic books may be textual, textual with background audio, graphical, graphical with background audio, video images, or a combination of video, text and graphics.

In an embodiment, advertisements that are in the form of audio or video may be designated as requiring run-through-completion status prior to the next page of the electronic book can be viewed. In this embodiment, the next viewable page of an electronic book will not be accessible until the advertisement has been completed. Electronic books containing these advertisements may be priced at a significant discount, or even completely subsidized by advertisers. In an alternate embodiment, run-through-completion status may be supported only for the first time viewing of an advertisement. If the run-through-completion status is not associated with an advertisement, moving to another electronic book page will cause the advertisement to cease being displayed.

Alternatively, advertisements may be links embedded within an electronic book. Additionally, these advertisements may be hidden from the subscriber, but made available through the use of an Electronic Books Linking System, which is described in detail in copending U.S. application Ser. No. 09/237,828 entitled ELECTRONIC BOOK ELECTRONIC LINKS, filed Jan. 27, 1999. The advertisements can be delivered embedded in the electronic book text, or the advertisements can be sent independently from the electronic book text, but associated with a particular location on a menu or for display within the electronic book text using electronic book linking technology and links tables. In an embodiment, the use of linking technology supports advertisements in the form of text, graphics, audio, video, or interactive content.

Using electronic book linking technology, advertisements may be interactive, as described in the co-pending U.S. application Ser. No. 09/237,828 entitled ELECTRONIC BOOK ELECTRONIC LINKS, filed Jan. 27, 1999. In this embodiment, an advertisement may have an underlying link that links the subscriber to the operations center 250 or the Internet web site 279 to allow for requesting more information about an advertised product or to allow for ordering of a selected product. The linked material may include text, video or audio content, and may be in HTML-based format. In an embodiment where the home system 258 has a dedicated communication capability, linked advertisements and related interactive materials may be accessed in real time. In an embodiment where the home system 258 does not have a dedicated communication capability, the home system 258 may initiate communications to establish connectivity to the location specified by the underlying link table. Alternatively, the home system 258 may store the requested linking information until the next time that the home system 258 establishes communication for other purposes, at which time the requested linked material may be provided to the home system 258.

FIG. 19c illustrates an example of linking targeted advertisements to an electronic book. A page 269′ of an electronic book is shown with text 270, and with links 271, 273 and 276 embedded in the text 270. The link 271 is associated advertisements with AD#1 (625) and AD#2 (626). The link 273 is associated with advertisements AD#2 (626) and AD#N (627). The advertisements 625, 626 and 627 are stored in locations in the memory 600 of the library 262. The ads 625, 626 and 627 may be downloaded to the memory 600 from the operations center 250, for example.

Also shown on the page 269 is an HTML link 276. The HTML link 276 is linked to an ad spot 279″, which is accessed through the web site 279.

In operation, when the page 269 is displayed on the viewer 266 or other suitable viewing device, the links 271, 273 and 276 are also displayed. In an embodiment, the links 271, 273 and 276 may be activated upon display of the page 269. For example, the advertisement linked to link 271 (AD#1, 625) may be displayed on the viewer 266, in either a full screen, split screen, partial screen or picture-in-picture format.

Alternatively, the links 271, 273 and 276 may be displayed on the page 269 but may remain inactive until a subsequent action is taken. For example, the links 271, 273 and 276 may be activated by the subscriber scrolling to the location of the link using a remote control, and pressing a select button on the remote control.

If the links 271, 273 and 276 are activated automatically as described above, the corresponding advertisements may be displayed in sequence. Alternatively, the corresponding advertisements can be displayed in one or more windows on the screen of the viewer 266.

When the advertisements are displayed in sequence, the advertisements may be timed to persist for a specified time, if the advertisements are static. If the advertisements are dynamic, such as an MPEG H video clip, or an audio clip, the advertisements may be displayed for the time required to complete the video clip or audio clip.

In another embodiment, the subscriber may cycle through the advertisements. For example, the ad 625 may be displayed in a full screen format. The subscriber may turn off the ad 625 by issuing a command using the remote control, for example. The next advertisement in sequence, ad 626 in this case, is then displayed.

In FIG. 19c, in the ad 625 is shown linked to the page 269 by two links, specifically the link 271 and the link 273. Thus, the ad 625 may be shown at multiple locations within the page 269 or within an electronic book. In an embodiment, using this feature, targeted advertisements may be displayed at different locations on the page 269 for different subscribers.

The link 276 is shown as an HTML link. In this case, when the link 276 is activated, the viewer 266, or similar device, is connected to the Internet web site 279, using a telephone modem and line, or other suitable communications device and network, for example. Once connected to the Internet web site 279, the ad 279″ may be displayed in the screen 602 of the viewer 266. If the viewer 266 is not able to connect to the Internet web site 279, an alternate advertisement that is stored in the memory 600 may be displayed. For example, the ad 627 may be displayed. In another embodiment, a pop-up menu may be displayed on the screen 602 indicating that the viewer 266 was not able to connect to the Internet web site 279.

The links shown in FIG. 19c may correspond to advertisement spot locations within an electronic book. The spot locations may be linked to advertisements as shown in FIG. 19c, or may include embedded advertisements. That is, for embedded advertisements, the text and graphics, if appropriate, associated with a particular advertisement may be part of the text of the electronic book, and as such may be displayed with the electronic book every time the electronic book is displayed. By linking the spot locations to a separate file or database, the advertisements shown in a particular spot location may be caused to change. Furthermore, some advertisements associated with a particular spot location may be displayed in a full screen format, and may persist on the screen of the viewer 266 for a predetermined time, such as 60 seconds. At the end of the predetermined time, the advertisement may automatically be removed from display. Alternatively, the subscriber may cause the advertisement to be removed by operating the page turn button 742, shown in FIG. 14a, for example. The use of spot location will be described later in detail.

Advertisements may either be static or dynamic. Static advertisements may be created and associated with a menu or an electronic book, and may remain fixed. Dynamic advertisements are flexible in nature and may be updated remotely from the operations center 250. Another version of a dynamic advertisement is a rotation group of advertisements, where a series of related advertisements are bundled together and rotated through a pre-defined schedule. The rotation schedule may be time-based, showing a different advertisement for a given period of time before displaying the next advertisement. Alternatively, the rotation schedule may be viewing-based, where each time a menu or an electronic book page is viewed, a different advertisement is displayed. Yet another embodiment of a dynamic advertisement is a stair-cased group of advertisements, where a pre-defined sequence of advertisements are bundled together to provide a sequential message, leading the subscriber through various levels of frequency of exposure and refinement of advertising message to a final culminating advertisement, in essence, a self-contained advertising campaign. The progression from one advertisement to the next may be time-based or viewing-based.

Advertisements may also be targeted to subscribers on various levels. At a highest level, advertisements can be delivered to all end subscribers, with no targeting of the advertisements to the subscriber, but with the advertisement displayed in the electronic book that is determined to be most relevant to the content of the advertisement. Alternatively, advertisements may be targeted to groups, with the groups categorized based on some common characteristics. Advertisements may also be targeted to specific subscribers that share the use of a home system 258 based on their unique characteristics.

Electronic books may be priced according to the level of advertising provided. For example, the subscriber could order an electronic book with no advertising, but pay a higher price for the electronic book. Conversely, the subscriber may choose to order an electronic book with advertising and be given a price discount or a free electronic book altogether. Additionally, collected advertising viewed data as well as collection of information regarding executed links to advertisements may be used in pricing electronic books for an individual subscriber, with those subscribers actively involved in viewing advertisements being given larger discounts.

Subscribers may purchase electronic books using a variety of methods, including buying from a physical bookstore or from a virtual bookstore, using a subscription service such as a Book-of-the-Month Club, buying electronic books delivered on a memory device or borrowing from an electronic book library. Each of these methods supports a varying extent of targeted advertising. For purchases made at a physical bookstore or books borrowed from an electronic book library, targeted advertising may only be supported if, at the point of sale or borrow, subscriber information can be obtained and used in the real-time assignment of advertisements to the electronic book. In this embodiment, the bookstore may make use of a modified TAMS 298 to enter collected subscriber information, if available, to generate the advertisements at the time of sale or borrow. Alternatively, default advertisements may be available in the electronic book and targeted advertisements are delivered at a later time to the appropriate home system 258. If subscriber information is not made available, default advertisements may be used in place of targeted advertisements.

To target advertisements, the TAMS 298 may make use of information from numerous sources. These sources include the User Profile menu (889, see FIG. 13), collected electronic books read data that is stored in the home system 258, library 262 or viewer 266 and periodically uploaded to the operations center 250, and from past advertisements viewed information which is stored in the home system 258 library 262 or viewer 266 and periodically uploaded to the operations center 250. Additionally, these sources may include past electronic book ordering information collected by the operations center 250, past products ordered through the electronic book selection and delivery system 200, questionnaire responses when being suggested an electronic book to order using the responsive book suggestions feature, as well as information from marketing databases and past television programs watched data as collected for Program Suggestions, as described in co-pending U.S. Pat. No. 5,798,785, U.S. application Ser. No. 08/160,281 entitled REPROGRAMMABLE TERMINAL FOR SUGGESTING PROGRAMS OFFERED ON A TELEVISION PROGRAM DELIVERY SYSTEM, filed Dec. 2, 1993.

The TAMS 298 supports the management of information required to support each of the following: (1) delivery of targeted advertisements along with electronic books, periodicals, newspapers, and menus being requested on demand; (2) delivery of targeted advertisements along with electronic books, periodicals, newspapers, and menus being broadcast; (3) delivery of refreshed targeted advertisements; and (4) delivery of TAMS-related subscriber-specific information and commands.

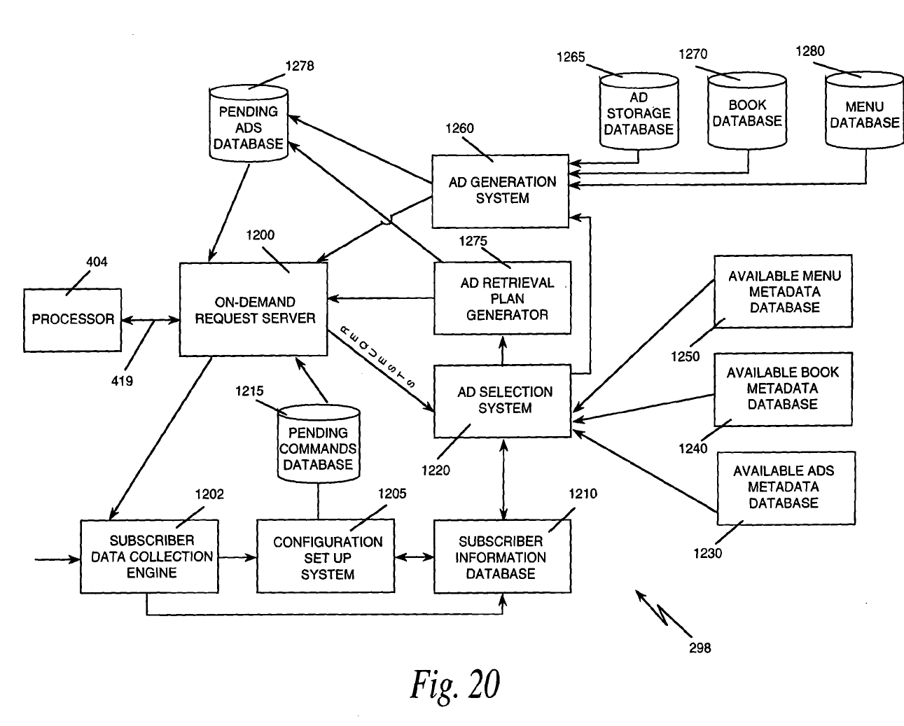

FIG. 20 shows the TAMS 298 configured to support the delivery of advertisements for electronic books and menus being requested on demand during an interactive session. In FIG. 20, an interactive request is received by the TAMS 298 from a subscriber using the operations center processor 404. The interactive request may be for a particular electronic book being ordered, or an update of menu information on available electronic books or services available using the electronic book system 200. Additional electronic personal data may be provided by the subscriber's library 262 or viewer 266 to facilitate the transaction. For example, the electronic book request may be generated based on the subscriber completing the electronic books suggestion feature (855, FIG. 13). Additionally, subscriber information may be accumulated during the course of using the home system 258, and this information may be uploaded to the operations center 250 during an interactive session. Alternatively, non-real time requests can be initiated by the subscriber and retrieved from the home system 258 by the operations center 250 using a polling process or provided to the operations center 250 using the billing and collection system 278. Real time and non-real time requests are received by an on-demand request server 1200 along with any collected subscriber information, including information on current advertisements residing on the home system 258 or viewer 266 associated with electronic books stored by the home system 258.

The on-demand request server 1200 provides any collected subscriber information to a subscriber data collection engine 1202 for storage in a subscriber information database 1210. The database 1210 also contains information collected from numerous sources for each subscriber. The subscriber information is then used by the ad selection system 1220 to determine the best advertisements to be displayed for the subscriber. The ad selection system 1220 uses information about the subscriber from the subscriber information database 1210, information about available advertisements from an available ads metadata database 1230, information about the requested electronic book from an available electronic books metadata database 1240, and information about the requested menu from an available menu metadata database 1250, to select appropriate advertisements to be packaged and delivered with the requested electronic book or menu.

Once the appropriate advertisements are determined by the ad selection system 1220, the ad generation system 1260 is directed to retrieve the appropriate advertisements, along with the requested electronic books, from an electronic book database 1270 or the requested menus from a menu database 1280, package the advertisements with the electronic book or menus, and deliver the electronic book or menu to the requesting subscriber. Concurrent with the interactive session of delivering the requested material to the subscriber, the on-demand request server 1200 determines if any other commands or broadcasts of refreshed advertisements may be delivered directly to the subscriber. This may be achieved by querying a pending commands database 1215 and a pending ads database 1278 to ensure that current advertisements residing in the home system 258 are the latest determined for the subscriber, and sending the latest advertisements if necessary. Alternatively, if information collected during the interactive transaction requires new action to be taken (refreshing advertisements or updating the subscriber category or group assignments), these actions can be initiated while the interactive session is active.

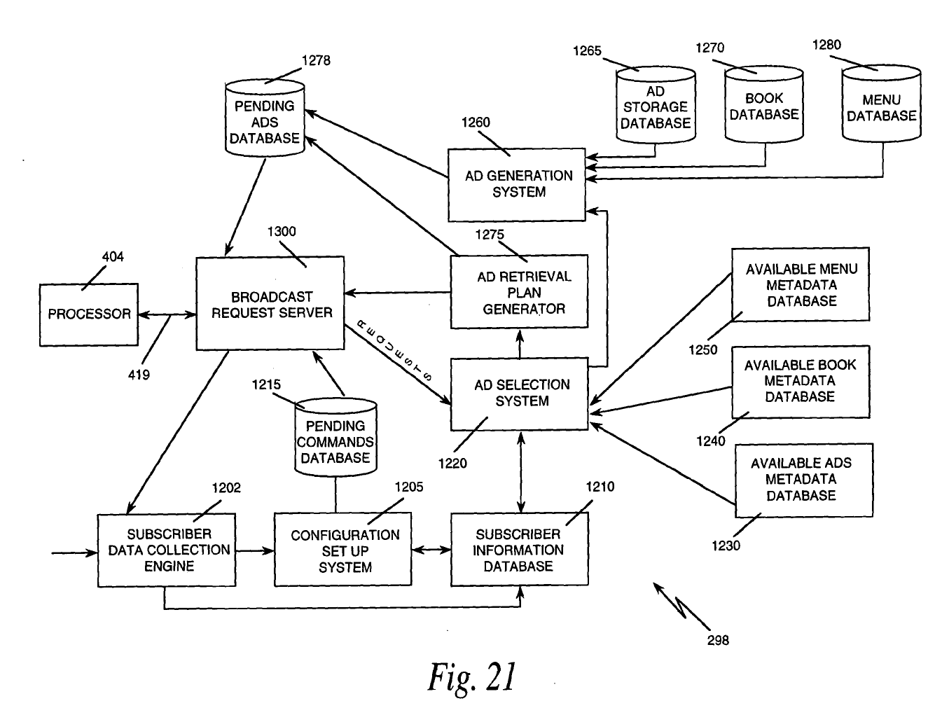

FIG. 21 shows the TAMS 298 supporting the delivery of advertisements for electronic books and menus to subscribers on a broadcast basis. Broadcast information can be destined for either the entire population of electronic book delivery system subscribers, groups of subscribers, and individual subscribers. Broadcast information can be initiated based on requests from subscribers, or by initiation at a remote site such as the operations center 250. Broadcast information can include electronic books that have been requested by numerous electronic book delivery system subscribers. Broadcasting is also ideal for distribution of electronic newspapers, periodicals, magazines, and other frequently delivered materials to the mass market, where each group of like subscribers may receive a different set of advertisements along with the electronic books and other electronic content. Broadcasting the requested content makes more efficient use of available system bandwidth than sending the same content to each requesting subscriber individually. Broadcasting may be supported over a variety of broadcast-capable communication systems, such as the Internet, cable television systems, terrestrial broadcast systems, satellite broadcast systems, and wireless communications systems, and other systems described in detail in co-pending U.S. application Ser. No. 09/289,957 entitled ELECTRONIC BOOK ALTERNATIVE DELIVERY SYSTEMS, filed Apr. 13, 1999, and U.S. application Ser. No. 09/289,956 entitled ELECTRONIC BOOK ALTERNATIVE DELIVERY METHODS, filed Apr. 13, 1999. Broadcast information may also include an index of electronic book titles, menu (and menu graphics) information, announcements, special offerings, discounts, promotions, previews, and advertisements to be used to refresh advertisements already resident on the home system 258.

Aggregated subscriber requests may be received by a broadcast request server 1300, along with any collected subscriber information, including information on current advertisements residing on the home system 258 or viewer 266 and associated with existing resident electronic books. The broadcast request server 1300 provides collected subscriber information to a subscriber data collection engine 1202 for storage in the subscriber information database 1210. The database 1210 may also contain information collected from numerous other sources for each subscriber. The subscriber information may then be used by the ad selection system 1220 to determine the best advertisements to be displayed for the requesting subscribers. Additionally, the information collected may be used to determine if the subscriber information has changed to the point that refreshed advertisements should be delivered to a subscriber or, alternatively, whether a subscriber's group assignments should be updated. The ad selection system 1220 uses subscriber information from the subscriber information database 1210, information about available advertisements from the available ads metadata database 1230, and information about the requested electronic book from the available electronic books metadata database 1240 or about the requested menu from the available menu metadata database 1250, to select the appropriate advertisements to be packaged and delivered with the requested electronic book or menu items. The ad selection system 1220 can be configured to select a single advertisement that best matches the requesting subscriber's profiles. Alternately, the ad selection system 1220 can select a number of advertisements, where the advertisements are determined by the ad selection system 1220. The ad generation system 1260 is directed to retrieve the appropriate advertisements, along with the requested electronic books from the electronic book database 1270 or menus from the menu database 1280, address the advertisements with the appropriate group addressing information, package the advertisements with the electronic book or menus, and deliver the data to the requesting subscribers.

Content can be delivered asynchronously to individual subscribers or groups of subscribers based on updated subscriber personal information, modified group assignments, the need for refreshed advertisements, and the generation of updated menu content. In this case, the TAMS 298 functions similarly as it would in receiving a request from a subscriber; however, in this case, the delivery initiation could be by TAMS operator initiation. Alternatively, initiation could be automatic based on a scheduled cycle. Upon delivery initiation, the ad selection system 1220 uses subscriber information from the subscriber information database 1210, information about available advertisements from the available ads metadata database 1230, and information about previously delivered electronic books from the available electronic books metadata database 1240 or information about previously delivered menus from the available menu metadata database 1250, to select the appropriate advertisements to be packaged and delivered. Once the ad selection system 1220 determines the appropriate advertisements, the ad generation system 1260 is directed to retrieve the appropriate advertisements or library system configuration information, package the configuration information, address the configuration information either to a single subscriber or group of subscribers, and deliver the configuration information to the appropriate home system 258 using the request server 1300. This delivery can be done in broadcast fashion over the electronic book system 200 or by communicating to home systems 258 directly.

The databases addressed in FIGS. 20 and 21 may be configured to support a variety of information necessary for the TAMS 298 to manage the targeting process. Below are tables that present typical data that may be tracked by these individual databases.

### User Information Database 1210

Electronic book system identification information
Home system type
Date of system set-up
Date of last communication with operations center
Household income
User data (for each registered subscriber of an electronic book), including:
   Name
   Sex
   Age
   Place of birth
   Education
   Mode of electronic book use
   Profession
   Book category preference
   TV program preferences
Demographic information
User profile menu information, date of last survey update
Electronic books read data
Past advertising viewed data, which ads, time spent viewing,
Past electronic books ordered data, along with time, date, and method of order
Past products ordered, along with time, date, and method of order
Past electronic book suggestions data
Past billing information
Imputed subscriber data from marketing databases
Past TV programs watched data, along with time and date
Past PPV programs ordered data, along with time and date
Mood indicators
Form based questionnaire results
Communication methods available (available options for both return and delivery)
Group assignments per subscriber for each category
Past ad packages delivered to subscriber, date of delivery, method of delivery
Zip+4 information

### Available Ads Metadata Database 1230

Display options (e.g, text, audio, graphics, video, link, HTML, interactive)
Static vs. dynamic ad indicator,
If dynamic ad, rotation group vs. stair case selection, with required control parameters
Display location (e.g, full screen, partial page, border, frame, banner)
If a linked ad, link table information
Pricing subsidy information
Run through completion status mode indication
Date of valid use
Ad placement controls, acceptable frequency
Category and group preferences (as ad ranking percentages)

### Available Electronic Book Metadata Database 1240

Price discount options (e.g, allowed, not allowed)
Available spot locations
Total spots allowed
Maximum spots allowed
For each available spot location:
   Display options (e.g, text, audio, graphics, video, link, HTML, interactive)
   Static vs. dynamic ad indicator,
   If dynamic ad, rotation group vs. stair case selection, with required control parameters
   Display location (e.g, full screen, partial page, border, frame, banner)
   Run through completion status mode indication
   Ad placement controls (e.g., acceptable frequency)
   Category and group preferences (as group breakdown percentages)

### Available Menu Metadata Database 1250

Available spot locations
Total spots allowed
Maximum spots allowed
For each available spot location:
   Display options (e.g, text, audio, graphics, video, link, HTML, interactive)
   Static vs. dynamic ad indicator,
   If dynamic ad, rotation group vs. stair case selection, with required control parameters
   Display location (e.g, full screen, partial page, border, frame, banner)
   Run through completion status mode indication
   Ad placement controls (e.g., acceptable frequency)
   Category and group preferences (as group breakdown percentages)

### Ad Storage Database 1265

Ad identifier with actual digital version of ad

### Electronic Book Database 1270

Electronic book identifier with actual digital version of book

### Menu Database 1280

Menu identifier with actual digital version of menu

### Pending Commands Database 1215

For each pending command:
   Destination address
   Actual command
   Date generated
   Date of confirmed receipt

### Pending Ads Database 1278

For each pending ad:
   Destination address
   Packaged ads
   Associated retrieval plan
   Date generated
   Date of confirmed receipt

The heart of the TAMS 298 is the ad selection system 1220. The selection system 1220 is responsible for the intelligent and rapid selection of advertisements for placement in electronic books and on menus. Category and group targeting is managed in a manner similar to that described in co-pending U.S. application Ser. No. 09/054,419 entitled TARGETED ADVERTISEMENT USING TELEVISION DELIVERY SYSTEM, filed Apr. 3, 1998, incorporated herein by reference.

Careful management of the advertisements within the electronic books or on menus, based on information known about the demographics and reading habits of subscribers, can greatly increase both the advertisers' likelihood of reaching an interested subscriber, and the likelihood a subscriber will be interested in a specific advertisement. Electronic books and menus are assigned a series of advertisements by the TAMS 298, and when multiple advertisements are delivered for a given spot in an electronic book, an ad retrieval plan is developed that directs which advertisements should be displayed, and in what order, for a given subscriber.

The process of managing the targeted advertising begins with a number of configuration and set-up steps. First, individual home system 258 address information is collected at the operations center 250. This information uniquely identifies each electronic book system subscriber and associates necessary information about each subscriber with the home system identifier to aid in the advertisement targeting process. This information includes subscriber profile information, electronic books read information, past advertisements delivered and viewed, and responses to menu-based questionnaires completed by the subscriber. Other subscriber information may be collected from various sources, including surveys and marketing databases correlated by address or zip code+4, for example.

Next, for a number of target criteria, subscriber groups are defined. Examples of target criteria include demographic targeting (age/sex/income) and location, such as Area of Dominant Influence (ADI). Each target criteria is then segmented into appropriate groups. For example, the ADI may include Los Angeles, Calif. and Washington D.C. New target criteria can be added and the groups redefined after their initial establishment.

For each target criteria, each home system 258 is assigned to a group based on the information collected about the subscriber. Once each subscriber is assigned to a group, the group assignments are conveyed to the home system 258 and stored therein. As groups are modified or group assignments change, the home systems 258 are provided with the changes. Additionally, the group assignment information is periodically resent to the home systems 258 to ensure that newly added home systems 258 and those home systems 258 that have accidentally lost their information are up-to-date.

The ad selection system 1220 determines the optimum types of advertisements to be placed in an electronic book or on a menu. An opportunity, or location in an electronic book or on a menu that is available for the placement of an advertisement will be denoted as a “spot location” henceforward. Within a spot location, one or multiple individual advertisements may be assigned, each denoted as a “spot” henceforward. The ad selection system 1220 takes into account subscribers who will likely read an electronic book or menu, the desirability of providing available advertisements to those subscribers, targeting criteria, the number of spots locations available for each electronic book or menu, and the number of spots available for assignment for a given spot location.

Once specific advertisements are selected for each available menu or electronic book spot, the subscriber groups that should view each advertisement are determined, based on the target criteria of interest. Assignment of a home system 258 to a targeting group for the appropriate advertisement may be based on a detailed retrieval plan. The retrieval plan may be distributed along with the advertisements directly to the home systems 258 from the operations center 250.

After the home system 258 receives and stores the advertisements and the retrieval plan, the home system 258 inserts those advertisements into the appropriate spot location in the respective electronic book or menu. The home system 258 will retrieve and store only those advertisements associated with that home system's group assignment. Alternatively, the home system 258 may retrieve and store all advertisements but only insert those advertisements into spot location as dictated by the retrieved plan.

When the advertisements are displayed on the viewer screen, the viewer 266 will store advertisement viewed data indicating that an advertisement was shown. In an embodiment, the viewer 266 will store this advertisement viewed data only if the advertisement is displayed for a predetermined time, or only if the subscriber takes an action to indicate the ad has been viewed, such as by clicking on a check-off box, for example. The accumulated advertisement viewed data will be collected from the viewer 266 at a later time for review purposes. The unique home system identification information will be provided with the collected advertisements viewed data. Upon collection of the advertisements viewed data, the viewer 266 and library 262 may return the used memory space to available pools for future use.

As shown in FIG. 4, the operations center processor 404 coordinates with the TAMS 298 using a data bus 419. All requests to the TAMS 298 to assign advertisements to an outgoing electronic book or menu come from the processor 404 using the data bus 419. Additional information is also provided to the TAMS 298 using the data bus 419 to enable the TAMS 298 to target advertisements. Once advertisements have been assigned for delivery, the advertisements are passed from the TAMS 298 to the processor 404 over the data bus 419 for delivery by the text generator 410.

The ad selection system 1220 receives requests to initiate the determination of advertisements to be placed using the appropriate request server 1200 or 1300. The ad selection system 1220 receives electronic book and menu delivery schedules from the broadcast request server 1300 and requests for the immediate delivery on-demand requested electronic books and menus from the on-demand request server 1200. The ad selection system 1220 receives electronic book and menu information from the available electronic book metadata database 1240 and the available menu metadata database 1250; advertisement/promotional information from an available ads metadata database 1230; and home system subscriber information from the subscriber information database 1210. The ad selection system 1220 provides outputs to the ad generation system 1260 and the retrieval plan generator 1275.

A part of the TAMS 298 operation is the retrieval of subscriber data, and the assimilation of the subscriber data into the advertisement selection method. This operation typically includes two steps. First, raw subscriber data is retrieved from the home systems 258. Then the raw data is filtered and used. The operations center 250 compiles the subscriber data, and then sends the subscriber data to the TAMS 298. Once assembled at the TAMS 298, the raw data is filtered for each application of the TAMS 298. In an embodiment, the subscriber information database 1210 receives inputs from the subscriber data collection engine 1202 and a configuration set-up system 1205. The subscriber information database 1210 provides outputs to the configuration set-up system 1205, and the ad selection system 1220.

The raw data gathered includes:
What books a subscriber purchased and when they were purchased,
What products a subscriber purchased and when they were purchased,
What PPV TV programs a subscriber purchased and when they were purchased,
What television programming a subscriber has viewed,
What electronic book/menu/advertisements a subscriber viewed and for how long, and
Subscriber profile information supplied using the subscriber profile menu 889.

The subscriber information database 1210 receives electronic books purchased and read information from the billing & collection system 278 or directly from home systems 258 using the TAMS subscriber data collection engine 1202.

Subscriber profile information is collected and stored on each subscriber for the purposes of advertisement targeting. The subscriber profile may include demographic information that may be gathered in a number of ways. The home system 258 builds the subscriber profile for each subscriber and stores the information in a memory file by subscriber name. The file may be uploaded to the operations center 250 each time the home system 258 initiates communications with the operations center 250. In an embodiment, to build a subscriber profile, the subscriber answers questions presented on a series of menu screens 889 (see FIG. 13). The menu screens 889 may request the subscriber to input information such as name, sex, age, place of birth, place of lower school education, employment type, level of education, types of electronic and non-electronic books read and frequency of reading, amount of television program viewing per week, and the number of television shows in particular categories that the subscriber watches in a given week such as, sports, movies, documentaries, sitcoms, amount of Internet use and favorite web sites, etc. Any demographic information that will assist the TAMS 298 in targeting advertisements may be used.

In addition to demographics gathered at the home system 258, the subscriber profile can be compiled using other methods. For instance, subscriber information can be gathered using questionnaires sent by mail and subsequently entered in the subscriber information database 1210.

As an alternative to gathering demographic data, a simulated subscriber profile can be generated using an algorithm that analyzes subscriber access history and subscriber habits. Using test information generated from a statistically significant number of subscribers, the simulated subscriber profile algorithm estimates the subscriber's age, education, sex and other relevant information. The analysis then compares the subscriber's electronic books read information with that of the test group. An example of the type of information for a subscriber profile is presented below.

The subscriber profile data fields are an example of typical fields that can be used in the databases. Definitions of various fields are listed below. The primary purpose of profiling the subscriber is to acquire marketing information on the subscriber's likely response to available advertisements. Ancillary information may be available including actual electronic book selections by the subscriber. Information tracked within the subscriber's profile includes:

| | |
|---|---|
| Subscriber ID | A unique identifier generated by the system, one |
| | for each subscriber using a specific electronic |
| | book home system 258. |
| Home System Types | Boolean field that identifies the type of home |
| | system 258 used. |
| Home System ID | ID of the home system 258. |
| Hookup Date | Date physical hardware is connected. |
| Survey Date | A demographic profile may be conducted for each |
| | subscriber. The following fields represent this |
| | demographic information. The date represents |
| | when the interview survey was completed. |
| Subscribers Age 2-5 | Boolean field if the household has |
| | subscribers between 2 and 5 years of age. |
| Subscribers Age 6-11 | Boolean field if the household has |
| | subscribers between 6 and 11 years of age. |
| Subscribers Age 12-17 | Boolean field if the household has |
| | subscribers between 12 and 17 years of |
| | age. |
| Subscribers Age | Boolean field if household has subscribers |
| N₁-N₂ | between N₁ and N₂ years of age. |
| Income | Annual household income. |
| Zip Code + 4 | Self-explanatory. |
| Occupancy | Number of subscribers in household. |
| Highest Education | Highest level of education of any |
| | subscriber in the household. |
| Field of Use | Personal, professional, educational, other. |
| Profession | Self-explanatory. |
| Education Level | Self-explanatory. |

These subscriber profile inputs may assist in the assignment of home systems 258 to groups for each targeting category. There are numerous variations to the field definitions listed above, such as different age groupings, for example. Other subscriber profile data fields may also be specified.

Marketing information, such as the demographics of subscribers and market information may be received from external sources or directly from the home systems 258 using the subscriber data collection engine 1202. To effectively manage the advertisement targeting operations, market information, such as the existence of markets for certain products, may be provided to the TAMS 298. The following type of information may be maintained in the subscriber information database 1210: subscriber demographic profile, subscriber buy information; and correlation of demographic information with buy information. As the electronic book selection and delivery system 200 is used, this information can be stored and maintained in the viewer 266 or the library 262. The subscriber data collection engine 1202 gathers the marketing information from the various sources and indexes the information for inclusion in the subscriber information database 1210.

To maintain the subscriber information database 1210 within the TAMS 298, a database server, communications server, subscriber work station or stations, or the suitable equivalents thereof, may be used. The database server supports saving data base files, event logging, event scheduling, multi-subscriber services, data base server services, and data base security access.

The communications server performs the following functions on data base data: integrity check, filtering, processing, downloading to home systems 258 using the pending commands database 1215, and uploading from home systems 258 using the subscriber data collection engine 1202.

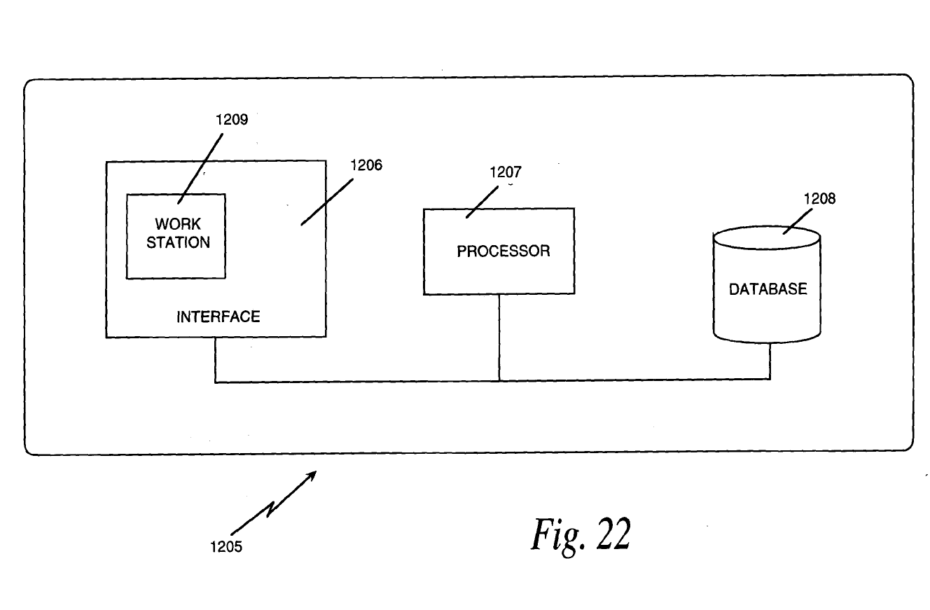

FIG. 22 shows the configuration set-up system 1205 in more detail. An interface 1206 receives individual addressing information unique to home systems 258. The interface 1206 can include a workstation, such as the workstation shown 1209, for example, from which an operator at the operations center 250 manually enters home system information. Alternately, home system information can be automatically entered at the interface 1206 by downloading from an off-site database, the Internet, a storage medium, such as a CD-ROM or a floppy disk, and by collecting the information directly from the individual home systems 258 using the subscriber data collection engine 1202. A processor 1207 processes the received home system information and organizes the information for USP. For example, the processor 1207 may create a Category/Group Definition matrix and a Group Assignment matrix that can be used to target advertisements to groups of home systems 258 or to an individual home system 258. In an alternative embodiment, if subscriber information is available where multiple subscribers may share a home system 258, a Group Assignment matrix may be created for each subscriber who shares the home system 258. The Category/Group Definition and Group Assignment matrices will be described later. The Category/Group Definition and Group Assignment matrices or organized home system information are then stored in a database 1208, and are periodically updated as home system information, for example, changes.

The information used by the processor 1207 to create a database of the Category/Group Definition and Group Assignment matrices includes, for example, the home system identifier, subscriber identifier, zip code+4 data, household income, and age and sex of the subscribers, for example. The information gathered by the configuration set-up system 1205 can come from a variety of sources including marketing databases, direct inputs from the subscribers, raw data collected by the subscriber data collection engine 1202, and other sources. Once the data are collected, the processor 1207 will assign category numbers to certain types of the data. For example, the ADI would be assigned category 1 and household (HH) income would be assigned category 2. Next, the configuration set-up system 1205 creates a number of non-overlapping groups for each category. For example, ADI can be broken down into Seattle, Wash., Washington D.C., Denver Colo., Los Angeles Calif., etc. Similarly, HH income can be broken down into a number of income groups such as no income, 20-40K, 60-120K, and over 120K. Then, the configuration set-up system 1205 assigns a “group mask representation” for each group within every category. The group mask representation may be simply a binary number that can be used to identify a particular group. Table A shows a completed Category/Group Definition matrix that could be used by the ad selection system module 1220 to assign targeted advertising to groups of home systems 258 or to individual home systems 258.

TABLE A
Category/Group Definition Matrix

| Category | Category | Group | | Group Mask |
|---|---|---|---|---|
| Number | Name | Number | Group Definition | Representation |
| 1 | ADI | 1 | Seattle, WA | 1000000000 |
| | | 2 | Washington, D.C. | 0100000000 |
| | | 3 | Denver, CO | 0010000000 |
| | | 4 | Los Angeles, CA | 0001000000 |
| 2 | HH income | 1 | No income | 1000000000 |
| | | 2 | 20-40K | 0100000000 |
| | | 3 | 40-60K | 0010000000 |
| | | 4 | 60-120K | 0001000000 |
| 3 | Category x | 1 | Group a | 1000000000 |
| | | 2 | Group b | 0100000000 |
| | | 3 | Group c | 0010000000 |
| | | 4 | Group d | 0001000000 |
| | | 5 | Group e | 0000100000 |
| | | 6 | Group f | 0000010000 |

The processor 1207 also creates the Group Assignment matrix. The Group Assignment matrix, shown in Table B, assigns to each home system 258, for each category, its corresponding group number. Associated with each group number is the group definition and the group mask representation. For example, the home system 258 identified by the address 12311 is assigned group number 2 (i.e., Washington D.C.) for ADI, and group number 3 (i.e., 40-60K) for household income. The Group Assignment matrix is updated periodically as categories and group definitions change, and as data related to individual home systems 258 or groups of home systems 258 change. Many other ways of organizing the information in a database for later UP are possible.

The configuration set-up system 1205 also delivers the group configuration (i.e., information specific to an individual home system 258, from the Group Assignment matrix) to each home system 258. For example, the home system 258 assigned the address 12311 is sent category 1, group 2 and group mask representation 01000000000.

TABLE B
Group Assignment Matrix

| | | Group | | Group Mask |
|---|---|---|---|---|
| Address | Category Name | Number | Group Definition | Representation |
| 12311 | ADI | 2 | Washington, D.C. | 01000000000 |
| | HH income | 3 | 40-60K | 00100000000 |
| | Category x | 3 | Group c | 00100000000 |
| 12312 | ADI | 4 | LA | 00010000000 |
| | HH income | 3 | 40-60K | 00100000000 |
| | Category x | 1 | Group a | 10000000000 |
| 12313 | ADI | 3 | Denver | 00100000000 |
| | HH income | 4 | 60-120K | 00010000000 |
| | Category x | 2 | Group b | 01000000000 |

The group configuration command can be stored in the pending commands database 1215 to be transmitted directly to each home system 258 from the operations center 250 the next time the home system 258 establishes communications with the operations center 250. Alternately, the group configuration can be broadcast periodically over the distribution system 208 for receipt by the home system 258. Each time a group configuration message is generated, the message is stored in the pending commands database 1215. Any time a home system 258 establishes communications with the operations center 250, the request server 1200 or 1300 queries the pending commands database 1215 to ensure that the home system 258 has the most recent command. If the home system 258 does not have the most recent command, the request server 1200 or 1300 provides the information to the home system 258.

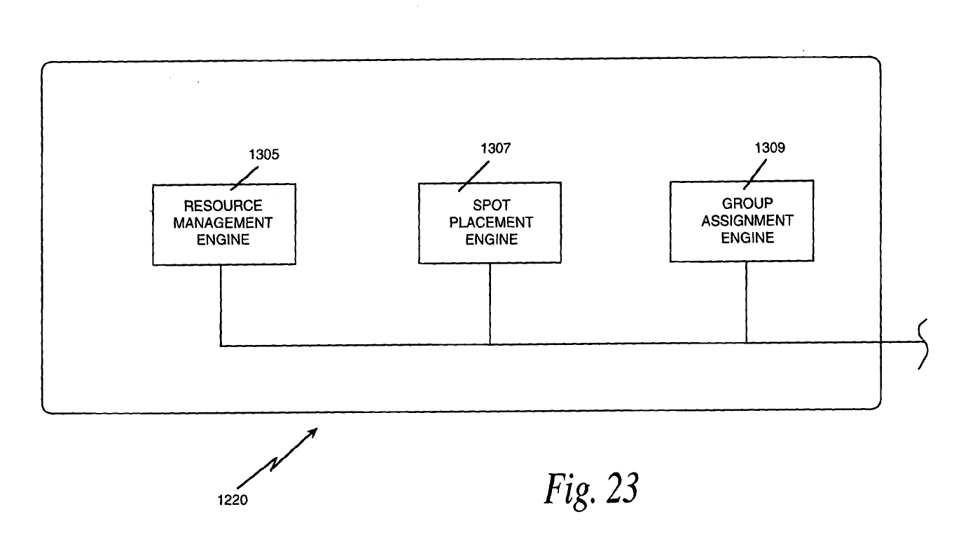

FIG. 23 shows the ad selection system 1220 in more detail. A resource management engine 1305 uses information from the available electronic book metadata database 1240 and available menu metadata database 1250 to determine the number of advertisement spots to be assigned to a given open spot location. A spot placement engine 1307 decides which advertisement spots to place in open spot locations in an electronic book or menu. A group assignment engine 1309 determines which home systems 258 will view specific advertisements. The spot placement engine 1307 receives information from the resource management engine 1305 related to the number of spots available, how many advertisements are to be provided for a given spot, and the actual type of spots available, for instance a textual advertisement, a graphical advertisement, and an advertisement in the form of a video or audio clip. The resource management engine 1305, the spot placement engine 1307, and the group assignment engine 1309 will be described later in more detail.

The resource management engine 1305 functions to divide available delivery bandwidth among multiple advertisements for a given spot location in an electronic book or menu. In the case where the electronic book or menu is being sent to a single home system 258, and where only one targeted advertisement is selected and delivered to the home system 258, the resource management engine 1305 may only identify the type of advertisement and available bandwidth for that advertisement. The resource management engine 1305 can also support packaging multiple advertisements within a spot, and have these advertisements presented to a single subscriber or a group of subscribers in a predefined sequence, with the advertisement presentation preferably controlled by information provided in the retrieval plan. A package of advertisements may be treated as a single advertisement for all targeting purposes.

Because there may be a limited amount of network communications bandwidth to deliver advertisements with electronic books and menus, the resource management engine 1305 may assign the available bandwidth optimally to the spots within the individual spot locations of electronic books or menus being delivered over the communication channels. Some spot locations may be assigned multiple advertisements, whereas other spot locations may be assigned only a single advertisement. Referring to Table A, four group numbers (i.e., 1-4) are shown for the category of targeted advertisement, ADI. For a particular spot location in an electronic book or menu, the four groups can be divided into two, one for each available spot, with groups 1 and 2 receiving the targeted advertising carried in Spot A and groups 3 and 4 receiving the targeted advertising carried in Spot B. This later example is shown in Table C.

TABLE C
Home System Retrieval Plan

| | | | Groups | |
|---|---|---|---|---|
| Spot | Category of | Advertisements | Assigned to | Group Mask |
| Location | Targeting | To Retrieve | Specific Ad | Assignment |
| Spot | ADI | Spot A | 1, 2 | 11000000000 |
| Location 1 | | Spot B | 3, 4 | 00110000000 |
| Spot | HH Income | Spot A | 1, 2, 3 | 11100000000 |
| Location 2 | | Spot B | 4 | 00010000000 |
| Spot | Category x | Spot A | 1, 2 | 11000000000 |
| Location 3 | | Spot B | 3 | 00100000000 |
| | | Spot C | 4 | 00010000000 |
| | | Spot D | 5 | 00001000000 |
| | | Spot E | 6 | 00000100000 |
| Spot | All | Spot A | All | 11111111111 |
| Location 4 | | | | |

After determining how many spots will be needed for each spot location within an electronic book or menu, the resource management engine 1305 may also account for the type of available targeted advertisements for display and the variety of subscribers (according to group assignment numbers) who may be reading the electronic book or menu. An advertiser may provide this information when forwarding advertisements to the operations center 250 for insertion.

In an embodiment, the spot placement engine 1307 determines which specific advertisements are to be placed in each available open spot of the spot location within an electronic book or menu. The spot placement engine 1307 first receives the list of available advertisements/promotional material from the available ads metadata database 1230. In cooperation with the resource management engine 1305, the spot placement engine 1307 then determines which of the available advertisements/promotions should be placed in a spot location within the electronic book or menu. For example, if the preferred category of targeted advertisement for the spot location 1 is ADI, the spot placement engine 1307 will select one or more targeted advertisements from the available ads metadata database 1230 to place in that spot location. If the demographic or other data assembled by the configuration set-up system 1205 indicates that more than one targeted advertisement should be placed, depending on the ADI, then the spot placement engine 1307 will select the appropriate number of targeted advertisements from the available ads metadata database 1230, and will assign each targeted advertisement to a specific spot. The operation of the spot placement engine 1307 to assign the targeted advertisements will be described later in more detail.

In an embodiment, the group assignment engine 1309 receives inputs from the resource management engine 1305 and the spot placement engine 1307 and then determines which home systems 258 will view specific targeted advertisements. Thus, for each spot location, the group assignment engine 1309 assigns the home systems 258 to one of the spots. The home systems 258 can be assigned based on their placement within a group (i.e., based on their group assignment number) or based on their individual home system 258 unit address. In tables B and C, the assignments are shown based on the group assignment numbers. As also shown in Table C, the group addressing for a spot location is based on a single category of targeted advertising. This may avoid a conflict regarding which spot a home system 258 may retrieve.

The group assignment engine 1309 provides an output to the retrieval plan generator 1275. The output indicates which group assignment numbers (i.e., which groups of home systems 258) are assigned to a spot for a given spot location in a delivered electronic book or menu. The retrieval plan generator 1275 then generates a bit word, or group mask assignment, that is used to assign the groups to spots. Once generated, the retrieval plan is stored in the pending ads database 1278, and is available to the operations center 250 to be distributed along with the electronic book or menu and the actual advertisements.

Preferably, the subscriber data collection engine 1202 (see FIGS. 20, 21) receives electronic books read data and targeted advertisements viewed data, from the home system 258, that may be collected whenever the home system 258 communicates with the operations center 250. The information is used at the TAMS 298 for billing commercial advertisers and may also be used as input for future ad campaigns.

In an embodiment, the ad selection system 1220 provides an advertisement generation request command to the ad generation system 1260. The advertisement generation request command specifies which particular advertisement is to be displayed at a particular spot, and the actual location of the advertisement. The advertisement is then retrieved from the ad storage database 1265 or alternatively, an appropriate storage location within the operations center 250. The TAMS-resident advertisements, along with the retrieval plan, are provided by the TAMS request server 1200 or 1300 to the processor 404 in the operations center 250 over the bus 419 for delivery to the appropriate home systems 258.

When a home system 258 receives an electronic book or menu that contains targeted advertisements, software instructions operating on the home system's microprocessor 628 analyzes the contents of the retrieval plan. Then, based on the groups assigned for each spot, the home system 258 retrieves those spots that match its own group assignments for the targeting category being used for the spot location. The home system 258 then associates those advertisements retrieved with the appropriate electronic book or menu location where the spot will be placed, so that when the electronic book or menu is viewed, the advertisement assigned to that spot location is displayed on the viewer 266.

An example of the process for assigning targeted advertisements in the embodiment to spots using the spot placement engine 1307 will now be described. As discussed above, targeted advertising uses targeting categories and independent groups within each target category to tie three entities together: 1) the home system 258; 2) advertisements; and 3) electronic books and menus. The home systems 258 (or viewers 266) are assigned to groups for each targeting category by the configuration set-up system 1205 based on numerous factors. One method to assign the home systems 258 to groups is to use the zip code+4 as an index into one of the available demographic marketing databases. From the zip code+4 data, a distinct demographic cluster can be determined. The demographic cluster can then be mapped directly to the specific group within each targeting category. Manual assignment of groups to home systems 258 would be a daunting task for a large population of home systems (approaching several million). Therefore, the processor 1207 in the configuration set-up system 1205 performs this function automatically, using its installed software routines. Alternative methods can also be devised to automatically map individual home systems 258 to groups within targeting categories. Once each home system 258 is mapped to one group for each targeting category, the group assignments are delivered to the home system 258 for storage (see Table B).

Next, electronic books and menus, and more specifically, spot locations in electronic books and menus are tied to groups as well. For each spot location, a group breakdown percentage can be defined for each group that represents the likely compatibility of the content of the electronic book or menu surrounding that spot location with each group. This information preferably resides in the available electronic books metadata database 1240 and the available menus metadata database 1250. Table D shows a sample breakdown of these group breakdown percentages for five example spot locations for three example targeting categories.

The group breakdown percentage data may be derived from a number of sources including surveys, ratings services, and electronic books ordered data and advertisements viewed data collected by the home systems 258, for example. In this example, the three targeting categories are the same as those presented in Table B, and the group assignment numbers are the same as those presented in Table A. Thus, targeting categories 1 and 2 each have four groups associated with them, and targeting category 3 has six groups associated with it. For spot location 1, the targeting category 1 refers to ADI and under group 1, a group breakdown percentage of 25 percent is assigned for group 1 from the targeting category ADI since 25 percent of the subscribers reside in the Seattle, Wash. ADI. The group breakdown percentages for each targeting category for each spot location may sum to 100 percent.

Advertisements may also be broken down as to how well an advertisement ranks with each group within one and up to all possible targeting categories, again using percentages. This information may be provided by an advertiser responsible for the advertisement and may reside in the available ads metadata database 1230. Table E shows a sample assignment of ad ranking percentages for eight sample advertisements using the

TABLE D
Spot Location Group Breakdown Percentages

| | Target | | | | | | |
|---|---|---|---|---|---|---|---|
| | Cate- | Group | Group | Group | Group | Group | Group |
| Spot Location | gory | 1 | 2 | 3 | 4 | 5 | 6 |
| Spot Location 1 | 1 | 25 | 25 | 25 | 25 | N/A | N/A |
| ″ | 2 | 30 | 10 | 20 | 40 | N/A | N/A |
| ″ | 3 | 10 | 10 | 20 | 20 | 20 | 20 |
| Spot Location 2 | 1 | 10 | 20 | 30 | 40 | N/A | N/A |
| ″ | 1 | 25 | 25 | 25 | 25 | N/A | N/A |
| ″ | 3 | 10 | 15 | 25 | 25 | 15 | 10 |
| Spot Location 3 | 1 | 40 | 30 | 20 | 10 | N/A | N/A |
| ″ | 2 | 80 | 10 | 5 | 5 | N/A | N/A |
| ″ | 3 | 25 | 25 | 10 | 10 | 15 | 15 |
| Spot Location 4 | 1 | 50 | 0 | 50 | 0 | N/A | N/A |
| ″ | 2 | 0 | 40 | 40 | 20 | N/A | N/A |
| ″ | 3 | 10 | 10 | 25 | 25 | 15 | 15 |
| Spot Location 5 | 1 | 20 | 30 | 30 | 20 | N/A | N/A |
| ″ | 2 | 30 | 30 | 10 | 30 | N/A | N/A |
| ″ | 3 | 10 | 30 | 10 | 30 | 10 | 10 |

same targeting categories and group numbers as in Table D. Not all advertisements may be assigned to groups for a targeting category if an advertiser does not wish its advertisement to be targeted in the manner required by that targeting category.

Referring to Table E, the data indicates that for ad 1, and targeting category 1 (ADI) the advertiser believes that ad 1 is appropriate for the subscribers in groups 1 and 2 and is not appropriate for the subscribers in groups 3 and 4. The advertiser also believes that ad 1 is equally appropriate for both the group 1 and the group 2 subscribers. However, if the group 1 subscribers are determined to be more likely to respond to ad 1 than the group 2 subscribers, then group 1 could be given a higher percentage than group 2. Table E also shows that ad 1 is not applicable to groups 5 and 6 because only four groups are defined for the targeting category ADI. Thus, all the home systems 258 will be grouped into one of groups 1 through 4.

TABLE E
Ad Ranking Percentages

| | Target | | | | | | |
|---|---|---|---|---|---|---|---|
| | Cate- | Group | Group | Group | Group | Group | Group |
| Ad | gory | 1 | 2 | 3 | 4 | 5 | 6 |
| Ad 1 | 1 | 50 | 50 | 0 | 0 | N/A | N/A |
| ″ | 2 | 30 | 10 | 20 | 40 | N/A | N/A |
| ″ | 3 | 0 | 0 | 0 | 0 | 0 | 0 |
| Ad 2 | 1 | 0 | 0 | 50 | 50 | N/A | N/A |
| ″ | 2 | 0 | 0 | 0 | 0 | N/A | N/A |
| ″ | 3 | 0 | 0 | 0 | 0 | 0 | 0 |
| Ad 3 | 1 | 0 | 0 | 0 | 0 | N/A | N/A |
| ″ | 2 | 25 | 25 | 25 | 25 | N/A | N/A |
| ″ | 3 | 0 | 0 | 0 | 0 | 0 | 0 |
| Ad 4 | 1 | 50 | 0 | 50 | 0 | N/A | N/A |
| ″ | 2 | 0 | 40 | 40 | 20 | N/A | N/A |
| ″ | 3 | 10 | 30 | 10 | 30 | 10 | 10 |
| Ad 5 | 1 | 40 | 20 | 20 | 20 | N/A | N/A |
| ″ | 2 | 10 | 30 | 30 | 30 | N/A | N/A |
| ″ | 3 | 30 | 30 | 30 | 5 | 5 | 0 |
| Ad 6 | 1 | 0 | 0 | 0 | 0 | N/A | N/A |
| ″ | 2 | 0 | 0 | 0 | 0 | N/A | N/A |
| ″ | 3 | 10 | 10 | 10 | 10 | 30 | 30 |
| Ad 7 | 1 | 20 | 20 | 40 | 20 | N/A | N/A |
| ″ | 2 | 25 | 25 | 25 | 25 | N/A | N/A |
| ″ | 3 | 0 | 30 | 20 | 30 | 0 | 20 |
| Ad 8 | 1 | 30 | 40 | 0 | 30 | N/A | N/A |
| ″ | 2 | 30 | 30 | 10 | 30 | N/A | N/A |
| ″ | 3 | 20 | 0 | 20 | 20 | 20 | 20 |

Using this paradigm, advertisements can be targeted using at least two methods. The first is a designated multi-ad campaign where specific unique sets of subscriber groups are assigned for each ad of the campaign. In the second method, each advertisement provided by an advertiser is independently associated with subscriber groups. Advertisements from several different advertisers are then used together to optimize use of spot locations.

Using the information above, the spot placement engine 1307 determines: 1) how many spots are assigned to which spot location; 2) which targeting category is used for which spot location; 3) which advertisements to place in which spots; and 4) which groups are assigned to which spots. Due to bandwidth management concerns, the algorithm in the spot placement engine 1307 that assigns targeted advertisements to the spots assumes that there is a total number of spots available [TOTAL_SPOTS] for an overall electronic book or menu (across all spot locations), and assumes that no more than some maximum number of the spots can be or are desired to be assigned to a given spot location. This amount is denoted as [MAX_SPOTS]. As described earlier, it is possible to send a package of advertisements that are rotated. Although this package is treated as a single advertisement for targeting purposes, its impact on bandwidth may be taken into account when calculating whether [MAX_SPOTS] has been exceeded for a given spot location.

The operation of an embodiment of an advertisement targeting algorithm will be described with reference to the example values shown in Tables A-E. Various other prioritizing or ranking schemes may be used as described later.

Step 1: For each electronic book or menu, determine the advertisement with the highest overall ranking if that advertisement were the only advertisement to be placed in a spot location in an electronic book or menu. In essence, this step compares the data in Tables D and E. To do this, as Step 1a, first select the first spot location and advertisement to be analyzed. As Step 1b, for that advertisement selected in Step 1a, select the first category. Then, multiply the advertisement's Group Ranking Percentage by the spot location's Group Breakdown Percentage for each group and sum the result. As Step 1c, repeat Step 1b for the next targeting category. As Step 1d, repeat steps 1b and 1c for each advertisement. As Step 1e, for the spot location under consideration, select the advertisement/targeting category that yields the highest summed value. Then, for Step 1f, repeat Steps 1b-1e for all spot locations.

For example, using spot location 1, advertisement 1:

target category 1: 50*25+50*25+0*25+0*25=25%

target category 2: 30*30+10*10+20*20+40*40=30%

target category 3: 0*10+0*10+0*20+0*20 0*20+0*20=0%

The cross-multiplied result then shows a measure of effectiveness for each advertisement if displayed in the corresponding spot location. Table F below presents the results of Step 1 above for spot location 1.

TABLE F

| Spot | Cate- | Group | Group | Group | Group | Group | Group | Summa- |
|---|---|---|---|---|---|---|---|---|
| location/Ad | gory | 1 | 2 | 3 | 4 | 5 | 6 | tion |
| 1/1 | 1 | 12.5 | 12.5 | 0 | 0 | 0 | 0 | 25 |
| | 2 | 9 | 1 | 4 | 16 | 0 | 0 | 30 |
| | 3 | 0 | 0 | 0 | 0 | 0 | 0 | 0 |
| 1/2 | 1 | 0 | 0 | 12.5 | 12.5 | 0 | 0 | 25 |
| | 2 | 0 | 0 | 0 | 0 | 0 | 0 | 0 |
| | 3 | 0 | 0 | 0 | 0 | 0 | 0 | 0 |
| 1/3 | 1 | 0 | 0 | 0 | 0 | 0 | 0 | 0 |
| | 2 | 7.5 | 2.5 | 5 | 10 | 0 | 0 | 25 |
| | 3 | 0 | 0 | 0 | 0 | 0 | 0 | 0 |
| 1/4 | 1 | 12.5 | 0 | 12.5 | 0 | 0 | 0 | 25 |
| | 2 | 0 | 4 | 8 | 8 | 0 | 0 | 20 |
| | 3 | 1 | 3 | 2 | 6 | 2 | 2 | 16 |
| 1/5 | 1 | 10 | 5 | 5 | 5 | 0 | 0 | 25 |
| | 2 | 3 | 3 | 6 | 12 | 0 | 0 | 24 |
| | 3 | 3 | 3 | 6 | 1 | 1 | 0 | 14 |
| 1/6 | 1 | 0 | 0 | 0 | 0 | 0 | 0 | 0 |
| | 2 | 0 | 0 | 0 | 0 | 0 | 0 | 0 |
| | 3 | 1 | 1 | 2 | 2 | 6 | 6 | 18 |
| 1/7 | 1 | 5 | 5 | 10 | 5 | 0 | 0 | 25 |
| | 2 | 7.5 | 2.5 | 5 | 10 | 0 | 0 | 25 |
| | 3 | 0 | 3 | 4 | 6 | 0 | 4 | 17 |
| 1/8 | 1 | 7.5 | 10 | 0 | 7.5 | 0 | 0 | 25 |
| | 2 | 9 | 3 | 2 | 12 | 0 | 0 | 26 |
| | 3 | 2 | 0 | 4 | 4 | 4 | 4 | 18 |

Step 2: For each spot location, determine the advertisement/targeting category combination that results in the highest overall ranking. List the spot locations, the overall ranking, the corresponding advertisement, and the corresponding targeting category. In case of a tie, select any advertisement with the overall highest ranking. Table G shows the results. Thus, from Table G, ad 4, an ad displayed within a spot in spot location 4 yields a measure of effectiveness of 50 (highest) and ad 8 along with spot location 5 yields a measure of effectiveness of 28.

TABLE G

| | | | Corresponding |
|---|---|---|---|
| | Highest Overall | Corresponding | Targeting |
| Spot Location | Ranking | Ad | Category |
| Spot Location 1 | 30 | Ad 1 | 2 |
| Spot Location 2 | 35 | Ad 2 | 1 |
| Spot Location 3 | 35 | Ad 1 | 1 |
| Spot Location 4 | 50 | Ad 4 | 1 |
| Spot Location 5 | 28 | Ad 8 | 2 |

Step 3: Order the resulting list of spot locations from Step 2 from lowest overall ranking to highest overall ranking. Table H shows the results.

TABLE H

| | | | Corresponding |
|---|---|---|---|
| | | Corresponding | Targeting |
| Spot Location | Overall Ranking | Ad | Category |
| Spot Location 5 | 28 | Ad 8 | 2 |
| Spot Location 1 | 30 | Ad 1 | 2 |
| Spot Location 2 | 35 | Ad 2 | 1 |
| Spot Location 3 | 35 | Ad 1 | 1 |
| Spot Location 4 | 50 | Ad 4 | 1 |

Step 4: Select the spot location from Step 3 resulting in the lowest overall ranking. As Step 4a, for the selected spot location, select the first targeting category. As Step 4b, assemble a table showing the product of each ad Group Ranking Percentage and spot location Group Breakdown Percentage combination. Table I below provides an example for spot location 5 and targeting category 1.

TABLE I

| Spot | Cate- | Group | Group | Group | Group | Summa- |
|---|---|---|---|---|---|---|
| location/Ad | gory | 1 | 2 | 3 | 4 | tion |
| 5/1 | 1 | 10 | 15 | 0 | 0 | 25 |
| 5/2 | 1 | 0 | 0 | 15 | 10 | 25 |
| 5/3 | 1 | 0 | 0 | 0 | 0 | 0 |
| 5/4 | 1 | 10 | 0 | 15 | 0 | 25 |
| 5/5 | 1 | 8 | 6 | 6 | 4 | 24 |
| 5/6 | 1 | 0 | 0 | 0 | 0 | 0 |
| 5/7 | 1 | 4 | 6 | 12 | 4 | 26 |
| 5/8 | 1 | 6 | 12 | 0 | 6 | 24 |

As Step 4c, find the product that is the highest. In case of a tie, select the product that corresponds to the highest summation value for that spot location/ad combination. In case a tie still persists, select any of the cells with an equivalent value. Table J below shows the previous example continued where group 2 for spot location/ad combination 5/1 is selected.

TABLE J

| Spot | Cate- | Group | Group | Group | Group | Summa- |
|---|---|---|---|---|---|---|
| location/Ad | gory | 1 | 2 | 3 | 4 | tion |
| 5/1 | 1 | 10 | *15* | 0 | 0 | 25 |
| 5/2 | 1 | 0 | 0 | 15 | 10 | 25 |
| 5/3 | 1 | 0 | 0 | 0 | 0 | 0 |
| 5/4 | 1 | 10 | 0 | 15 | 0 | 25 |
| 5/5 | 1 | 8 | 6 | 6 | 4 | 24 |
| 5/6 | 1 | 0 | 0 | 0 | 0 | 0 |
| 5/7 | 1 | 4 | 6 | 12 | 4 | 26 |
| 5/8 | 1 | 6 | 12 | 0 | 6 | 24 |

Step 5: Find the product that is next highest (or the same value as in Step 4), but that is associated with a group not yet selected. Again, in case of a tie, select the product that corresponds to the highest summation value for that spot location/ad combination. In case a tie still persists, select any of the cells with an equivalent value. Table K below shows the previous example continued.

TABLE K

| Spot | | | | | |
|---|---|---|---|---|---|
| location/ | | | | | |
| Ad | Category | Group1 | Group2 | Group3 | Group4 |
| 5/1 | 1 | *10* | *15* | 0 | 0 |
| 5/2 | 1 | 0 | 0 | *15* | *10* |
| 5/3 | 1 | 0 | 0 | 0 | 0 |
| 5/4 | 1 | 10 | 0 | 15 | 0 |
| 5/5 | 1 | 8 | 6 | 6 | 4 |
| 5/6 | 1 | 0 | 0 | 0 | 0 |
| 5/7 | 1 | 4 | 6 | 12 | 4 |
| 5/8 | 1 | 6 | 12 | 0 | 6 |

Step 6: Repeat Step 5 until a product has been selected for all groups. Table L below continues the example.

TABLE L

| Spot location/Ad | Category | Group 1 | Group 2 | Group 3 | Group 4 |
|---|---|---|---|---|---|
| 5/1 | 1 | 10 | 15 | 0 | 0 |
| 5/2 | 1 | 0 | 0 | 15 | 10 |
| 5/3 | 1 | 0 | 0 | 0 | 0 |
| 5/4 | 1 | 10 | 0 | 15 | 0 |
| 5/5 | 1 | 8 | 6 | 6 | 4 |
| 5/6 | 1 | 0 | 0 | 0 | 0 |
| 5/7 | 1 | 4 | 6 | 12 | 4 |
| 5/8 | 1 | 6 | 12 | 0 | 6 |

Step 7: For all ads with products cells selected in Step 6, calculate the summed products of those selected cells for each ad. Table M below show the results.

TABLE M

| Spot | Cate- | Group | Group | Group | Group | Summa- |
|---|---|---|---|---|---|---|
| location/Ad | gory | 1 | 2 | 3 | 4 | tion |
| 5/1 | 1 | 10 | 15 | 0 | 0 | 25 |
| 5/2 | 1 | 0 | 0 | 15 | 10 | 25 |
| 5/3 | 1 | 0 | 0 | 0 | 0 | 0 |
| 5/4 | 1 | 10 | 0 | 15 | 0 | 0 |
| 5/5 | 1 | 8 | 6 | 6 | 4 | 0 |
| 5/6 | 1 | 0 | 0 | 0 | 0 | 0 |
| 5/7 | 1 | 4 | 6 | 12 | 4 | 0 |
| 5/8 | 1 | 6 | 12 | 0 | 6 | 0 |

Step 8: Order the ads in Step 7 from highest summed value to lowest. In case of a tie, arbitrarily order those ads with the same summed value. Table N presents the example results.

TABLE N

| Spot | Cate- | Group | Group | Group | Group | Summa- |
|---|---|---|---|---|---|---|
| location/Ad | gory | 1 | 2 | 3 | 4 | tion |
| 5/1 | 1 | 10 | 15 | 0 | 0 | 25 |
| 5/2 | 1 | 0 | 0 | 15 | 10 | 25 |

Step 9: As Step 9a, if the number of ads selected in Step 8 exceeds [MAX_SPOTS], select the first [MAX_SPOTS] advertisements with the summed value. For example, if it is desired to assign at most two spots to a spot location, the algorithm selects the two advertisements with the highest ad Group Ranking Percentage and spot location Group Breakdown Percentage products. Next, as Step 9b, for the unselected ads, determine those groups that were associated with these omitted ads.

Step 10: For the advertisements associated with the groups determined in Step 9b, select the product within that group that is the highest for the [MAX_SPOT] selected ads from Step 9a. Recalculate the summed products of those selected groups cells for each of the ads. Table 0 below provides a new example, assuming [MAX_SPOTS]=2; therefore, groups 5 and 6, which are associated with ad 6, may be reallocated to ads 7 & 5, respectively.

TABLE O

| Spot | Cate- | Group | Group | Group | Group | Group | Group | Summa- |
|---|---|---|---|---|---|---|---|---|
| location/Ad | gory | 1 | 2 | 3 | 4 | 5 | 6 | tion |

Before Step 11

| | | | | | | | | |
|---|---|---|---|---|---|---|---|---|
| 5/7 | 3 | 0 | *9* | 2 | *9* | 0 | 2 | 18 |
| 5/5 | 3 | *3* | 9 | *3* | 1.5 | 0.5 | 0 | 6 |
| 5/6 | 3 | 1 | 3 | 1 | 3 | *3* | *3* | 6 |

After Step 11

| | | | | | | | | |
|---|---|---|---|---|---|---|---|---|
| 5/7 | 3 | 0 | *9* | 2 | *9* | 0 | *2* | 20 |
| 5/5 | 3 | *3* | 9 | *3* | 1.5 | *0.5* | 0 | 6.5 |
| 5/6 | 3 | 1 | 3 | 1 | 3 | 3 | 3 | 0 |

Step 11: Calculate the total summed product value for all ads selected in Step 10. From Table P, this value is 26.5. The resultant groups selected for each ad will serve as the group assignments if this spot location/targeting category ultimately results in the best match, as determined in the remaining steps of the algorithm.

TABLE P

| Spot | Cate- | Group | Group | Group | Group | Group | Group | Summa- |
|---|---|---|---|---|---|---|---|---|
| location/Ad | gory | 1 | 2 | 3 | 4 | 5 | 6 | tion |
| 5/7 | 3 | 0 | *9* | 2 | *9* | 0 | *2* | 20 |
| 5/5 | 3 | *3* | 9 | *3* | 1.5 | *0.5* | 0 | 6.5 |

| | |
|---|---|
| Total summed product values | 26.5 |

Step 12: Repeat steps 4-11 above for the same selected spot location of Step 4 using the remaining target categories. The Table Q example below provides the output results.

TABLE Q

| Spot | Cate- | Group | Group | Group | Group | Summa- |
|---|---|---|---|---|---|---|
| location/Ad | gory | 1 | 2 | 3 | 4 | tion |
| 5/1 | 1 | *10* | *15* | 0 | 0 | 25 |
| 5/2 | 1 | 0 | 0 | *15* | *10* | 25 |

| | |
|---|---|
| Total summed product values | 50 |

| Spot | Cate- | Group | Group | Group | Group | Group | Group | Summa- |
|---|---|---|---|---|---|---|---|---|
| location/Ad | gory | 1 | 2 | 3 | 4 | 5 | 6 | tion |
| 5/1 | 2 | *9* | 3 | 2 | *12* | 0 | 0 | 21 |
| 5/4 | 2 | 0 | *12* | *4* | 6 | 0 | 0 | 16 |
| | | | Total summed product values | | | | | 37 |
| 5/7 | 3 | 0 | *9* | 2 | *9* | 0 | *2* | 20 |
| 5/5 | 3 | *3* | 9 | *3* | 1.5 | *0.5* | 0 | 6.5 |

| | |
|---|---|
| Total summed product values | 26.5 |

Step 13: Select the targeting category that yields the highest total summed product amount. Assign this as the Maximum Rank for that electronic book or menu. In the case above, it would be Targeting Category 1, with a value of 50 that is selected.

Step 14: Repeat Steps 4-13 for the spot location selected in Step 4 with the next lowest overall ranking, computing the Maximum Rank for each spot location.

Step 15: Use the available [MAX_SPOTS] spots for the spot locations up to the maximum number of [TOTAL_SPOTS] that yield the largest Maximum Rank. Make use of the relevant targeting category determined in Step 13, with advertisements as determined in Step 10, with group assignments as determined in Step 11.

Step 16: For all other spot locations, assign the single advertisement that yielded the highest Overall Ranking as determined in Step 2.

The above algorithm is meant to be illustrative and not limiting. Other algorithms are possible for assigning targeted advertising to groups of home systems 258 or to individual home systems 258. For example, the above algorithm could incorporate a weighting scheme for certain factors. Other targeted advertising routines can also be incorporated into the above algorithm.

The above algorithm can be simplified in the case where advertisements are being selected to be delivered with an electronic book or menu to be received by a single subscriber. In this case, prior to initiating the steps in the algorithm, the spot location Group Breakdown Percentages table is modified to display a group breakdown percentage of 0 for all groups that the subscriber does not belong to for each targeting category.

An alternate advertisement targeting routine 1374 is described in U.S. Pat. No. 5,600,364, which is hereby incorporated by reference. In this alternative, software in the ad selection system 1220 generates packages of advertisements geared towards particular subscribers and makes use of a subscriber's demographic information and reading habits to determine those advertisements that are of most interest to that particular subscriber. The routine 1374 then outputs packages of advertisements targeted towards each subscriber or group of subscribers.

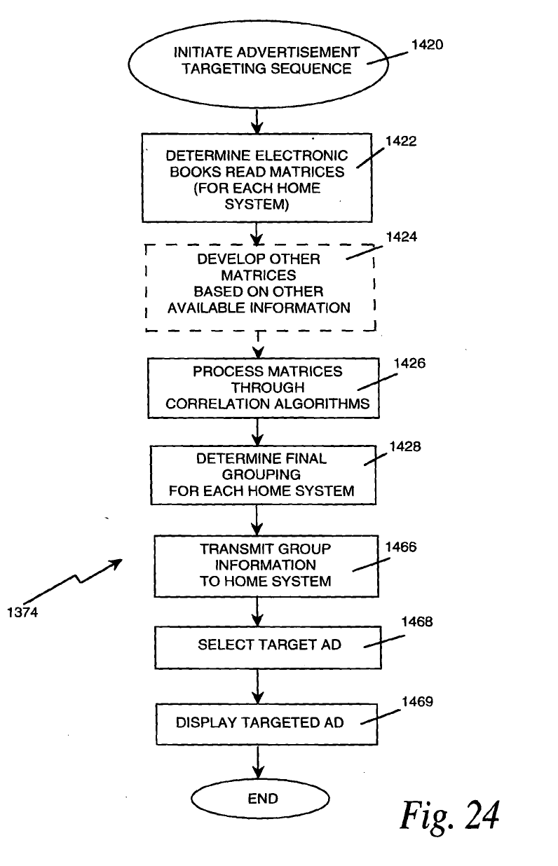

FIG. 24 shows the seven primary functions of an alternate advertisement targeting routine 1374. The function of the routine 1374 is to target advertisements for systems 258 based on historical electronic books read data and other data that is available at the TAMS 298. In the discussion that follows, the alternate advertisement targeting routine 1374 is described as executed at the TAMS 298.

The process may be initiated as shown at initiation ellipse 1420. In the first subroutine, identified at block 1422, the processor 404 accesses the electronic books read matrices stored in the subscriber information database 1210. The first subroutine 1422 uses a unique home system 258 ID to access a specific matrix for one home system 258. These matrices are maintained and updated by periodic collections by the operations center 250 of accumulated information from the home systems 258.

In the second subroutine, shown at block 1424, the processor 404 develops other matrices based on other available information. The second subroutine 1424 is an optional subroutine not required for the functioning of the system. For groups of home systems 258 or for each individual home system 258, matrices may be developed based on the demographic information, billing information, pricing information, age information and other information that may be stored in the subscriber information database 1210.

In the process matrices subroutine, block 1426, the processor 404 processes all matrices through a set of correlation algorithms. In particular, the processor 404 takes matrices developed in the first two subroutines 1422 and 1424 and processes the matrices until reaching a final matrix.

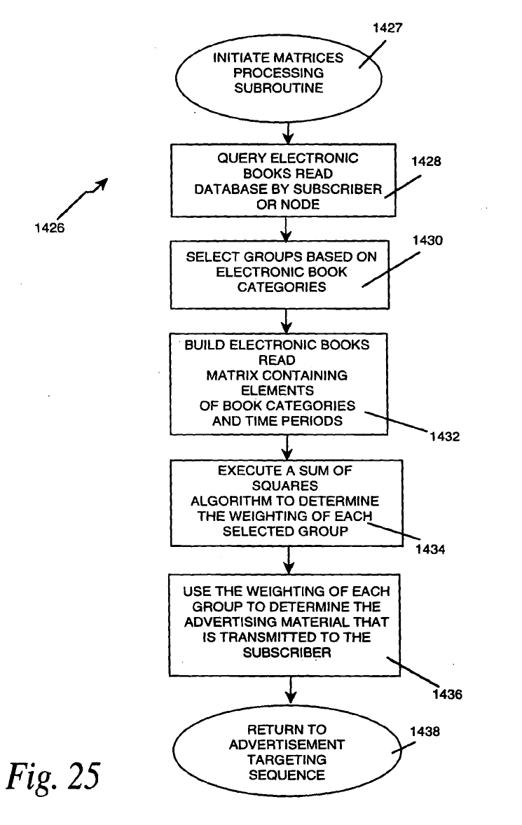

FIG. 25 shows an embodiment of the matrices processing subroutine 1426 that is called by the advertisement targeting sequence 1374 shown in FIG. 24. As shown in FIG. 25, the processor 404 initiates the matrices processing subroutine 1426 at initiation ellipse 1427 and then accesses or queries, at block 1429, the electronic books read file and gathers information regarding either an individual subscriber or a group of subscribers. The processor 404 can gather the electronic books read information in this way for individual subscribers or a group of subscribers.

Once the electronic books read information has been gathered in the database, the processor 404 selects and groups, at block 1430, electronic books read based on electronic book categories and time periods. The software initially takes each electronic book category (e.g., sports, news, mysteries, etc.) and determines the number of electronic books read for a given time. The periods may be set to any length of time, including, for example, one, two, three or four weeks. The processor 404 will loop through such a counting process for each group and period and then proceed to build an electronic books read matrix, at block 1432, based on the electronic book categories and periods. Essentially, all electronic books read in a particular category and time period will be entered into the electronic books read matrix. Once the matrix has been built, the processor 404, using matrices processing subroutine 1426, will process the matrix for a given subscriber or group of subscribers through the correlation algorithms.

A number of correlation algorithms may be used to weight each selected electronic book category. For example, as shown at block 1434, the processor 404 may use a sum of squares algorithm to determine the weighting. Once weighted, the weighted categories will be correlated by the processor 404 at block 1436, with various advertisements stored in the available ads metadata database 1230. The processor 404 then selects a set of the most heavily weighted advertisements for inclusion within the electronic books to be delivered to individual subscribers or groups of subscribers. Having determined the weightings of each group and prioritizing the groups accordingly, the processor 404 returns to the advertisement targeting sequence 1374 of FIG. 24.

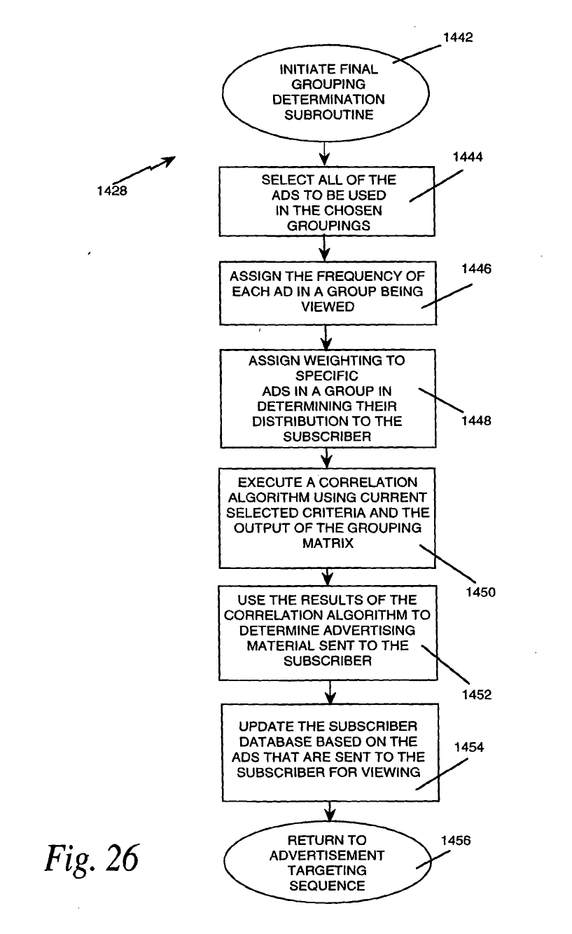

Referring back to FIG. 24, in the fourth subroutine, as represented at block 1428, the processor 404 uses the final matrix developed by the correlation and weighing algorithm described above, to select a grouping (or selective filter) for each home system 258. The final groupings of advertisement that may be sent to the home systems 258 or group of home systems 258 may use a subroutine as diagramed in FIG. 26.

The fourth subroutine 1428 depicted in FIG. 26 is called or initiated by the advertisement targeting sequence 1374 of FIG. 24 in order to determine the final groupings. In the subroutine shown at block 1444, the processor 404 selects a set of advertisements that will be used in the chosen groupings. This selection process may involve advertisements from various advertisement categories. Each advertisement may subsequently be assigned a number of times that it will be shown in a given electronic book, block 1446. The frequency of display may be based on various factors, including the number of requests and cost paid by the respective advertisers to have the advertisement displayed. Such factors may be used by the processor 404 in the next step of the subroutine, at block 1448, at which the processor 404 assigns a weighting to specific advertisements in each advertisement category. These weightings are used to prioritize the advertisements that will be sent to individual home systems 258 or group of home systems 258.

Once the advertisements have been weighted, the processor 404 executes a correlation algorithm, at block 1450, using selected criteria (i.e., the various factors used to weight the advertisements) as well as the output of each electronic books read matrix. Any number of correlation algorithms and weighting algorithms may be used, including the sum of squares weighting algorithm described above.

The results from the correlation algorithm subsequently determine the advertisements and electronic book content that is sent to the processor 404 for distribution. Once the processor 404 at the fourth subroutine 1428 completes these steps, the subscriber information database 1210 updates the subscriber record based on the ads that are sent, as shown at block 1454. The database update allows the advertisers to track the costs and frequency of the advertisements targeted to specific home systems 258 or groups of home systems 258. Following the updates, the processor 404 returns to the advertisement targeting sequence shown in FIG. 24, block 1456.

Referring to FIG. 27, home system 258 groupings (1 through 5) 1460 are shown. The number of home system 258 groupings available may be determined by the bandwidth available to transmit advertisements along with electronic books. The bandwidth of the system may limit the number of advertisements that are available to the home system 258.

Referring back to FIG. 24, the processor 404 at the fifth subroutine, represented at block 1466, prepares home system 258 group information for transmission to the home systems 258 along with the requested electronic books.

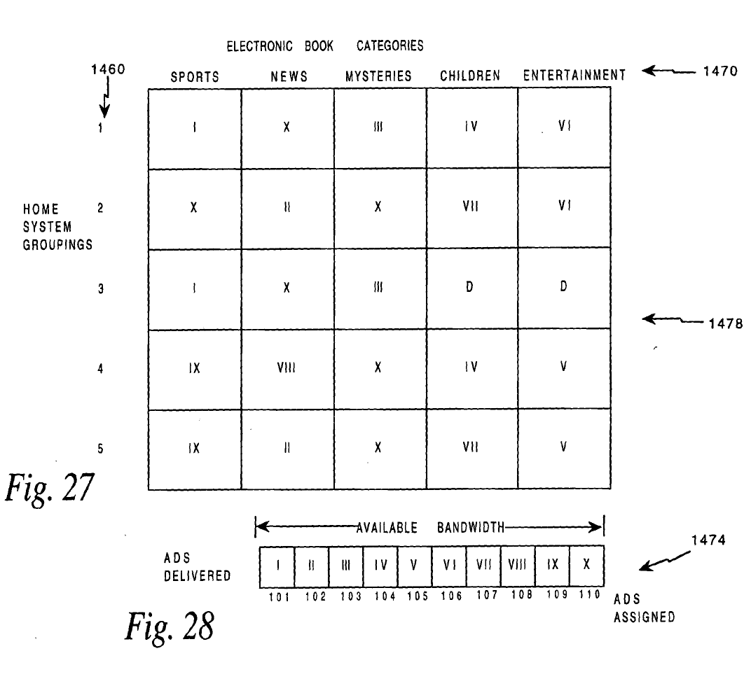

In the sixth subroutine, block 1468, the processor 404 selects the targeted advertisements. The sixth subroutine 1468 is the last decision making process in displaying a targeted advertisement for a subscriber. As shown in block 1469, the home system 258 then displays the targeted advertisement on the viewer 266. As noted above, targeted advertising can be based on reading a specific electronic book or a category of electronic books. In an embodiment, the home system 258 performs this last step by correlating (or matching) the electronic book being read by the subscriber with the home system 258 group information that has been previously transmitted by the TAMS 298. FIG. 27 shows an exemplary table matching home system 258 groups 1460 and electronic book category being read 1470 with a specific advertisement. The advertisements are shown in FIG. 28 at 1474 and are assigned Roman numerals I through X, for example. The number of home system 258 groupings and advertisements can vary. FIG. 28 shows a division of available bandwidth to carry ten advertisements. In this example, the advertisements 1474 are numbered 101-110.

The TAMS 298 will transmit group information to a home system 258 shown as row names 1460 on FIG. 27. The TAMS 298 will also transmit data that informs the home system 258 which of the multiple advertisements 1474 is assigned to an electronic book category shown as columns 1470 on FIG. 27. Each home system 258 only requires the data related to that home system's assigned group (or row). For example, in FIG. 27, the home system 258 in group 1 (row 1) is provided with data on the advertisements which are assigned for sports electronic books as I, children's electronic books as N and mystery category electronic books as III. In this manner, each home system 258 is only required to store information related to its own grouping. Therefore, a home system 258 that is in group 1 only needs to store the information related to group 1 that is found in row 1 of FIG. 27.

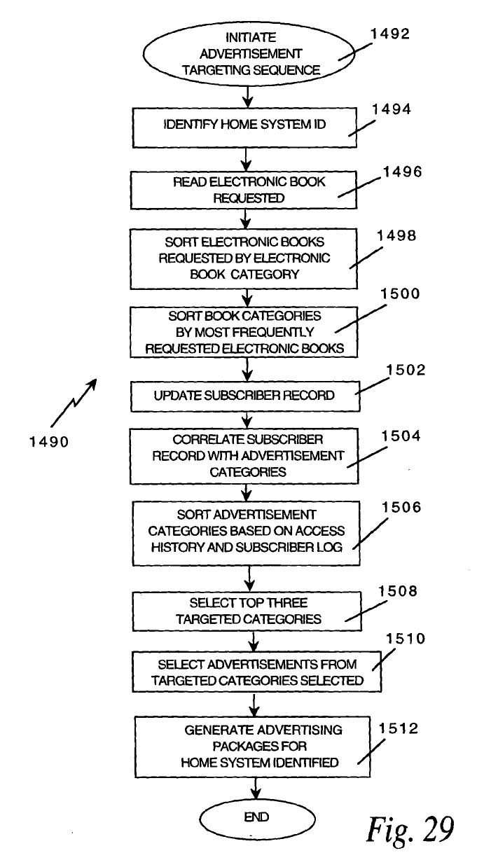

FIG. 29 shows a software program flow 1490 that is an alternative to the ad selection system 1220 targeting routine 1374, depicted in FIG. 24. The alternative routine 1490 allows each home system 258 to be individually targeted with specific advertisements and is initiated automatically, as shown at block 1492, by the TAMS 298 upon receipt of an electronic book order request from a home system 258. Thus, once the TAMS 298 receives electronic book request information from a home system 258, the TAMS 298 begins the process of selecting a package of advertisements that is based on, among other things, that subscriber's demographic information and reading history.

Upon receipt of an electronic book order request from a home system 258, the processor 404 reads the home system 258 identifier, as shown at block 1494, and the electronic books requested. The subscriber data collection engine 1202 writes information on the electronic books requested to the subscriber information database 1210, updating the subscriber record that contains listings of all electronic books requested within the past week, month or year.

With continued reference to FIG. 29, the ad selection system 1220 then calls a subroutine that sorts the electronic books requested by electronic book category, block 1498. In turn, the electronic book categories are sorted, as shown at block 1500, based on the number of times that electronic books appearing in each particular category are requested. In so doing, processor 404, using the sorting subroutine as shown at block 1500, determines and ranks those electronic books and electronic book categories that are most frequently viewed at that home system 258.

All rankings of electronic books and electronic book categories for that home system 258 are written to the subscriber information database 1210, as shown at block 1502.

Next, the ad selection system 1220 calls a subroutine, shown at block 1504, that correlates the updated subscriber record with the available advertisement metadata database 1230. By correlating these two with one another, the subroutine assigns or correlates various categories of advertisements to each ranking of electronic books and electronic book categories. The categories of advertisements that may be so assigned are found in the available advertisement metadata database 1230 and may include: (1) Household Goods/Products, (2) Home Improvement and Maintenance, (3) Personal Hygiene, (4) Entertainment Items and Events, (5) Sporting Goods and Events, (6) Motor Vehicles and Related Products, (7) Foodstuffs and Beverages, and (8) Miscellaneous, for example. Where, for example, the subscriber has read a sporting electronic book, the Sporting Goods and Events, Home Improvement and Maintenance categories may be assigned to that particular sporting event/electronic book and Sports electronic book category.

Once the electronic books and electronic book categories are correlated with the advertisement categories in the available advertisement metadata database 1230, the processor 404 calls a sorting subroutine 1506 that ranks the correlated advertising categories based on other information in the database files. In one embodiment, this ranking is primarily based on data in the updated subscriber information database 1210, as shown at block 1506. By using data on the subscriber's past electronic book selections and demographic information, the processor 404 ranks the correlated categories of advertisements according to those likely to be of most interest to that subscriber.

After the advertisement categories have been sorted and ranked, the processor 404 selects the top three advertisement categories as the targeted categories for a given electronic book and subscriber, block 1508. Individual advertisements are then chosen from the available advertisements metadata database 1230, with all selections made from the targeted categories, at block 1510. The advertisements that are selected are written to the subscriber information database 1210 and to the ad generation system 1260, from where advertising packages can be generated, at block 1512, for ultimate delivery to the home system 258.

The terms and descriptions used herein are set forth by way of illustration only and are not meant as limitations. Those skilled in the art will recognize that numerous variations are possible within the spirit and scope of the invention as defined in the following claims.

1-127. (canceled)

128. A method comprising:
identifying, by a content placement engine of a content management system, at least one location for rendering content in an electronic book;
receiving, via an interface of the content management system from a remote terminal system, information relating to usage of the terminal system;
identifying, using the content placement engine, at least one content category based on the received information relating to usage of the terminal system;
determining, using a resource management engine, an available bandwidth of a communication channel between the content management system and the terminal system;
selecting, using the content placement engine, at least one content item from a plurality of content items based on the identified at least one content category and determined available bandwidth;
generating, using a retrieval plan generator of the content management system, content retrieval plan information configured to enforce the rendering of the at least one selected content item in the at least one location in the electronic book by the terminal system;
transmitting, via an interface of the content management system, a copy of the electronic book to the terminal system; and
transmitting, via the interface of the content management system, the content retrieval plan information and the at least one selected content item for rendering by the terminal system in the at least one location in the copy of the electronic book in accordance with the content retrieval plan information.

129. The method of claim 128, wherein determining the available bandwidth of the communication channel is based, at least in part, on the at least one location for rendering content in the electronic book.

130. The method of claim 128, wherein the at least one selected content item comprises at least one of textual content, graphical content, audio content and video content.

131. The method of claim 128, wherein the at least one selected content item comprises a content package comprising a plurality of content pieces.

132. The method of claim 131, wherein generating the content retrieval plan information further comprises generating information relating to the rendering of least one content piece of the content package in the at least one location in the electronic book by the terminal system.

133. The method of claim 131, wherein the number of content pieces included in the content package are selected based in part on the determined available bandwidth.

134. The method of claim 128, wherein the method further comprises identifying, using the content placement engine, a plurality of ranked categories based on the received information relating to usage of the terminal system.

135. The method of claim 134, wherein the at least one content category is identified based on the plurality of ranked categories.

136. The method of claim 128, wherein the method further comprises packaging the copy of the electronic book, the content retrieval plan information, and the at least one selected content item to generate a packaged electronic book and wherein transmitting the copy of the electronic book, the content retrieval plan information, and the at least one selected content item comprises transmitting the packaged electronic book to the terminal system.

137. The method of claim 128, wherein the at least one location comprises a page in the electronic book.

138. The method of claim 128, wherein the at least one location comprises a portion of a page in the electronic book.

139. The method of claim 128, wherein the at least one location comprises a menu associated with the electronic book.

140. The method of claim 128, wherein the method further comprises receiving, via the interface of the content management system from a remote terminal system, subscriber information relating to a user of the terminal system.

141. The method of claim 140, wherein identifying the at least one content category is further based on the subscriber information.

142. The method of claim 140, wherein the subscriber information comprises at least one of an age, sex, education level, income level, and reading preference associated with the user of the terminal system.

143. The method of claim 128, wherein the copy of the electronic book, the content retrieval plan information, and the at least one selected content item are transmitted concurrently via the interface of the content management system.

144. The method of claim 128, wherein the method further comprises receiving an indication, via the interface of the content management system, that the at least one selected content item was rendered by the terminal system.
